(19) United States
(12) Patent Application Publication
(10) Pub. No.: US 2011/0112940 A1
(43) Pub. Date: May 12, 2011

(54) Systems and Methods for Managing Tips and Gratuities

(76) Inventor: John Steven Marshall, Princeton, NJ (US)

(21) Appl. No.: 12/987,528

(22) Filed: Jan. 10, 2011

Related U.S. Application Data
(62) Division of application No. 11/517,550, filed on Sep. 7, 2006.

(51) Int. Cl. G06Q 10/00; G06Q 90/00

(52) U.S. Cl. 705/30; 705/500

(57) ABSTRACT

Disclosed are systems and methods for recording, maintaining, and reporting tips and gratuities, optionally including details such as employee, task performed, and shift. In one aspect, inter-employee tip and gratuity transactions are tracked and verified. In another aspect, taxing authority forms and/or returns are automatically generated with substantially decreased administration time and cost, thereby facilitating a user's participation in voluntary taxing authority programs. Additionally, the training required by such programs is automatically monitored. In yet another aspect, tips and/or gratuities may be paid as wages. In another aspect of the present invention, employees are provided an opportunity to increase declared tips if the originally declared tips place employee in jeopardy of an audit. In another aspect, interfaces to third-party systems such as POS systems, payroll systems, and the like are provided to further minimize system administration time and data accuracy. In another aspect, Web-based systems are provided.

### CROSS-REFERENCE TO RELATED APPLICATIONS

This application claims the benefit of and is a divisional of the U.S. non-provisional patent application entitled “Systems and Methods for Managing Tips and Gratuities”, having Ser. No. 11/517,550 and filed Sep. 7, 2006, and currently pending, which is incorporated by reference in its entirety (including the computer program listing appendix entitled “Systems and Methods for Managing Tips and Gratuities”) as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

Embodiments of the present invention generally relate to systems and methods for managing tips and gratuities. More specifically, the present invention relates to systems and methods for recording, maintaining, and reporting tips and gratuities including tips and gratuities transferred between individuals and automatically generating the forms and/or returns required by the employee, employer, appropriate tax authority, etc. or the information required therefore.

In an attempt to increase tax compliance among tipped employees, the Internal Revenue Service (“IRS”) has established voluntary compliance agreements for industries in which tips and/or gratuities are customary. These agreements include the Tip Reporting Alternative Commitment (“TRAC”), the Employer-designated Tip Reporting Commitment (“EMTRAC”), the Tip Rate Determination Agreement (“TRDA”), and the Attributed Tip Income Program (“ATIP”). Each such commitment and agreement has varying advantages and requirements for those employers that become a party to, and enforce the requirements of, such commitments or agreements.

The TRAC commitment emphasizes education and tip and/or gratuity reporting procedures, but has less stringent employer requirements as compared to the TRDA agreement. Upon entering the TRAC commitment, employers agree to train all new employees upon hire and to train all existing employees quarterly on the legal requirements of reporting all cash and credit card tips and/or gratuities to their employer. New hire training shall include (i) a short oral explanation of the reporting requirements and the records maintenance requirements including IRS Publication 1244 (i.e., Employee's Daily Record of Tips and Report to Employer), (ii) written informational materials, which may include any of the following IRS documents: Publication 1244, Publication 531 (i.e., Reporting Tip Income), and Publication 1872 (i.e., Tips on Tips for employees in the food and beverage industry); and (iii) an explanation of the employer's tip reporting procedures. Additionally, the employer must establish tip and gratuity reporting procedures that include written statements generated on a periodic basis, wherein the periodic basis is a minimum of a monthly basis. Such statements shall include all tips and/or gratuities attributable to all employees and shall include employees' tip and/or gratuity information, which must be provided to the employer prior to the 10^{th} day of the month following the month in which such tips and/or gratuities are received.

Furthermore, TRAC commitment participants (i.e., employers who have elected to enter a TRAC commitment) agree to (i) file all required federal tax returns and pay and deposit all federal taxes, (ii) for each of the employer's establishments that is a large food or beverage establishment, the employer will comply with the requirements for filing Form 8027 (i.e., Employer's Annual Information Return of Tip Income and Allocated Tips, wherein a large food or beverage establishment is defined by the IRS to be one in which (1) food or beverage is provided for consumption on the premises, (2) tipping is a customary practice, and (3) more than 10 employees worked more than 80 hours on a typical business day during the preceding calendar year, (iii) send an additional copy of each Form 8027 to the IRS, (iv) maintain records of the gross receipts subject to tipping and the credit card receipts including the credit card tips for at least four (4) years after the 15^{th} day of April following the calendar year to which the records pertain, and (iv) make the following records available upon request of the IRS: quarterly totals for statistical samplings of gross receipts subject to tipping, credit card receipts including credit card tips, total credit card tips, and total tips reported.

In return for entering the TRAC commitment, the IRS promises the employer that it will (i) not initiate any tip and/or gratuity examinations of the employer or any one of its establishments included in the TRAC commitment for any time period for which the TRAC commitment is in effect, except in relation to a tip and/or gratuity examination of one or more employees or former employees of the employer or one of its establishments and (ii) base any IRS section 3121(q) notice and demand issued to the employer or one of its establishments included in the TRAC commitment and relating to any period for which the TRAC commitment is in effect solely on amounts reflected on Form 4137 (i.e., Social Security and Medicare Tax on Unreported Tip Income, as filed by an employee with his or her Form 1040) or Form 885-T (i.e., Adjustment of Social Security Tax on Tip Income Not Reported to Employer, as prepared at the conclusion of an employee tip and gratuity examination).The EMTRAC program is similar to the TRAC system except that the EMTRAC program is only available to employers in the food and beverage industry whose employees receive both cash and credit card tips (i.e., tips charged to a credit card). The EMTRAC commitment gives employers the freedom to design and/or customize their respective educational program and tip and gratuity reporting procedures. However, the employer's custom EMTRAC program must be approved by the IRS to allow the employer to participate in the EMTRAC program.

Employers entering an EMTRAC commitment agree: (1) to file all required federal tax returns and pay and deposit all federal taxes, (2) to maintain the following records for at least four (4) years after the 15^{th} day of April following the calendar year to which the records relate: (i) gross receipts subject to tipping, (ii) credit card receipts showing credit card tips and/or gratuities, and (iii) upon the request of the IRS, to make the quarterly totals available for statistical sampling of gross receipts subject to tipping, credit card receipts including credit card tips, total credit card tips, and total tips and/or gratuities reported by the employees.

In return for entering the EMTRAC commitment, the IRS promises the employer that it will (i) not initiate any tip and/or gratuity examinations of the employer or any one of its establishments included in the EMTRAC commitment for any time period for which the EMTRAC commitment is in effect, except in relation to a tip and/or gratuity examination of one or more employees or former employees of the employer or one of its establishments, (ii) base any IRS section 3121(q) notice and demand issued to the employer or one of its establishments included in the EMTRAC commitment and relating to any period for which the EMTRAC commitment is in effect solely on amounts reflected on Form 4137 (i.e., Social Security and Medicare Tax on Unreported Tip Income, as filed by an employee with his or her Form 1040) or Form 885-T (i.e., Adjustment of Social Security Tax on Tip Income Not Reported to Employer, as prepared at the conclusion of an employee tip and gratuity examination), and (iii) not evaluate the employer for compliance with the provisions of the EMTRAC program for the first two calendar quarters for which the EMTRAC program is in effect.

In contrast, the TRDA is an agreement between an employer and the IRS wherein the IRS works with the employer to arrive at either a minimum IRS percentage (i.e., the minimum dollar value of tips and/or gratuities expected to be received by the employee as a percentage of the total sales for which the employee is provided such tips and/or gratuities) or a minimum IRS rate (i.e., the minimum effective hourly rate expected to be made by the employee, wherein the employee's effective hourly rate is calculated by dividing the total tips and/or gratuities received for a specific time period by the hours worked during this time period and adding this calculated value to the employee's hourly wage rate paid by the employer to the employee for the same time period) for the employer's various positions (e.g., server, bartender, bus person, etc). These minimum IRS percentages and minimum IRS rates are based on IRS guidelines as well as tip and/or gratuity information that the employer has established during previous months and years of business. For example, such information may include credit card sales, cash sales, credit card tips, cash tips, etc. previously reported to the employer.

In order for an employer to participate in a TRDA, the employer must enroll at least 75% of its employees in the TRDA. In order for the employee to participate, he or she must sign a Tipped Employee Participation Agreement (“TEPA”). The TEPA requires the employee to report his or her tips and/or gratuities to the employer on a monthly basis. Annually, the employer is required to submit either a revised minimum IRS percentage or a revised minimum IRS rate (depending upon which minimum standard was originally selected by the employer) to the IRS, based upon the information received from its employees for the previous year.

Furthermore, as per the terms of the TRDA, the employer must confirm that the employees that entered into a TEPA are reporting tips and/or gratuities that are equal to or above the minimum IRS percentage or minimum IRS rate. If an employee is reporting tips and/or gratuities at a level for which the minimum IRS requirements are not met, the employer is required to provide the IRS with the employee's name, social security number, job classification, sales, hours worked, and amount of tips and/or gratuities reported.

Although this reporting requirement shifts the burden of monitoring tip and/or gratuity reporting from the IRS to the employer, there are several benefits to the employer. Participation in TRDA assures the employer that it will not be audited for the tax period preceding enrollment in the TRDA so long as the requirements of the TRDA are met. Additionally, enrollment of the employer and employees in the TRDA may result in a more accurate reporting of the employees' tips and/or gratuities. This may entitle the employer to business tax credits and/or a refund of a portion of the social security and Medicare taxes paid by the employer. Furthermore, the employer may provide some shelter for its employees from the IRS by informing its employees when the employee has not declared enough tips and/or gratuities to clear the IRS minimum rate or IRS minimum hourly wage. In such instances, the employees may be allowed to declare additional tips and/or gratuities, thereby minimizing the likelihood of an IRS audit.

Similarly, the ATIP program is an IRS program entered by an employer wherein the employer creates a method of attributing the total tips received by the establishment to all tipped employees thereof. The method of attributing such tips may be any reasonable method that is consistently applied to similarly situated employees. For example, such methods may attribute tips to employees using based upon factors including, but not limited to, gross sales, hours, shift, and task performed by the employee.

In order for an employer to participate in the ATIP program, the employer must enroll at least 75% of its employees in same. In order for the employee to participate, he or she must sign an ATIP Employee Participation Agreement. This agreement allows the employer to attribute tips to participating employees, based upon the criteria of the attribution method which is provided to the participating employees in writing, as if such tips were declared by such employees in written form. However, participating employees may elect to declare tips in addition to, or less than, the tips attributed to the respective employee. However, any employees that declare tips in an amount less than the amount attributed by the employer will lose the benefits of participating in the ATIP program.

Although the ATIP program burdens the employer with the task of attributing tips and/or gratuities, there are several benefits to the employer. Participation in the ATIP program assures the employer that the IRS will not initiate any tip examinations of a participating establishment with respect to any period during which the establishment is participating in the ATIP program so long as the requirements of the ATIP program are met. Furthermore, ATIP program participation provides further benefits to the employer regarding the values upon which any section 3121(q) notice and demand will be based for any period during which the particular establishment is participating in the ATIP program. Also, the participating establishment will be considered in compliance with the reporting requirements of section 6053(c) (2) and (3) of the IRS Code for the taxable periods during which the employer's participation in the ATIP program remains in effect. Additionally, enrollment of the employer and employees in the ATIP program may result in a more accurate reporting of the employees' tips and/or gratuities. This may entitle the employer to business tax credits and/or a refund of a portion of the social security and Medicare taxes paid by the employer.

Although there are many advantages to enrolling in any one of the available IRS commitments or agreements, the primary disadvantage is the time required on the employer's behalf to meet the necessary criteria and the cost of such time (e.g., wages paid to administrators of such commitments or agreements). For example, for the TRAC system, the IRS estimates the total annual reporting and/or recordkeeping burden for an employer to be approximately 4,877 hours. Furthermore, the IRS estimates the annual burden per respondent or recordkeeper to vary between 13 and 30 hours, depending upon individual circumstances, with an estimated average of 20 hours. The estimated number of respondents and/or recordkeepers is 300. Similarly, the IRS estimates the total annual reporting and/or recordkeeping requirements for the EMTRAC system to be 870 hours, wherein the estimated annual burden per respondent or recordkeeper varies from 8 to 44 hours with an estimated average of 13 hours. This estimate is based upon 20 respondents and/or recordkeepers. For compliance with the TRDA agreement, the IRS estimates the total annual reporting and/or recordkeeping requirements to be 1,897 hours, wherein the estimated annual burden per respondent or recordkeeper varies from 6 to 21 hours with an estimated average of 11 hours. This estimate is based upon 100 respondents and/or recordkeepers. Finally, compliance with the ATIP program is estimated at a total annual recordkeeping burden of 6,100 hours, wherein the estimated annual burden per respondent averages 10 hours with an estimated number of 610 respondents.

Although some systems currently exist to aid employers with meeting some of the requirements of IRS programs such as TRAC, EMTRAC, TRDA, and ATIP, these systems and methods track information related to such programs but do not track all required information including, but not limited to, tips and/or gratuities transferred from a first employee (e.g., a server) to his or her support staff (e.g., busboys, bar servers, etc.) (“tipout(s)”), methods of attributing tips, methods for automatically identifying under-declared tips for reporting to the IRS, methods for automatically generating required IRS forms, etc. Consequently, the administrative time for participating in such programs is considerable.

For example, some systems and methods have been created to track sales and sales tax in the form of a point of sale (“POS”) system. In its most simplistic form, such systems include an electronic register with the ability to calculate sales tax. In one such system, the register is located at a retail location. When a consumer makes a purchase, the register processes the transaction and calculates the amount of sales tax required for the purchase. The consumer then pays the required tax and the register transmits the tax information to a remote location via standard data transmission methods such as the Internet. This remote location may simply be another computer owned by the retailer or may be the tax authority to which the tax is paid. The tax information may be sent immediately or periodically depending on the retailer's needs or legal requirements. Additionally, the computer at the remote location may debit the retailer's bank account to prevent the retailer from spending monies that are designated for tax payment. The register additionally may print a receipt for the consumer to document the sale and the amount of tax to be paid to the proper tax authority.

Similarly, systems and methods have been created to track employee hours and sales. Many such systems and methods have been created in the form of a time clock or POS system. In its most simplistic form, such systems include a personal computer (“PC”) interfaced to a computerized time clock. In one such system, the PC is used to create and maintain employee records, job records, and employee schedules. Once the employee data and schedules are entered into the PC, the employees may clock in and out via the time clock. The employee's hours may then be recorded locally at the time clock and transferred to the PC at the end of the day. Upon receipt of such data, the PC may perform a variety of functions such as creating a permanent record of the hours for each payroll period, controlling labor costs by preventing employees from clocking in early or clocking out late, monitoring employee tardiness by requiring a pass code for use of the time clock, which prevents co-workers from clocking in for tardy employees, and the like. Additionally, sales records may also be recorded by the PC to further track labor costs. For example, a clothing retailer may record the sales generated by each employee to determine if too few or too many employees are working during a particular shift.

In another similar system, a restaurant management POS system is provided that tracks employee hours and sales in addition to distributing customer order information (e.g., desired meals, beverages, etc.) to the appropriate employees (e.g., chef, bartender, etc.) for preparation thereof. For example, one or more networked touch screens and/or PCs may be provided for use by the servers. Additionally, one or more networked printers and/or PCs may be provided for use by the kitchen and/or bar staff. Upon receiving an order for a customer, the server or bartender enters the information via a touch screen. This information is then sent to the printer or PC of the person who will prepare the item. For example, if a server enters an alcoholic drink and a salad, the bartender will receive the drink order and the appropriate kitchen personnel will receive the salad order. Such systems are intended to simplify restaurant management.

Finally, systems exist for tracking and recording tips and gratuities associated with individual sales, as well as the method of payment for such sales (e.g., credit card, cash, etc.). Such systems are also capable of totaling all tips and gratuities directly received by each employee. In some embodiments, such systems are also capable of totaling tips received for cash sales independent from tips received for credit card sales.

### BRIEF SUMMARY OF THE INVENTION

Briefly stated, in one aspect of the present invention, a method for managing tipouts is provided. This method includes receiving at least one tipout provided to at least one first employee from at least one second employee, verifying at least a portion of at least one tipout, and providing at least one tipout to at least one first employee.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1 depicts a flowchart of one method of managing tips and gratuities in accordance with the present invention;

FIG. 2A depicts a flowchart of one method of transferring tips and gratuities between employees in accordance with the present invention;

FIG. 2B depicts an envelope for use in one method of transferring tips and gratuities between employees in accordance with the present invention;

FIG. 3 depicts one system for managing tips and gratuities in accordance with the present invention;

FIG. 4 depicts a flowchart of an overview of a second exemplary method of managing tips and gratuities in accordance with the present invention;

FIGS. 5A and 5B depict a flowchart of one method of managing tip information and a portion of peripheral tip information in accordance with the method of the present invention illustrated in FIG. 4;

FIG. 6 depicts a flowchart of one method of generating reports in accordance with the method of the present invention illustrated in FIG. 4;

FIG. 7 depicts a flowchart of one method of managing sales and sales adjustment information in accordance with the method of the present invention illustrated in FIG. 4;

FIG. 8 depicts a flowchart of one method of managing employee data in accordance with the method of the present invention illustrated in FIG. 4;

FIG. 9 depicts a flowchart of one method of managing training including seminar topics, feedback, and attendance in accordance with the method of the present invention illustrated in FIG. 4;

FIGS. 10A and 10B depict a flowchart of one method of setting up TRDA parameters in accordance with the method of the present invention illustrated in FIG. 4;

FIG. 10C depicts a flowchart of one method of setting up ATIP program parameters in accordance with the method of the present invention illustrated in FIG. 4;

FIGS. 11A and 11B depicts a flowchart of one method of generating an activity summary report in accordance with the method of the present invention illustrated in FIG. 4;

FIG. 12 depicts an exemplary activity summary report generated by the method depicted in FIGS. 11A and 11B in accordance with the present invention;

FIGS. 13A and 13B depict a flowchart of one method of generating an IRS TRAC statement in accordance with the method of the present invention illustrated in FIG. 4;

FIGS. 14A and 14B depict an exemplary IRS TRAC statement generated by the method depicted in FIGS. 13A and 13B in accordance with the present invention;

FIGS. 15A and 15B depicts a flowchart of one method of generating an IRS 8027 report in accordance with the method of the present invention illustrated in FIG. 4;

FIG. 16 depicts an exemplary IRS 8027 report generated by the method depicted in FIGS. 15A and 15B in accordance with the present invention;

FIG. 17 depicts a flowchart of one method of generating a tip declaration problem report in accordance with the method of the present invention illustrated in FIG. 4;

FIG. 18 depicts an exemplary tip declaration problem report generated by the method depicted in FIG. 17 in accordance with the present invention;

FIG. 19 depicts a flowchart of one method of generating an IRS form 4070A in accordance with the method of the present invention illustrated in FIG. 4;

FIG. 20 depicts an exemplary IRS form 4070A generated by the method depicted in FIG. 19 in accordance with the present invention;

FIG. 21 depicts a flowchart of one method of generating an IRS form 4070 in accordance with the method of the present invention illustrated in FIG. 4;

FIG. 22 depicts an exemplary IRS form 4070 generated by the method depicted in FIG. 21 in accordance with the present invention;

FIG. 23 depicts a flowchart of one method of generating a staff training history report in accordance with the method of the present invention illustrated in FIG. 4;

FIG. 24 depicts an exemplary staff training history report generated by the method depicted in FIG. 23 in accordance with the present invention.

FIGS. 25A and 25B depict a flowchart of one method of performing error checking, generating an error report, and exporting payroll in accordance with the method of the present invention illustrated in FIG. 4;

FIG. 26 depicts a flowchart of one method of managing an individual's tips and gratuities in accordance with one embodiment of the present invention; and

FIG. 27 depicts a flowchart of one method of managing multiple employers and co-workers in an individualized system accordance with one embodiment of the present invention.

### DETAILED DESCRIPTION OF THE INVENTION

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a tip” includes a plurality of tips. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

As used herein, all variations of the term “tip” refer to something given voluntarily by a patron to a service employee.

As used herein, all variations of the term “gratuity” refer to a surcharge imposed upon a patron by the patronized establishment.

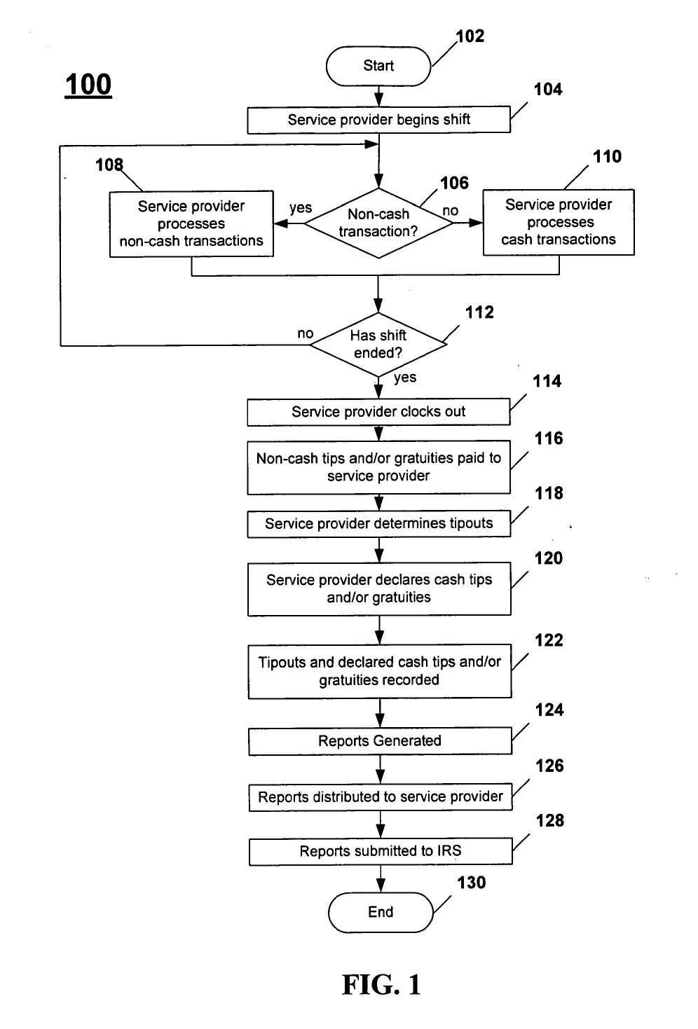

Referring first to FIG. 1, illustrated is a flow diagram of an exemplary process for managing tips and gratuities in accordance with the present invention. Process 100 begins at 102, at which the exemplary process is implemented by a business providing services for which tipping and/or providing gratuities is customary. Although such services will be described herein using an exemplary embodiment of restaurant services (i.e., serving of foods and/or beverages), the methods and systems of the present invention may be implemented with the provision of virtually any type of service in which it is customary to provide gratuities and/or tips including, but not limited to, hair salon services, spa services, valet services, tour guide services, moving services, and bellman services. Process 100 then proceeds to 104.

At 104, one or more service providers begin his or her shift. In one aspect of the present invention, the start of the shift includes “clocking in” via an employee time clock, an interfaced system (“IS”), or the like. Interfaced systems may include, but are not limited to, point-of-sale (“POS”) systems, electronic cash register systems, timeclock programs, time and attendance systems, payroll processing systems, and other similar systems as are known in the art. Such systems record an employee's starting and ending work hours for the purposes of calculating total hourly wages based upon the quantity of hours worked. Once the service provider has “clocked in”, the service provider's shift begins and the service provider provides patrons with the desired services. In the exemplary restaurant embodiment of the present invention, service providers perform services such as taking meal orders, serving food and beverages, and the like. Such services also include processing of payments for goods and services, which payments are typically made via cash and/or non-cash methods such as credit cards, checks, house charges, and gift certificates.

Whenever a service provider must process a payment, process 100 proceeds to 106. At 106, a determination is made regarding whether such payment will be made via a method other than cash. Non-cash payments are primarily credit card payments, however, such payments may also include, but are not limited to, checks such as personal checks and traveler's checks, house charges, and gift certificates. If yes, process 100 proceeds to 108 at which the service provider processes the non-cash transaction(s). In one aspect of the present invention, processing of non-cash transactions at 106 occurs via a POS system. A POS system, as is known in the art, captures data at the time and place of the sale (e.g., at the cash registers). Many POS systems include computers or specialized terminals that are co-located with cash registers, bar code readers, optical scanners, magnetic stripe readers, and the like such that information may be automatically captured by the computer or specialized terminal from the co-located equipment. Furthermore, many POS systems are networked or otherwise linked together such that data from each collection point is transferred to one central location for analysis, reporting, and the like.

In the exemplary restaurant embodiment, such non-cash transactions may be processed via the POS system by entering the data via a cash register or cash register terminal. Such non-cash transactions may include meal charges, bar charges, non-cash tips, non-cash gratuities, and the like. Such non-cash transactions may also include any transactions made via a debit card. Advanced POS systems are equipped with the ability to categorize each non-cash charge such that any tip and/or gratuities included therein are applied to a non-cash tip account and/or a non-cash gratuity account, respectively, for the specific service provider. Furthermore, such POS systems are capable of adding the base charges (i.e., the charges for the services provided by the business establishment exclusive of any tips and gratuities) upon which the tips and/or gratuities are applied to a base charges account such that at the end of the service provider's shift, the quantity of tips and/or gratuities may be calculated as a percentage of base charges. Although such POS systems are popular in current day business establishments, other methods of processing non-cash transactions may be substituted without departing from the scope of the present invention. For example, some businesses may be equipped solely with a credit card processing machine having zero capabilities for distinguishing between base charges, tips, and/or gratuities. In such scenarios, each of the aforementioned items must be manually tracked or recorded upon the credit card charge receipt.

If, at 106, a determination is made that the payment will be made via cash, process 100 proceeds to 110 at which the service provider processes the cash transaction(s). Similar to 108, in one aspect of the present invention, processing of cash transaction(s) at 106 occurs at least partially via a POS system. In this exemplary restaurant embodiment, cash transactions may be processed via the POS system by entering the data via a cash register or cash register terminal. Such cash transactions may include meal charges, bar charges, gratuities paid for cash and/or non-cash base charges, and the like, however, cash tips are not typically included therein. Rather such cash tips are typically held by the service provider until the end of his or her shift, at which point the service provider reconciles the retained cash tips with the business establishment as discussed in greater detail below with respect to 116 Again, although such POS systems are popular in current day business establishments, other methods of processing cash transactions may be substituted without departing from the scope of the present invention. For example, some businesses may be equipped solely with a cash drawer having zero capabilities for distinguishing between base charges, tips, and/or gratuities. In such scenarios, each of the aforementioned items must be manually tracked or recorded upon the cash sale receipt. Or, cash tips may be determined by simply counting the cash accumulated by the server at the end of a shift.

At 112, process 100 determines whether the service provider's shift has ended. If no, process 100 returns to 106 at which the server continues to process transactions. If the service provider's shift has ended, process 100 proceeds to 114, at which the service provider clocks out. Such clocking out may be performed via a POS system or via alternative systems (e.g., a time and attendance system) and methods without departing from the scope hereof. Process 100 then proceeds to 116.

At 116, tips and/or gratuities paid to the business establishment as non-cash charges (“non-cash tips and/or gratuities”), but intended for the service provider, are paid to the service provider. In one aspect of the present invention, such tips and/or gratuities are paid to the service provider in cash. In another aspect of the present invention, such tips and/or gratuities are retained by the business establishment and are included in the service provider's gross wages, as is required by the IRS. In another aspect of the present invention in which the process is embodied in a software application, a user-selectable option is provided that allows a user to index the software system to it's particular method of paying non-cash tips and/or gratuities to service providers (e.g., as wages, as cash, etc.). However, alternate embodiments of transferring non-cash tips and/or gratuities to the service provider may be substituted without departing from the scope of the present invention. Process 100 then proceeds to 118.

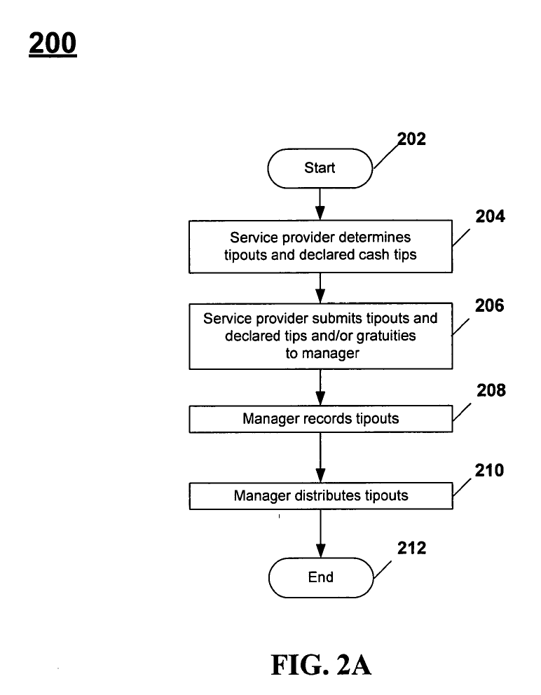

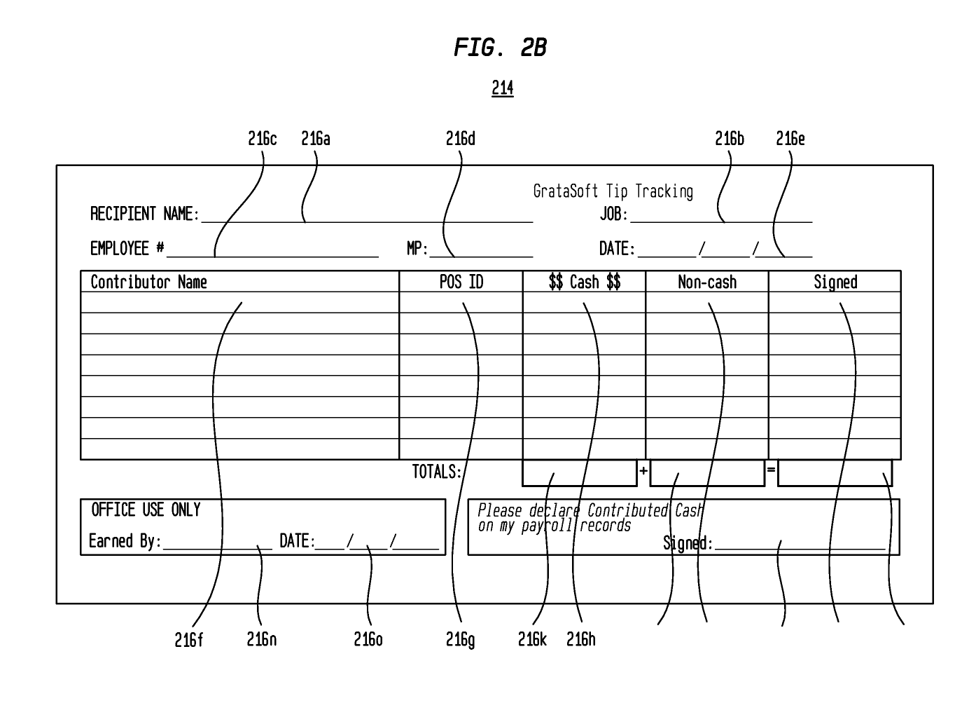

At 118, each service provider may tipout a portion of the tips and/or gratuities received during his or her shift to support staff (e.g., busboys, bar servers, etc.). Typically, such tipouts are made in the service provider's sole discretion and are based upon the normal tipout guidelines for the business establishment (whether written or unwritten). For example, the service provider may provide his or her support staff with a specific percentage of his or her tips and/or gratuities. Historically, tipouts are provided as cash transactions between the service provider and the support staff. Furthermore, the service provider has typically paid federal, state, and/or local income tax on all tips and/or gratuities including those that have been tipped out to the support staff. Or, such service provider does not declare the portion of his or her tips that are tipped out, thereby resulting in non-payment of income taxes for such portions. That is, typically the support staff does not pay such taxes on received tipouts. Therefore, in one aspect of the present invention, tipouts provided to support staff are reported to the method and/or system administrator such that the tipouts may be properly excluded from the service provider's income and may be included in the respective support staffs income. One specific method for reporting such tipouts is described in greater detail below with respect to FIG. 2A; however, other methods and/or systems for tracking tipouts may be substituted without departing from the scope of the present invention. This tipout reporting scheme encourages accurate reporting of all tips and/or gratuities by service providers by eliminating the disincentives associated with it. After the service provider provides his or her tipouts, if any, to the intended recipients either directly or indirectly via a business establishment manager, co-worker, etc., process 100 proceeds to 120.

At 120, the service provider(s) declare cash tips and/or gratuities to the business establishment. In one aspect of the present invention, such declaration only includes cash tips and/or gratuities received from patrons (i.e., such declaration does not include tipouts received from other co-workers). In such embodiments, tipout information is recorded separately and each employee's total declared tips and/or gratuities are adjusted based upon the provided tipout information via the systems and methods of the present invention. In its most simplistic form, this step involves simply notifying business establishment personnel of the total cash tips and/or gratuities received for all cash and non-cash sales. Typically, the business establishment does not require reporting of cash sales, non-cash sales, and the non-cash tips and gratuities associated therewith since such transactions are typically recorded in the business establishment's computerized system (e.g., a POS system). However, embodiments of the present invention are envisioned in which the service providers are also responsible for reporting cash sales, non-cash sales, and non-cash tips and gratuities to business establishments having unsophisticated payment processing systems. Process 100 then proceeds to 122. Although FIG. 1 depicts determination of tipouts and declaration of cash tips and/or gratuities as multiple steps, alternate embodiments are envisioned in which these steps are performed in a varying order or simultaneously such as the embodiment discussed below with respect to FIG. 2B.

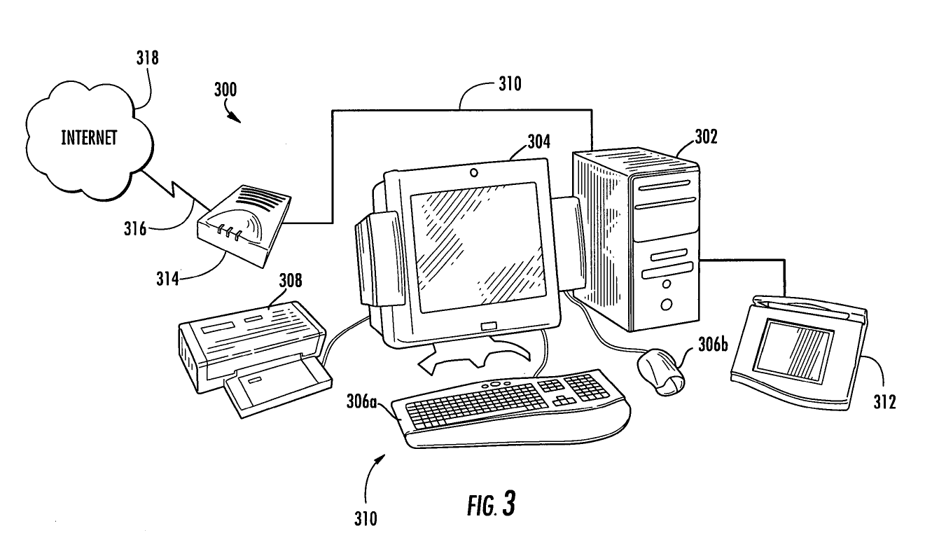

Information regarding the service provider's shift such as reported tipouts, sales, and tips and/or gratuities is recorded at 122. In one aspect of the present invention, recording involves entering this information into a software program executed by a system such as the systems described in greater detail with respect to FIG. 3 and as described in greater detail below. Such recording may be performed by any one of a variety of personnel including, but not limited to the service provider, a software administrator, and the service provider's manager. Process 100 then proceeds to 124.

At 124, reports may be generated based upon the recorded information received from a plurality of service providers as well as any information received from any computerized payment processing system including, but not limited to, non-cash sales and non-cash tips and/or gratuities. The systems and methods of the present invention are designed to automatically generate desired reports with little or no input from a user. Numerous reports may be generated in a variety of formats including, but not limited to, activity summary reports, tip declaration problem reports, staff training history reports, and IRS reports such as TRAC statements, IRS Form 8027, and IRS Publication 1244 reports including IRS forms 4070A and 4070. In some embodiments of the present invention in which the business establishment has agreed to participate in the IRS' TRAC, TRDA, and/or ATIP programs, such reports are designed to replicate the IRS forms and to automatically prepare all forms required for submission to the IRS for such programs. Or, such reports may provide the user with all information required to prepare such forms.

For example, one such generated report is the Employers Annual Information Return of Tip Income and Allocated Tips (i.e., IRS Form 8027), which includes total non-cash receipts (i.e., the sum of all non-cash sales that include non-cash tips paid thereon), total non-cash tips and/or gratuities, total non-cash tips and/or gratuities as a percentage of total non-cash receipts, gross receipts including all non-cash sales and cash sales (i.e., the sum of all cash sales, as well as all non-cash sales for which cash tips were received), total indirect tips, total direct tips, total tips declared, total tips declared as a percentage of gross receipts, total service charge, the value of eight percent of the gross receipts, the total value of all allocated tips (allocated tips equal the positive value of eight percent of the gross receipts minus the value of total tips declared), and the total quantity of directly tipped employees. All participants of the IRS' TRAC and ATIP programs and all large food and/or beverage establishments must submit this form to the IRS. However, using the systems and methods of the present invention, such reports may be prepared in significantly less time, thereby increasing the likelihood that a greater quantity of business establishments will register with this and similar voluntary IRS programs. For example, for the TRAC system, the IRS estimates the total annual reporting and/or recordkeeping burden for an employer to be approximately 4,877 hours. Furthermore, the IRS estimates the annual burden per respondent or recordkeeper to vary between 13 and 30 hours, depending upon individual circumstances, with an estimated average of 20 hours. The estimated number of respondents and/or recordkeepers is 300. However, using the systems and methods of the present invention, such time requirements are greatly reduced. Similarly, compliance with the ATIP program is estimated at a total annual recordkeeping burden of 6,100 hours, wherein the estimated annual burden per respondent averages 10 hours with an estimated number of 610 respondents.

Process 100 then proceeds to 126. At 126, some or all reports generated at 124 are distributed to one or more service providers. In some aspects of the present invention, such reports are distributed to aid the service providers in their compliance with the appropriate IRS rules and regulations (e.g., IRS Publication 1244 reports, Form 4070, Form 4070A, etc.). In other instances, such reports are distributed to aid the business establishment in its compliance with any voluntary taxing authority programs in which it is participating. For example, employers who participate in a TRAC agreement are required by the agreement to provide their employees (no less than monthly) with a written statement of non-cash tips versus cash tips paid to the employee. Furthermore, provision of such reports to the service providers ensures that the business establishment's and service providers' records are synchronized (i.e., there are no discrepancies between the information reported to the IRS by the business establishment and that provided to the IRS by the service provider).

In some aspects of the present invention, such reports are distributed on a regular basis. For example, in the exemplary restaurant embodiment, such reports may be distributed to the service providers at the end of each pay period. However, other timings for such distributions may be substituted without departing from the scope hereof.

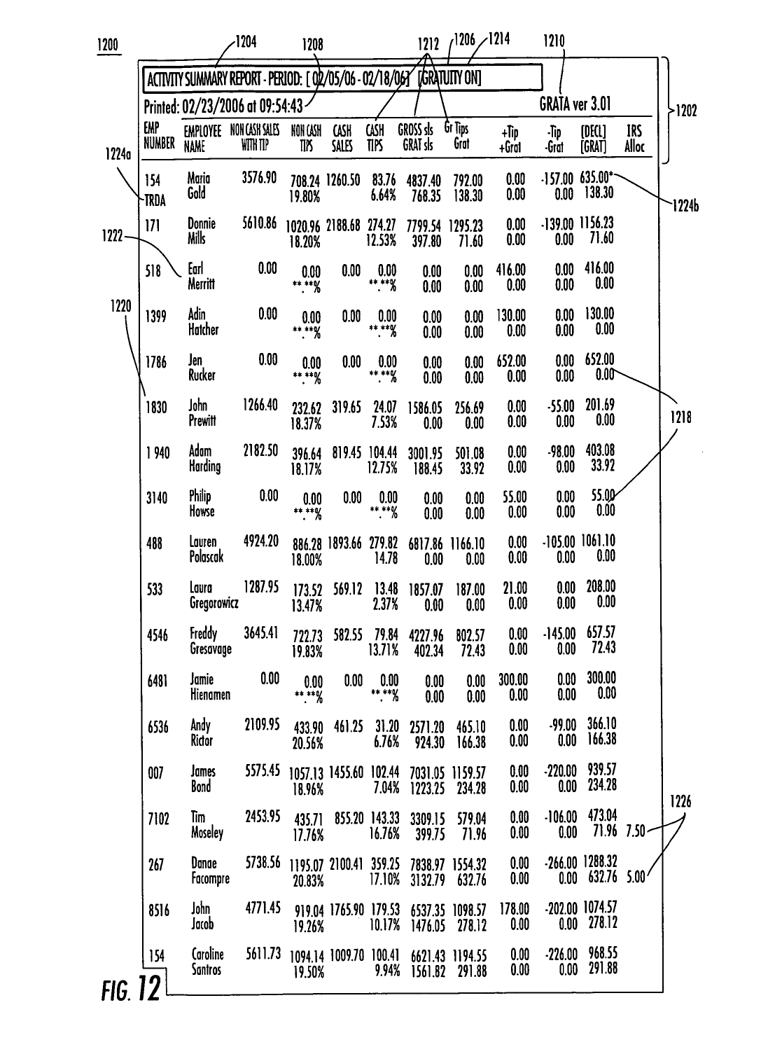

The distributed reports may detail information including, but not limited to, the service providers' gross sales, the service provider's non-cash sales, the service provider's cash sales, gross tips and/or gratuities received by the service provider, cash tips and/or gratuities received by the service provider, non-cash tips and/or gratuities received by the service provider, tips and/or gratuities disbursed to support staff by the service provider, etc. In addition, such reports may detail information including, but not limited to, calculations such as cash tips and/or gratuities as a percentage of total cash sales (wherein cash sales may be solely cash sales or they may include non-cash sales in which the tips and/or gratuities were paid as cash), non-cash tips and/or gratuities as a percentage of total non-cash sales, total tips and/or gratuities as a percentage of total sales, comparisons of these percentages, etc. An example of one such report is the exemplary activity summary report depicted in FIG. 12. Process 100 then proceeds to 128.

At 128, at least a portion of the reports that have been automatically generated by the systems and methods of the present invention are submitted to the appropriate taxing authority (e.g., the IRS). Or, alternatively, the information included in the generated reports is transferred to a taxing authority form for filing with the taxing authority. The service providers and/or the business establishment may submit such reports. In some aspects of the present invention, such reports are distributed to aid the business establishments in their compliance with the appropriate IRS rules and regulations. For example, business establishments that participate in the TRAC program are required to submit IRS form 8027 annually. Similarly, business establishments that participate in the TRDA program are required to submit reports detailing all employees who do not declare the IRS minimum percentage and/or IRS minimum rate to the IRS. Automatic generation of the required reports aids the business establishment with timely provision of such reports while simultaneously minimizing the time required to produce such reports. In some embodiments of the present invention, such reports may be automatically transmitted to the IRS in electronic form via methods known in the art, thereby further simplifying submission of such reports. Process 100 then proceeds to 130, at which it ends.

Although steps 116 through 128 are depicted in the flowchart of FIG. 1 in a specific order, alternate variations in these steps are envisioned within the scope of the present invention. In addition, although steps 116 through 128 are depicted as occurring after the conclusion of a shift, such steps may occur more or less frequently (e.g., such steps may be performed in real time via the use of a portable device such as a laptop, a personal digital assistant (“PDA”), a Web-based terminal, a Smartphone, a cell phone, etc.). For example, any one or more of these steps may occur, weekly, bi-weekly, monthly, bi-monthly, annually, or upon some other periodic basis without departing from the scope of the present invention.

Referring next to FIG. 2A, depicted is one exemplary embodiment of transferring tips and gratuities in accordance with the present invention. Process 200 begins at 202, at which a service provider has typically concluded his or her shift. Process 200 then proceeds to 204.

At 204, the service provider typically tallies his or her cash tips for reporting to the business establishment and determines the value of tips and/or gratuities that the service provider wishes to tipout, if any. Some business establishments have established guidelines for tipout amounts. For example, buspeople may receive a predetermined percentage of gross food sales, bartenders may receive a predetermined percentage of gross liquor sales, food runners may receive a gross percentage of gross sales, etc.

In one aspect of the present invention, the service provider places each tipout (typically in the form of cash) into a dedicated envelope such as envelope 214 depicted in FIG. 2B, and completes the predefined fields on the face of the envelope. As depicted in FIG. 2B, such fields may include, but are not limited to, recipient name field 216a (i.e., the name of the person receiving the tipout(s)), job description field 216b (i.e., the job description of the person receiving the tipout(s) such as server, bartender, bus person, etc.), employee number field 216c (i.e., the employee number of the person receiving the tipout(s)), meal period/shift field 216d (i.e., the meal period or shift for which the person is receiving the tipout(s)), date field 216e (i.e., the date of the shift for which the tipout(s) are being provided), contributor name fields 216f (i.e., the name of the person(s) providing the tipout(s)), POS ID fields 216g (i.e., the POS ID, if any, of the person(s) providing the tipout(s)), cash declaration fields 216h (i.e., the total value of all cash tipout(s) placed in the envelope by the respective contributor(s)), non-cash tipout(s) fields 216i (i.e., the value of the non-cash tipout(s) provided to the recipient by the respective contributor(s), wherein such tipout(s) are paid as wages and are therefore not placed into the envelope as cash), signature fields 216j (i.e., the signature of the contributor(s) verifying the value of contributed tipout(s)), cash declaration total field 216k (i.e., the total value of the cash tipout(s) received by this recipient from all contributors, and therefore the value of the cash contained in the envelope), non-cash tipout(s) total field 216l (i.e., the total value of the non-cash tipout(s) received by this recipient from all contributors), cash and non-cash tipout(s) total field 216m (i.e., the total value of all tipout(s) received by the recipient from all contributors for this shift, entered by field 216n (i.e., the name of the person recording the data included in fields 216a-216m in a tip and gratuity management system as per the present invention), entry date field 216o (i.e., the date of recording of the data included in fields 216a-216m in a tip and gratuity management system as per the present invention), and recipient's signature filed 216p (i.e., the signature of the person receiving the tipout(s)). In the envelope embodiment depicted in FIG. 2B, non-cash tipout(s) fields 216i and non-cash tipout(s) total field 216l are only used when the systems and methods of the present invention are paying tips and/or gratuities as wages. In embodiments in which gratuities are paid as cash, gratuity tipouts are included in the cash declaration fields 216h. However, other varying envelope embodiments having varying data fields may be substituted without departing from the scope of the present invention. For example, if paying gratuities as wages is not an available option with the implemented system and/or method, non-cash tipout(s) fields 216i and non-cash tipout(s) total field 216l may be omitted.

Also, various methods and systems for tracking tips and/or gratuities other than envelopes may be substituted without departing from the scope hereof. For example, in one alternate embodiment, a secure location (e.g., a cash drawer, register, a safe, a lock box, a drawer, etc.) associated with a POS system is incorporated. In such embodiments, the POS system is equipped with the ability to receive tip and/or gratuity data such as that included on the face of envelope 214. In this embodiment, the person providing the tipout provides the information relating thereto as well as the cash, if any, for the tipouts being provided to an employee such as the employee responsible for the specific cash drawer or register. The employee receiving the tipout data and/or cash then enters the data into the POS system, verifies the cash, if any, accepted from the tipout contributor, and enters such cash in the cash drawer or register. Thereafter, when the employee receiving the tipout requests such tipouts (e.g., at the end of such employee's shift), the current employee responsible for the cash drawer or register provides the tipouts to the recipient and enters data via the POS system to verify that such tipouts have been paid. However, use of a POS system cash drawer or register is simply one alternate embodiment to an envelope. Others may be substituted without departing from the scope of the present invention.

In another embodiment of the present invention, transfer of all tipout(s), regardless of how such tipouts are transferred (e.g., envelope, cash drawer, register, safe, lock box, drawer, etc.) and whether such tipouts are paid in cash or as wages, is documented via electronic signature, digital signature, and/or electronic/digital signature capture methods and/or systems. Electronic signatures include any mechanism for identifying the originator of an electronic message including, but not limited to, an electronic sound, symbol, or process, attached to or logically associated with a contract or other record and executed or adopted by a person with the intent to sign the record. Furthermore, electronic signatures also include any electronic form of a written signature such as a digital image of an actual written signatures received, for example, via a digital pen pad device. Digital signatures include, but are not limited to, cryptographically based signature assurance schemes (e.g., Public Key Infrastructure (“PKI”) schemes) in which a first algorithm allows a signature to be created and a second complementary algorithm allows the created signature to be checked or authenticated at a later time such as upon receipt of an electronic transmission of the created signature.

For example, when tipout transfers are documented via electronic signature, digital signature, and/or electronic/digital signature capture methods and/or systems, any one or more parties to the tipout transaction such as the tipout recipient, the tipout contributor(s), and any intervening co-workers involved in the transfer of the tipout (e.g., manager, employee, etc.) may be required to provide a signature, or an electronic or digital representation of his or her signature, to verify information such as the value of the tipout, the date of transfer of the tipout, receipt of the tipout by the tipout recipient, etc. Such signatures or electronic/digital representations thereof may then be stored with, or distinct from, the other tipout information in a database or via another form of electronic storage. Such information may then be retrieved for a plurality of purposes including, but not limited to, resolving any disputes relating to tipouts, providing documentation to a taxing authority of such tipout, etc.

In one aspect of the present invention, some or all of the information written on the face of envelope 214 (FIG. 2B) is presented to any one or more of the signers thereof in electronic form. After verification of the information, each signer may then sign the electronic document electronically, whereupon such signature(s) are then stored. Such embodiments eliminate the need for paper handling while also minimizing the costs and space associated with filing and storing same. Furthermore, storing of electronic tipout transaction information allows redundant backups to be made to minimize the potential for loss of such information due to fire, water damage, or any other potentially harmful incident. The electronic information may be backed up regularly using the same systems and methods incorporated by the business establishment for its other electronic data and files.

In some such aspects of the present invention, additional hardware is utilized for such signature capture. For example, an Interactive POS/Signature Capture Terminal such as the Transaction Team™ 8500 as manufactured by HandHeld Products™ may be utilized. Such a terminal captures a signature signed upon the screen of such terminal via a stylus or the like while also performing other functions such as accepting POS payments. Or, simplified terminals such as electronic signature pads may be utilized. One example includes the KioskGem LCD as manufactured by Topaz Systems, Inc. Such terminals may be attached directly to a system such as those described in greater detail with respect to FIG. 3 or they may be attached to an IS as discussed in greater detail herein. If attached to an IS, the electronic and/or digital signatures may be optionally uploaded or downloaded to the systems of the present invention on a periodic basis or instantaneously.

Other embodiments of the present invention are envisioned in which additional hardware is not required for signature capture. For example, in embodiments of the present invention in which the software operates on a portable device such as a PDA that is already equipped with a touch sensitive screen, signatures may be captured via the existing hardware and may be saved using software known in the art. One example of such software includes the Intuit Eclipse™ DMS software as manufactured by Intuit Inc. Such software operates with existing touch screen hardware and/or signature capture devices to store captured signatures. Or, software such as BT WebSignature as manufactured by Bennet-Tec Information Systems, Inc. allows a signature to be captured, saved as an image file, stored in a database, and optionally posted to a Web server. The captured signature may be created via a mouse, pen tablet, or the like. Although a plurality of signature capture devices and software have been discussed above in detail, other devices and/or software may be substituted without departing from the scope of the present invention.

After tipouts have been determined at 204, process 200 proceeds to 206. At 206, the service provider(s) optionally submit declared tips and/or gratuities and tipouts to a supervisor. In the exemplary embodiment of the present invention in which an envelope system is used to transfer tipouts, the envelopes are provided to a manager who verifies that all predefined fields have been filled out, confirms the contents of the envelope (e.g., the cash contained in the envelope matches that reported on the face of the envelope), and ensures that the service provider(s) or other contributors have signed the envelope. Or, in embodiments in which a secure location such as a POS drawer is utilized, a manager or other employee may simply enter the information regarding the tipout into the POS system, confirm the value of the cash provided by the tipout contributor(s), and, if desired, obtain the required signatures from the tipout contributor(s). Such signatures may be obtained in written or electronic/digital form. The cash received by the manager or other employee may then be placed in the secure location until it is collected by the tipout recipient(s). Additionally, the manager or other employee may also sign in written or electronic form to acknowledge receipt of the tipout(s). Similarly, collection of such tipout(s) by the recipient(s) may also require submission of written and/or electronic/digital signatures from such recipient(s). Process 200 then proceeds to 208.

At 208, once a supervisor has collected the declared tip and/or gratuity information and tipout information, it may be entered into the tip and gratuity management system. Such information may be entered into a software tip and gratuity management system via a standard PC interface such as those described in greater detail with respect to FIG. 3. In the exemplary restaurant embodiment, this collection and data entry may occur on a daily basis. Also, optionally, supervisors may execute error-checking programs and/or may generate error-checking reports to ensure that all service providers have declared cash tips and/or gratuities and that the amounts declared are reasonable. For example, the system may highlight tip declaration problems wherein cash sales are reported but cash tips are either not reported or are reported at a very low level (e.g., as compared to non-cash tips and/or gratuities). Identification of such tip and/or gratuity declaration shortcomings allows the service provider to be prompted to properly declare cash tips received. In some embodiments of the present invention, entry of the declared tip and/or gratuity information and tipout information may be entered into the tip and gratuity management system by providing the information to an IS and then uploading or downloading such information to the tip and gratuity management system. Furthermore, the manager and/or employee entering such information may also submit a written and/or electronic/digital signature at this time to further verify the entered information.

Once data entry is complete, the supervisor distributes the tipouts to the respective recipients at 210. Each recipient may be required to sign an envelope or the like, or to submit an electronic/digital signature, to acknowledge receipt of the tipouts and to provide permission to the business establishment for including such tipouts in the recipient's gross wages. Although process 200 depicts distribution of tipouts subsequent to entry of tipout information, alternate embodiments of the present invention are envisioned in which tipouts are distributed prior to entry of such information. Thereafter, process 200 proceeds to 212, at which it ends.

Turning now to FIG. 3, an exemplary embodiment of a simplistic system for implementing the systems and methods of the present invention is depicted. System 300 includes processing unit 302, printing device 308, user interface 310 (i.e., monitor 304, first user interface device 306a, and second user interface device 306b), and signature device 312.

Processing unit 302 may be a standard PC or server as is known in the art. However, any form of processing unit capable of executing an algorithm and storing data may be substituted in accordance with the present invention.

Monitor 304 may be any standard monitor, as is known in the art, that is capable of displaying information to a user. Similarly, first and second user interface devices may be any devices (e.g., a keyboard, a mouse, a touch screen, a pointing device, etc.) capable of allowing a user to interface with the systems and methods of the present invention. Printing device 308 may be any standard printer, as is known in the art, capable of printing data received from a processing unit such as processing unit 302. Furthermore, signature device 312 may be any device capable of accepting a signature as is known in the art. Some specific examples are discussed in greater detail above with respect to FIG. 2A.

Any components capable of performing the above-mentioned tasks may be substituted for the individual components of system 300 without departing from the scope of the present invention. In addition, multiple components (e.g., a memory and a processing unit) may be substituted for any individual component of system 300 (e.g., processing unit 302) without departing from the scope of the present invention so long as such components are capable of performing the necessary tasks. Or, alternatively, a single component (e.g., a laptop, a PDA, a Web-based terminal, a Smartphone, a cell phone, etc.) may be substituted for the entire system 300, or multiple components thereof, without departing from the scope hereof. Examples of such components include, but are not limited to, the Palm® 700w Smartphone, the Dell® Axim PDA, and Ultra Mobile PCs such as the Samsung® Q1. In such scenarios, many such single devices are equipped with on-board processing capabilities, monitors, and user interface devices. In embodiments of the present invention in which the operating system is a Windows® operating system, software designed for a full blown personal computer system such as system 300 may be easily installed on any portable device equipped with a Windows® Mobile operating system, as such system is designed to run all Windows® applications as well as operating system independent solutions such as HyperText Markup Language (“HTML”), Java, and the like.

Furthermore, in some embodiments of the present invention, system 300 may include network device 314 and/or Internet connection 316 to allow system 300 to connect to Internet 318. Network device 314 may be any equipment capable of connecting a processing unit such as processing unit 302 to Internet 318 including, but not limited to, a cable modem, a DSL modem, and a broadband card. In turn, network device 314 is typically coupled to an Internet connection 316, which may be wireless or hardwired. Such connections include telephone lines, cables, cellular networks, etc. For example, a hardwired Internet connection 316 may be a cable such as a coaxial cable wired from a cable television company's existing wiring infrastructure to the location of network device 314. Similarly, another hardwired Internet connection 316 may be telephone-grade conductors wired from a telephone company's existing wiring infrastructure to the location of network device 314. However, other varieties of hardwired and/or wireless connections may also be incorporated without departing from the scope of the present invention.

Connection of system 300 to Internet 318 allows the systems and methods of the present invention to be implemented in a Web-based manner. For example, the systems and methods of the present invention may be executed via a Web server or similar apparatus that interacts with one or more users via an Internet connection such as Internet connection 316 between the Web server and the user's local processing device or dumb terminal (e.g., a thin client, a thick client, etc.). Such web-based implementations may be programmed via a web programming tool such as the FUNCky.com programming tool or the like. Such interaction may include receiving input from a user and/or providing output (e.g., reports) to a user via the Internet connection.

In some aspects of the present invention, the Web-based systems and methods of the present invention may be accessed via any Web browser in communication with the Internet regardless of whether such Web browser resides on a non-portable device (e.g., a desktop PC) or a portable device such as a laptop, PDA, Smartphone, cellular phone, or the like. This capability allows users with the required user rights to access the systems and methods of the present invention at the business establishment, from home, or on the go (i.e., via a portable device). This feature may allow users of an individualized system (i.e., systems intended for personal use by a single employee), as described in further detail below, to download information from an IS or a business establishment's tip and gratuity management system to his or her home computer. Also, in embodiments of the present invention in which electronic and/or digital signatures are captured, a Web-based system allows a signature to be requested via electronic mail. Furthermore, Web-based systems facilitate integration of the systems and methods of the present invention with all Web-based IS, thereby increasing the likelihood of data entry via download from an IS, which minimizes the need for manual data entry. Web-based systems further facilitate multi-site deployment, maintenance, support, upgrades, enhancements to, centralized administration of, storage, and backup of the systems of the present invention.

Furthermore, web-based individualized systems facilitate upload of employee information such as declared tips, contributed and/or received tipouts, 4070 forms, 4070A forms, and the like to the employee's employer(s). Additionally, web-based systems facilitate downloading, purchasing, testing, and delivery of software patches, updates, upgrades, software enhancements and the like from the software provider. For example, software changes may be required to accommodate items including, but not limited to, changes and/or customizations of an IS and new taxing authority programs.

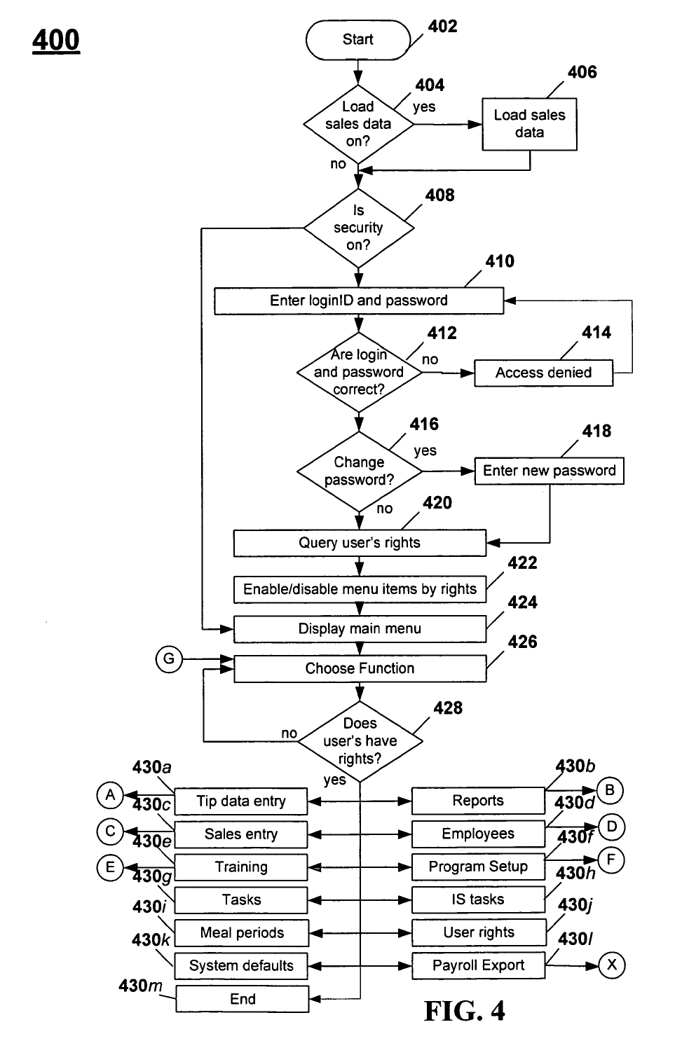

Turning next to FIGS. 4 through 25, depicted are processes and exemplary reports of one embodiment of the present invention. This exemplary embodiment will be referred to herein as Gratuity Reporting and Tip Allocation Software (“GrataSoft”). In this exemplary embodiment, the processes and reports depicted in FIGS. 4 through 25 are implemented as software and software generated reports, respectively, which operate on or are created by a system such as those discussed in greater detail above with respect to FIG. 3.

Referring to FIG. 4, depicted is process 400, which is an overview of the exemplary GrataSoft embodiment of the present invention. Process 400 begins at 402, wherein a user enables the system upon which the GrataSoft software is executed. For example, when GrataSoft is operated on a system such as those described in greater detail with respect to FIG. 3, such enabling may include energizing processing unit 302, monitor 304, and, optionally, printing device 306. In Web-based embodiments of the present invention, such enabling may include initiating a connection between a local processing unit or dumb terminal and the Web-based system via an Internet connection. A user may wish to enable the system once a user has received tipout information and/or tip and/or gratuity declarations from the service provider(s) to allow the user to record and/or generate reports for such information in a manner similar to that described above with respect to steps 122 and 124 of FIG. 1. Process 400 then proceeds to 404.

At 404, process 400 determines whether the GrataSoft system is set to automatically load sales data. If no, process 400 proceeds to 408. If yes, process 400 proceeds to 406, at which the GrataSoft system will query its existing data set to determine whether it is up to date. If it is not, it will automatically download all missing data. Such data may include non-cash sales, cash sales, non-cash tips and gratuities, and the like, which may be downloaded or uploaded to a local processing unit such as processing unit 302 from an IS.

In our exemplary embodiment, one such IS is an Aloha POS in the form of software, which is executed by the same processing unit (e.g., processing unit 302) that executes the present invention. The Aloha POS saves data in .DBF, or dBase, file structures. This data is transactional data that is stored in a small set of tables. For example, payments may be stored in a first PAYMENT.DBF file, item sales may be stored in a second ITEMSALES.DBF file, and staff time may be stored in a third STAFFTIME.DBF file. The Aloha POS also incorporates .DBF files for configuration files such as files containing task codes, rates, identification information, and employee information such as name, address, social security number, etc.

When a POS or similar type of system is interfaced to a system or process of the present invention such as the exemplary GrataSoft embodiment, employee information may be loaded directly from .DBF or similar files into the present invention, which avoids the need for re-entering employee information that has already been entered in the POS system. Similarly, job codes may be loaded directly from such systems to identify data such as clock in time, clock out time, hourly wage, total hours worked, task worked, etc. Additionally, non-cash sales, cash sales, gratuities, etc. may be loaded directly from such systems to identify and calculate gross sales information. Such loading ensures that the same information is present on both systems. Although specific items of information have been identified for transfer from the Aloha POS system to the present invention, the systems and methods of the present invention may be programmed to load any information available in the IS, regardless of whether the IS is an Aloha POS system, another brand of POS system, or a non-POS system, without departing from the scope of the present invention. Similarly, information may be loaded from .DBF or other types of files using similar methods.

Loading of information to the present invention from an IS may be performed via execution of an interface process and queries (e.g., database or SQL queries) to the IS. This interface process is designed to read or query the information contained in the .DBF files or the like. In some embodiments of the present invention, such queries are written using software such as dBase Plus to provide Microsoft® Windows® compatibility as well as compatibility with a number of files types including, but not limited to, SQL server, Sybase, Oracle, Microsoft Access, etc. Access to the data contained therein is created by pointing the exemplary GrataSoft embodiment of the present invention to the IS' file folder, which is typically a distinct file folder from that containing the GrataSoft data files, which is stored on the Aloha server (e.g., a processing unit such as processing unit 302). In a typical embodiment, the GrataSoft software will be co-located on such Aloha server, or processing unit. However, such embodiments are not required. The Aloha file folder may be local or remote to the server, although if such file folder is remotely located, it must be configured as a mapped drive on the local server. For example, in one aspect of the present invention, the file folder is located remotely and it is configured as a mapped drive on the local server via an Internet connection such as those discussed above in greater detail with respect to FIG. 3. Once the exemplary GrataSoft embodiment of the present invention has been pointed to the correct file location, it may simply query the database information as is known in the art. However, alternate methods of downloading or transferring data such as sales data may be substituted without departing from the scope of the present invention. For example, in one aspect of the present invention, mapping is performed via Web mapping utilizing a Universal Naming Convention (“UNC”) server and data transfer is performed via uploading and downloading via HyperText Transfer Protocol (“HTTP”), Extensible Markup Language (“XML”), and/or HTML as is known in the art.

In some aspects of the present invention, such interface process and queries are implemented in a module that is easily separable from other processes. Such separation allows the interface process and queries to be easily replaced to accommodate integration to a new or different system, without requiring changes to the other processes.

Although this exemplary embodiment integrates to an Aloha POS system, embodiments of the present invention are envisioned in which other types of IS are substituted. Also, alternate methods of integrating the present invention to the POS system may be substituted without departing from the scope hereof. Alternatively, the functions and features of the POS software, as known in the art, may be incorporated directly into the systems and methods of the present invention (e.g., in embodiments of the present invention in which the system is a software package, such software package may also include all typical POS or the like functions and features as is known in the art). Or, the functions and features of the present invention may be incorporated directly into the IS including, but not limited to, the POS system.

After the sales data is loaded, process 400 continues to 408. Or, if at 404, the user does not elect to download sales data into the GrataSoft system, process 400 proceeds directly to 408 from 404. A user may elect not to load such sales data, for example, if such data has already been loaded or if such data is not required for the functions to be performed by the user.

At 408, a determination is made regarding whether the security features are enabled or disabled. Security measures are implemented to maintain system integrity and control access to all or a portion of the GrataSoft system. Prior to each user's use of the GrataSoft system, the user is assigned secure login identification codes and passwords. Such login identification allows access to varying levels of information and to varying system functions based upon the user's need and/or position within the business establishment. For example, users such as owners or managers may require access to all system information and all system functions to allow such users to perform high level functions such as modifying system defaults, setting user rights, configuring and modifying voluntary IRS program parameters, assigning tasks to employees, defining meal periods, etc. In contrast, the capabilities of shift leaders or supervisors may be limited to a specific sub-set of available system information and system functions. For example, such users may be limited to tasks such as entering the service provider(s)' tipouts and tips and/or gratuities, generating reports, and the like. Similarly, the capabilities of the service provider(s) may be further limited to system information and system functions such as viewing the respective service provider's tips and/or gratuity information, tipout information, sales information, etc. The systems and methods of the present invention may be customized to allow each user, or each category of user (e.g., owner, manager, service provider, etc.) to access a distinct set of system information and/or system functions.

If security features are not enabled, process 400 proceeds directly to 424. However, if such features are enabled, process 400 proceeds to 410. At 410, a user is prompted to enter her login identification code and password. Process 400 then proceeds to 412, at which the login identification code and password are tested for authenticity. Such testing may be performing using any method known in the art. If the login identification code and password are authentic, process 400 proceeds to 416. If the login identification code and password are not authentic or the password does not correspond to the login identification code entered, process 400 proceeds to 414.

At 414, access is denied to the GrataSoft system. In one embodiment of the present invention, the system such as system 300 displays an access denied or error message which ends the execution of the software (e.g., the user is kicked out of the GrataSoft system). In other embodiments, process 400 returns to 410 to allow the user to re-enter her login identification code and password. In such an embodiment, there may be a maximum number of allowed tries before the GrataSoft system will no longer allow login identification codes and/or passwords. This feature minimizes the potential for access to the GrataSoft system by simply guessing multiple login identification codes and passwords.

At 416, upon successful entry of a user login identification code and password, the user is prompted with an option to change her password. If the user does not wish to change her password, process 400 proceeds to 420. However, if the user chooses to change her password, process 400 proceeds to 418 prior to proceeding to 420. At 418, the user is prompted to enter her new password and the new password is stored in a processing unit such as processing unit 302 of system 300.

Once login identification code and/or password changes are completed, if any, process 400 proceeds to 420. At 420, the GrataSoft system determines which menu items (e.g., system information, system functions, etc.) are available to the user (i.e., the items to which the user has “rights”). Such rights are determined based upon the user's login identification code and/or password. In one aspect of the present invention, such rights are determined by querying a database or the like to determine what functions are enabled for the specific login identification code and/or password. Such database may be a Microsoft® Access® database as known in the art. However, alternate methods of saving function data in correlation to password, position, or similar data may be substituted (e.g., via registers, memory locations, etc.). In an alternate embodiment of the present invention, such rights are determined by querying a database or the like to determine the position of the person associated with the login identification code and/or password. Thereafter, the database or the like may be re-queried to determine the menu items available to a user of the designated position. However, alternate embodiments for determining the rights of a user may be substituted without departing from the scope of the present invention.

Once the GrataSoft system has obtained the user's rights, process 400 proceeds to 422. At 422, specific user menu options will be selectively enabled and disabled based upon the level of access associated with the login identification code and/or password as determined at 420. Process 400 then proceeds to 424, at which the main menu is displayed to the user. In one aspect of the present invention, the main menu is customized such that it only includes those functions for which the user has rights. In another aspect of the present invention, the main menu includes all functions but those for which the user does not have rights are grayed to indicate that they are not accessible or such rights are otherwise disabled. However, other methods of presenting the main menu to the user may be substituted in accordance with the present invention. In the exemplary embodiment of the present invention depicted in FIGS. 4 through 25, the available functions 430 include tip data entry function 430a, reports function 430b, sales entry function 430c, employees function 430d, training function 430e, program setup function 430f, tasks function 430g, IS tasks function 430h, meal period function 430i, user rights function 430j, system defaults function 430k, payroll export function 430l, and end function 430m. However, functions may be added, deleted, and/or modified without departing from the scope hereof.

Process 400 then proceeds to 426, at which the user selects the desired function. Such function may be selected in any one of a variety of methods known in the art such as entering a number associated with such function via an operator input device such as operator input device 306a, placing a cursor atop a desired function displayed on a monitor such as monitor 304 and clicking it via an operator input device such as operator input device 306b, and the like.

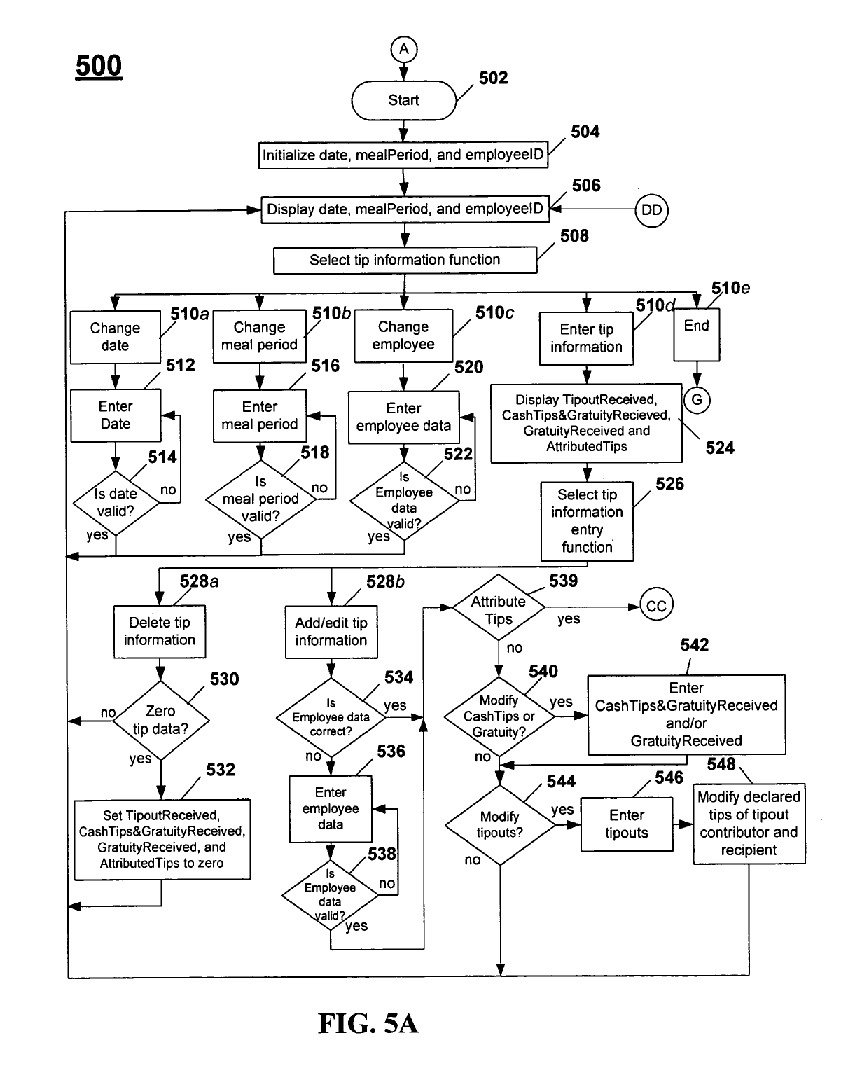

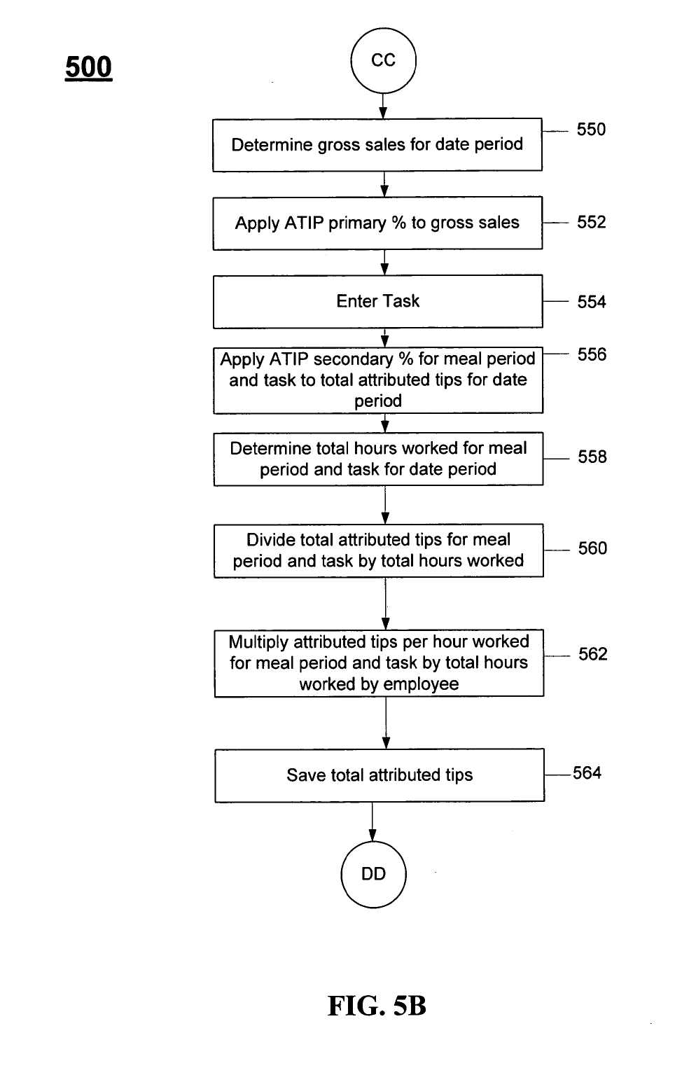

After the user has selected a function, process 400 proceeds to 428. At 428, the GrataSoft system queries a database or the like to determine whether the user has the rights to run the function selected at 426. If the user does not have the required rights, process 400 returns to 426, at which the user may select another function. An error message may also be displayed to the user prior to returning the user to 426. If, at 428, the user does have the required rights to access the selected function 430, process 400 executes a process associated with the selected function 430. That is, a new process begins that executes the tasks for the chosen function 430. Exemplary embodiments of processes for functions 430a-430f and 430l are depicted in FIGS. 5-10 and FIG. 25, respectively.

If tasks function 430g is selected, the user is prompted to define the tasks to be used with the exemplary GrataSoft system. Such tasks may include, but are not limited to, serving, bartending, bussing, food preparation, cleanup, etc. Similarly, if meal periods function 430i is selected, the user is prompted to define the meal periods to be used with the exemplary GrataSoft system. Such meal periods may include, but are not limited to, breakfast, lunch, brunch, dinner, etc. In some embodiments of the present invention, shifts may be substituted for meal periods, particularly those embodiments in which meal periods are not applicable (e.g., hair salon services, spa services, valet services, tour guide services, moving services, and bellman services). In such embodiments, shifts are determined by the approximate times of the day worked rather than the meal being served during the hours worked.

Or, alternatively, upon selecting either tasks function 430g or meal periods function 430i, the user may be presented with a predefined list of options for which the user has the ability to select or deselect options from said list, or to modify the listed options. In some embodiments of the present invention, defined data such as meal periods, employee identifiers, and the like cannot be deleted once they have been entered. Such restrictions minimize the possibility that incomplete records will be created by deletion of a portion of the data relating thereto. In some embodiments, although deletions are not allowed, the descriptions of the defined data may be modified.

If IS tasks function 430h is selected, the user is prompted to define the tasks associated with the IS (e.g., a POS system) to be used with the exemplary GrataSoft system. Such tasks may include, but are not limited to, bussing, bartending, serving, table running, etc. IS tasks function 430h allows a user to add, edit, or delete such IS tasks. However, alternate embodiments of the present invention are envisioned in which IS tasks are automatically imported from the IS without departing from the scope of the present invention. For example, the exemplary GrataSoft system may list the imported IS tasks to allow the user to select the desired tasks to be added to the GrataSoft system.

By selecting user rights task 430j, the rights of each user may be selected or determined. For example, a user accessing this function may determine whether each system user has the ability to view, add, edit, or delete system data such as tips, sales, and employee data. Or, a user accessing this function may determine whether each system user has the rights to run programs, run reports, edit his or her specific password, edit employee passwords, edit user rights, edit program settings, edit locked data ranges, and edit voluntary taxing authority program (e.g., TRDA, ATIP, TRAC, etc.) criteria. Although a few specific user rights have been enumerated, user rights task 430j may be configured to allow a system administrator or the like to modify any user right available with the specific implementation of the present invention without departing from the scope hereof.

System default function 430k provides user access to system defaults. Such defaults may include defaults such as establishment information defaults, system setting defaults, and IS interface defaults. More specifically, establishment information defaults may include establishment name, establishment address, establishment email address, establishment Website, establishment telephone number, establishment federal employer identification number, and the like. This establishment information may be used during printing of reports including those reports to be submitted to the IRS or other taxing authorities.

System default settings may include setting days in a pay period and enabling/disabling options such as security features, report graphics, paying tips as wages (i.e., if this option is set to “on”, the business establishment retains and/or collects the employee's cash and/or non-cash tips from the employee and includes an amount equal thereto in the employee's wages), paying gratuities as wages (i.e., if this option is set to “on”, the business establishment retains the employee's cash and/or non-cash gratuities and includes an amount equal thereto in the employee's wages), TRDA (i.e., if this option is set to “on”, the system automatically calculates and/or reports any shortfall between declared tips and/or gratuities and the level of tips and/or gratuities expected by the IRS as established by the minimum IRS percentage or rate), TRAC (i.e., if this option is set to “on”, the system automatically calculates and/or reports the difference between non-cash tips and/or gratuities as a percentage of non-cash sales and cash tips and/or gratuities as a percentage of cash sales), ATIP (i.e., if this option is set to “on”, the system automatically attributes tips to all employees participating in the ATIP program) and such tips attributed tips are treated as if they were reported by the employee to the employer, Allocation Enabled (i.e., if this option is set to “on”, the system will automatically increase the tips and/or gratuities declared by the employee to meet IRS Form 8027 criteria), and Autocorrect (i.e., if this option is set to “on”, the system will automatically increase the tips and/or gratuities declared by the employee to meet TRDA criteria or to achieve an acceptable difference between credit card and cash tip and/or gratuity percentages). IS interface system defaults include enable interface to IS system, poll sales on startup (i.e., download and/or update sales data from an IS automatically upon startup of the GrataSoft system), update data during execution of payroll export function 430l (i.e., download any updated sales data from IS data files that may impact sales, tips, hours worked, etc. (e.g., edits, corrections, credits, refunds, clocking in or out errors, etc.)), force non-cash tip (i.e., automatically declare non-cash tips if a service provider forgets to clock out after a shift), as well as entry fields in which the location of files, file folders, and the like may be entered to allow the exemplary GrataSoft system to access data from, or provide data to, ISs such as an Aloha POS, a payroll processing system, a time and attendance system, etc. However, the aforementioned system defaults are exemplary only and other system defaults may be substituted without departing from the scope of the present invention. For example, for individualized systems of the present invention as discussed in greater detail below, system defaults function 430k may include the ability to define employee data for the sole employee.

If any of functions 430a-430l are selected, process 400 returns to 426 after executing the function. However, if function 430m is selected, process 400 ends, the user exits the GrataSoft system, and process 400 terminates.

Turning next to FIGS. 5A and 5B, illustrated is a flow diagram of an exemplary embodiment of a process for entering tip information and peripheral tip information into a system such as the exemplary GrataSoft system and/or attributing tips to an employee via such system. In some embodiments of the present invention in which an envelope or similar system is incorporated, such as that discussed above with respect to FIGS. 2A and 2B, the envelopes or other tip declaration/distribution method is synchronized to match the data entry fields associated with process 500. For example, the data entry screen for process 500 may mimic the data fields included on the face of an envelope such as envelope 214. In addition, in aspects of the present invention in which electronic/digital signatures and/or electronic signature capture methods are incorporated, this function may accept signatures from any one of the tipout recipient, tipout contributor, or other co-worker involved in the tipout process. Process 500 begins at 502, typically after being launched from a master process such as process 400 as described above with respect to FIG. 4. For example, process 500 may be launched by selecting function 430a (FIG. 4). Once process 500 has been initiated, it proceeds to 504.

At 504, the variables date, mealPeriod, and employeeID are initialized to the current date, to the first meal period (e.g., breakfast, lunch, dinner, etc.) of the initialized date, and to the first employee identification number as such numbers are stored in the GrataSoft system, respectively. In the GrataSoft system, the date variable allows entered tipouts and tips and/or gratuities (collectively, “tip information”) to be associated with the date on which the tips and/or gratuities are received by the service provider. Similarly, the mealPeriod variable allows the entered tip information to be associated with the shift during which the tipout and tip and/or gratuity transactions (collectively, “tip transactions”) take place. The employeeID variable allows entered tip information to be associated with the specific employeeID of the service provider who receives the tip transactions. In this exemplary embodiment, it is envisioned that the tip information will be entered into the GrataSoft system almost daily. However, the system may be programmed to allow the user to manually enter the desired date, rather than having the date default to the current date. In addition, varying data entry periods (weekly, monthly, etc.) may be substituted without departing from the scope of the present invention. Once all variables have been initialized, process 500 proceeds to 506.

At 506, the tip information associated with the date, mealPeriod, and employeeID variables are displayed to the user via a user interface such as those described in greater detail with respect to FIG. 3 and process 500 proceeds to 508. At 508, the user selects a tip information function also via a user interface such as those described in greater detail with respect to FIG. 3. In this exemplary embodiment of the present invention, the main functions include change date function 510a, change meal period function 510b, change employee function 510c, enter tip information function 510d, and end function 510e. Once the user selects a function, process 500 proceeds to the selected function 510a through 510e. For example, if the change meal period function is selected, process 500 proceeds to 510b. Although FIG. 5A depicts five functions 510a through 510e, functions may be deleted, added, or substituted without departing from the scope of the present invention.

If at 508, the user has selected change date function, process 500 proceeds to 510a at which a process to change the date begins. Process 500 then proceeds to 512, at which the user is prompted to enter a date. In one aspect of the present invention, double clicking on the date field yields a calendar from which a user may select the day, month, year, etc. Or, alternatively, a data may be displayed with up and down arrows for adjustment of same. For example, a date entry field may be displayed to the user via a user interface such as those described in greater detail with respect to FIG. 3. After the user enters a date, process 500 may optionally verify that the date is valid at 514. For example, a valid date may include any date within the current pay period to ensure that data is not accidentally modified for a pay period for which payroll data has already been processed. Or, alternatively, a valid date may include any date in the current year that is prior to or includes the current date to ensure that data is not accidentally modified for a year in which an annual return (e.g., IRS form 8027) has been filed with the appropriate taxing authority. If the date is invalid, process 500 returns to 512 at which the user may re-enter it. However, if the date is valid, process 500 returns to 506 at which the revised date, mealPeriod, and employeeID variables are re-displayed to the user.

Similarly, if, at 508, the user has selected change meal period function 510b, process 500 proceeds to 510b at which a process to change the meal period begins. Process 500 then proceeds to 516, at which the user is prompted to enter a meal period. After the user enters a meal period, process 500 verifies that the meal period is a valid meal period at 516. Valid meal periods would typically include the meal periods that have been initially entered into the GrataSoft system during the initial system setup (e.g., via meal periods function 430i), wherein such meal periods are based upon the number of meal periods the business establishment offers per day. If the meal period is not valid, process 500 returns to 516 at which the user may re-enter the meal period. However, if the meal period is valid, process 500 returns to 506 at which the revised date, mealPeriod, and employeeID variables are re-displayed to the user. In other embodiments of the present invention, meal periods are selected from a listbox or the like to prevent a user from entering an invalid meal period.

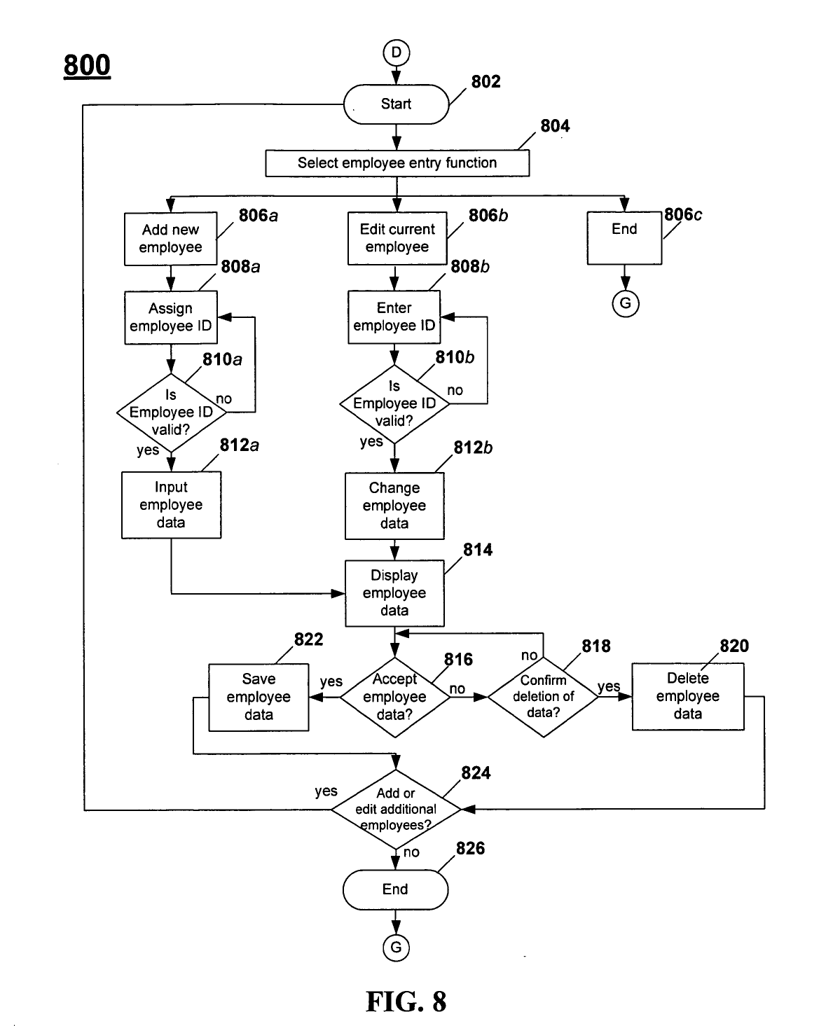

Or, if at 508, the user has selected change employee function 510c, process 500 proceeds to 510c at which a process to change the employee begins. In some aspects of the present invention such as the exemplary GrataSoft embodiment, the selected employee is the employee that received the tips and/or gratuities to be entered. Process 500 then proceeds to 520, at which the user is prompted to enter employee data such as an employee ID, employee name, or the like. After the user enters the employee data, process 500 verifies the employee data at 522. If one aspect of the present invention, the employee data is an employee ID that is valid if it corresponds to any one of the employee ID numbers assigned to an employee during the process of entering employees into the GrataSoft system (e.g., employees function 430d (FIG. 8)). Or, alternatively, the employee data is an employee name that is valid if it corresponds to any one of the employee names entered into the GrataSoft system. Or, alternate methods of verifying employee data may be substituted without departing from the scope hereof. If the employee data is invalid, process 500 returns to 520 at which the employee data may be re-entered. However, if the employee data is valid, process 500 return to 506 at which the revised date, mealPeriod, and employeeID variables are re-displayed to the user.

If at 508, the user has selected enter tip information function 510d, process 500 proceeds to 510d at which a process to enter tip information begins. Process 500 then proceeds to 524, at which the data associated with the TipoutReceived, CashTips&GratuityReceived, GratuityReceived, and AttributedTips variables are displayed to the user. The TipoutReceived variable is set to the amount that the service provider associated with the current employee ID has received from other employees for the current meal period of the current date. The CashTips&GratuityReceived variable is set to the amount of tips and/or gratuities that the service provider associated with the current employee ID has received from clients and/or customers for the current meal period of the current date. The GratuityReceived variable is set to the amount of gratuities that the service provider associated with the current employee ID has received from clients and/or customers for the current meal period of the current date. The AttributedTips variable is set to the amount of tips that has been attributed to the service provider by the business establishment. These variables will display zero if no data has been previously entered into the GrataSoft system for the current variables.

Process 500 then proceeds to 526 at which the user selects a tip information entry function. In this exemplary embodiment of the present invention, the tip information entry functions include Delete Tip Information Function 528a and Add/Edit Tip Information Function 528b. Once the user selects a function, process 500 proceeds to the selected function.

If, at 526, the user has selected Delete Tip Data Function 528a, process 500 proceeds to 528a at which the tip information is deleted. That is, tipouts and tips and/or gratuities received by the current employee on the current date for the current meal period will be set to zero dollars and zero cents. Process 500 then proceeds to 530, at which the user is prompted to confirm deletion of the tip information. If at 530, the user does not wish to zero the tip information, process 500 returns to 506 at which the current date, mealPeriod, and employeeID are displayed to the user. However, if the user elects to delete the tip information, process 500 proceeds to 532 prior to returning to 506. At 532, the variables TipoutReceived, CashTips&GratuityReceived, GratuityReceived, and AttributedTips associated with the selected employee, meal period, date, and, optionally, task are set to zero and process 500 proceeds to 506.

If, at 526, the user has selected Add/Edit Tip Information Function 528a, process 500 proceeds to 528b, at which a process to add and/or edit the tip information begins. Process 500 then proceeds to 534, at which the user is prompted to confirm that she has selected the correct employee. If at 534, the employee data is correct, process 500 proceeds to 540. However, if at 534 the employee data is incorrect, process 500 proceeds to 536. At 536, the user is prompted to enter employee data, and process 500 verifies the employee data at 538. If the employee data is invalid, process 500 returns to 536 at which the user may re-enter the employee data. However, if the date is valid, process 500 proceeds to 539.

At 539, the user is prompted to determine whether she would like to attribute tips to the current employees for the current date and meal period. If yes, process 500 proceeds to 550 as depicted in FIG. 5B. At 550, process 500 determines the gross sales for the selected date. For example, such sales may be the gross sales for a particular day. Process 500 then proceeds to 552.

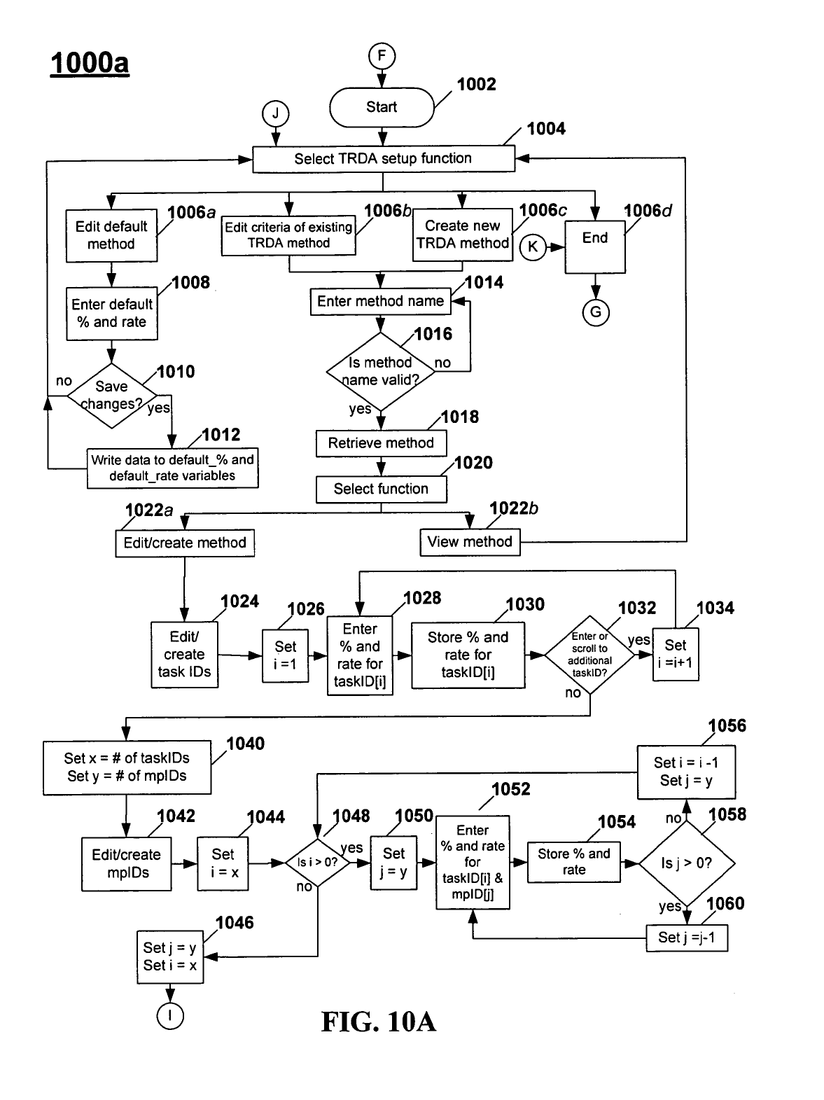

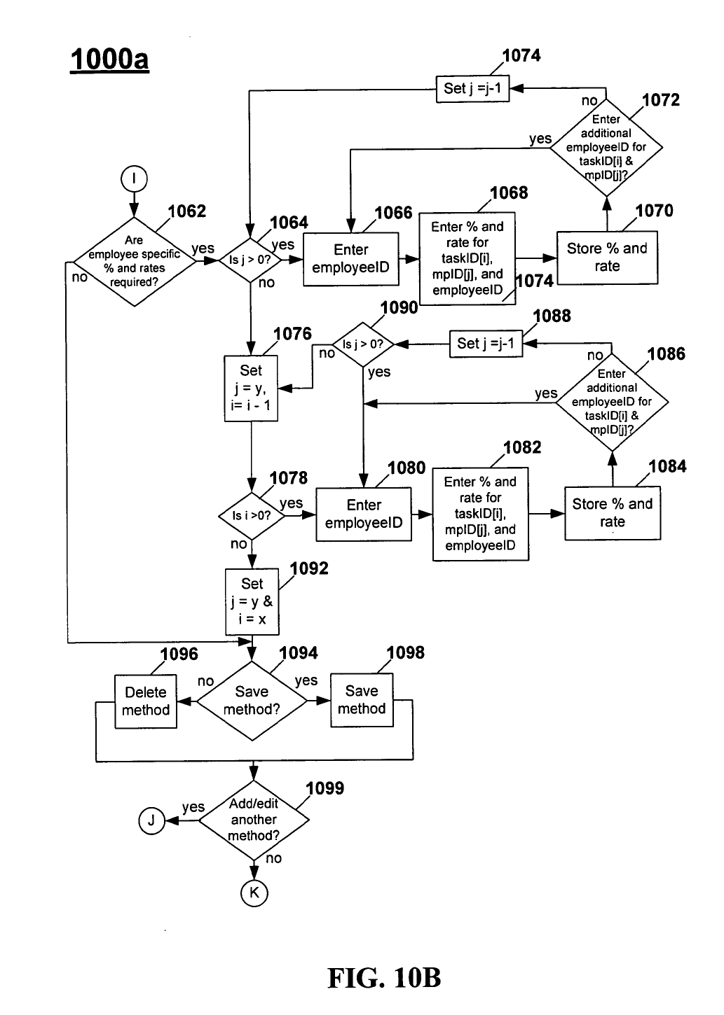

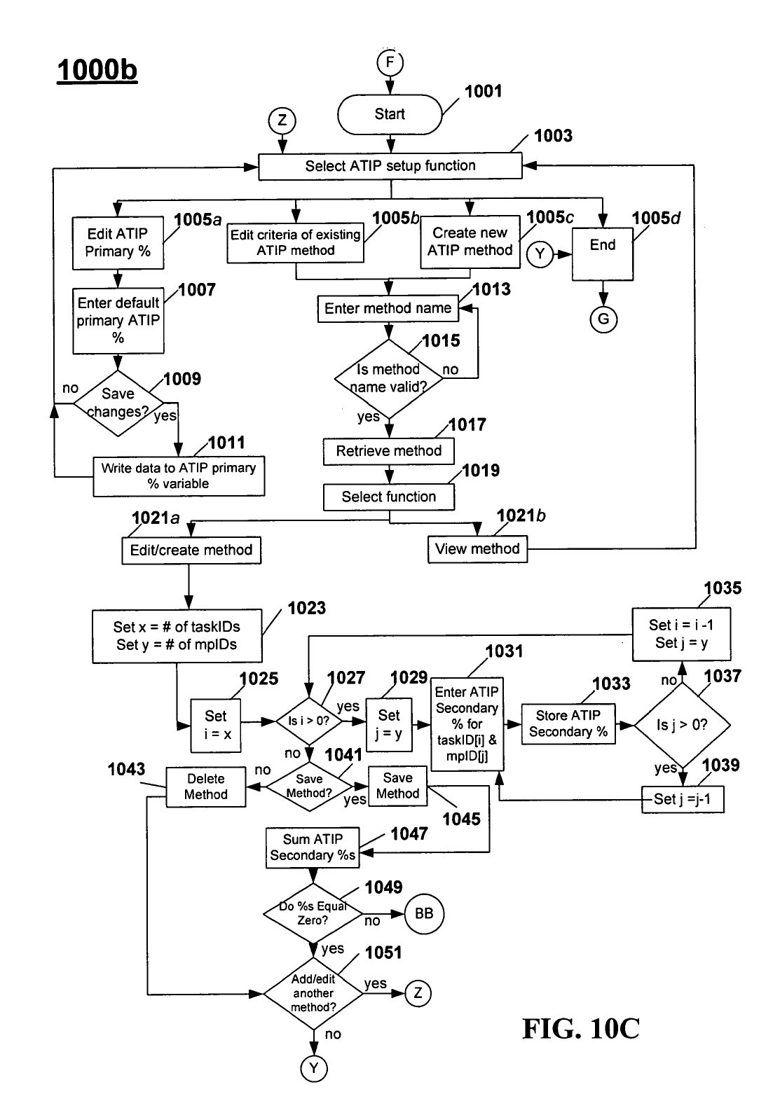

At 552, the gross sales for the current date is multiplied by the ATIP primary percentage to determine the total value of all tips to be attributed for the current date. In the exemplary GrataSoft embodiment of the present invention, the ATIP primary percentage is defined as a part of process 1000b as discussed in greater detail below with respect to FIG. 10C. Process 500 then proceeds to 554, at which a task is entered. Such task is one of the tasks defined, for example, via tasks function 430g (FIG. 4). This task represents the task performed for the current meal period and the current date for which tips shall be attributed. Process 500 then proceeds to 556.

At 556, the ATIP secondary percentage associated with the current meal period and the current task is multiplied by the total attributed tips (as calculated at 552) for the current date. In the exemplary GrataSoft embodiment of the present invention, the ATIP secondary percentages are defined as a part of process 1000b as discussed in greater detail below with respect to FIG. 10C. Process 500 then proceeds to 558, at which the total hours worked for the current meal period, current task, and current date are determined. Next, at 560, the total tips attributed for the current meal period and the current task (as calculated at 556) is divided by the total hours worked (as determined at 558), thereby providing the total attributed tips per hour for the current meal period, for the current task during the current date. Process 500 then proceeds to 562, at which the total attributed tips per hour (as calculated at 560) is multiplied by the total number of hours worked by the current employee for the current meal period for the current task during the current date. Process 500 then proceeds to 564, at which the total attributed tips (as calculated at 562) is saved. This data is stored in conjunction with its respective date, mealPeriod, and employeeID variables in the form of a database or the like such as a Microsoft® Access® database using methods known in the art. However, alternate methods of saving sales data may be substituted (e.g., via registers, memory locations, etc.).

Although FIG. 5B depicts one method of attributing tips in accordance with one embodiment of the present invention, any reasonable method may be substituted without departing from the scope of the present invention. For example, in some embodiments, tips are attributed to each employee based upon the number of hours worked by each employee divided by the total number of hours worked by all employees during a particular shift, date, etc. In other embodiments, tips are attributed to each employee based upon the total sales of each employee divided by the total sales of all employees for a particular shift, date, etc. Or, in yet other embodiments, tips are attributed to a first subset of employees (e.g., servers) based upon a first method (e.g., hours worked by the employee versus hours worked by all employees) and tips are attributed to a second subset of employees (e.g., bartenders) based upon a second method (e.g., sales of each employee versus sales of all employees). That is, a combination of attribution methods may be used for different subsets of employees. Although the example provided herein includes two subsets, any number of subsets and any number of methods may be used without departing from the scope of the present invention.

Or, alternatively, if a user elects not to attribute tips at 539, process 500 proceeds to 540. At 540, the user is prompted to determine whether she would like to modify the value of the cash tips and/or gratuities received by the current employee on the current date for the current meal period. A user may enter cash tip and/or gratuity data even if such employee has been attributed tips at step 539. Such declarations are above and beyond attributed tips and will be reported in that manner for the employee's payroll purposes. However, if an employee elects to declare tips and/or gratuities in an amount less than the attributed amount, the attributed tips shall be deleted and the amount of the employee's declaration only will be included in the employee's gross wages. Also, for employers participating in a tip attribution program such as ATIP, tips will not be attributed to non-participating employees. Therefore, those employees shall continue to declare tips as described herein.

If a user elects yes at 540, process 500 proceeds to 542, at which the user enters the new data and such data is written to the CashTips&GratuityReceived and/or GratuityReceived variables. Also, the task associated with the tip may also be entered. This data is stored in conjunction with its respective date, mealPeriod, and employeeID variables in the form of a database or the like such as a Microsoft® Access® database using methods known in the art. However, alternate methods of saving sales data may be substituted (e.g., via registers, memory locations, etc.). After entry of the new CashTips&GratuityReceived and/or GratuityReceived data, or if the user elects not to enter new such new data, process 500 proceeds to 544. It should be noted that the exemplary GrataSoft embodiment does not require entry of non-cash tips and/or gratuities since that data is automatically received from its IS. However, in embodiments of the present invention in which such data must be entered manually, step 542 would also provide for entry of all non-cash tips and/or gratuities. Similarly, step 524 would allow for display of all non-cash tips and/or gratuities.

At 544, the user is prompted to decide if she would like to modify the value of the tipouts received by the current employee on the current date for the current meal period. If yes, process 500 proceeds to 546, at which the user is prompted to enter the tipout data. Such data is entered by identifying the dollar value of each tipout received by the current employee, the form in which such tipout is received (i.e., cash or non-cash), the employee who contributed the tipout to the recipient, the task associated with the tipout, and any other information associated with the tipout. Such detail is required to allow the Gratasoft system to deduct the tipout from the tips declared by the employee providing the tipout and to augment the tips declared by the employee receiving the tipout. Such detail also allows non-cash tipouts to be paid to the recipient as wages or as cash received directly from the business establishment. Furthermore, in some aspects of the present invention in which electronic/digital signatures and/or electronic signature capture methods are utilized, entry of the tipout information also includes collection of a signature from one or more of the tipout recipient, the tipout contributor(s), and any other employees involved in the transfer and/or recording of the tipout.

It should be noted that the systems and methods of the present invention allow such tipouts to be tracked regardless of whether the tipout is paid in cash or not. For example, if the business establishment elects to have employee tipouts included as part of his or her wages, the business establishment may retain the cash received from the tipout contributor and may pay such tipouts, in addition to any non-cash tipouts received by the tipout recipient, to the tipout recipient as part of such recipient's next paycheck. Or, in some embodiments of the present invention, the election to receive tipouts as wages may be performed on a per employee basis (as compared to a per business establishment basis). Also, in some embodiments of the present invention, only non-cash tipouts are paid to the recipient as wages and cash tipouts are paid as cash. Increasing the employee's net pay provides a better chance for the employee's taxes, health, 401(k), and other deductions to be fully funded. It also provides the establishment with improved cash flow by paying out tipout funds at a later date than that upon which such funds are actually received from the tipout contributors. Since payroll companies are not allowed to “underfund” tip declarations in order to meet mandatory tax requirements (i.e., payroll companies are not allowed to arbitrarily decrease an employee's declared tips to ensure that the employee's net pay is able to pay all required taxes such as federal, state, and local witholdings), employers have traditionally set up tip loan accounts to ensure full tip reporting and mandatory tax funding. The hope is that future pay periods will zero these balances before staff decide to leave. That is, the employer loans the employee any funds required to pay all mandatory witholdings in the hope that future pay will be sufficient to pay all mandatory witholdings and repay the employer loan.

Modifications of the tipout contributor(s)' and tipout recipient's declared tips are performed at 548. That is, the tips declared by each tipout contributor are reduced by the value of all contributed tipouts and the tips declared, if any, by each tipout recipient are increased by the value of all received tipouts. These automatic tip modifications encourage all employees receiving tips to properly declare the value of the cash tips and/or gratuities received, since such modifications ensure that the employee contributing the tipout will not be responsible for paying income tax on such tipouts, which has historically been a problem when contributing tipouts in accordance with systems and methods known in the art. The business establishment also benefits from proper reporting of cash tips and/or gratuities received as such establishments are less likely to be audited by a taxing authority. Furthermore, such proper reporting may entitle the business establishment to business tax credits and/or a refund of a portion of the social security and Medicare taxes paid by the employer, thereby resulting in a financial gain for the business establishment.

If a user elects not to modify tipout data at 544 or if the user has completed modifying tipout data at 548, process 500 returns to 506. If at 508, the user has selected End Function 510e, process 500 proceeds to 510e at which process 500 is terminated. Since, in this exemplary embodiment, process 500 is invoked by process 400, process 500 returns control to process 400 at 426, at which the user may select another function from the main menu of the GrataSoft system.

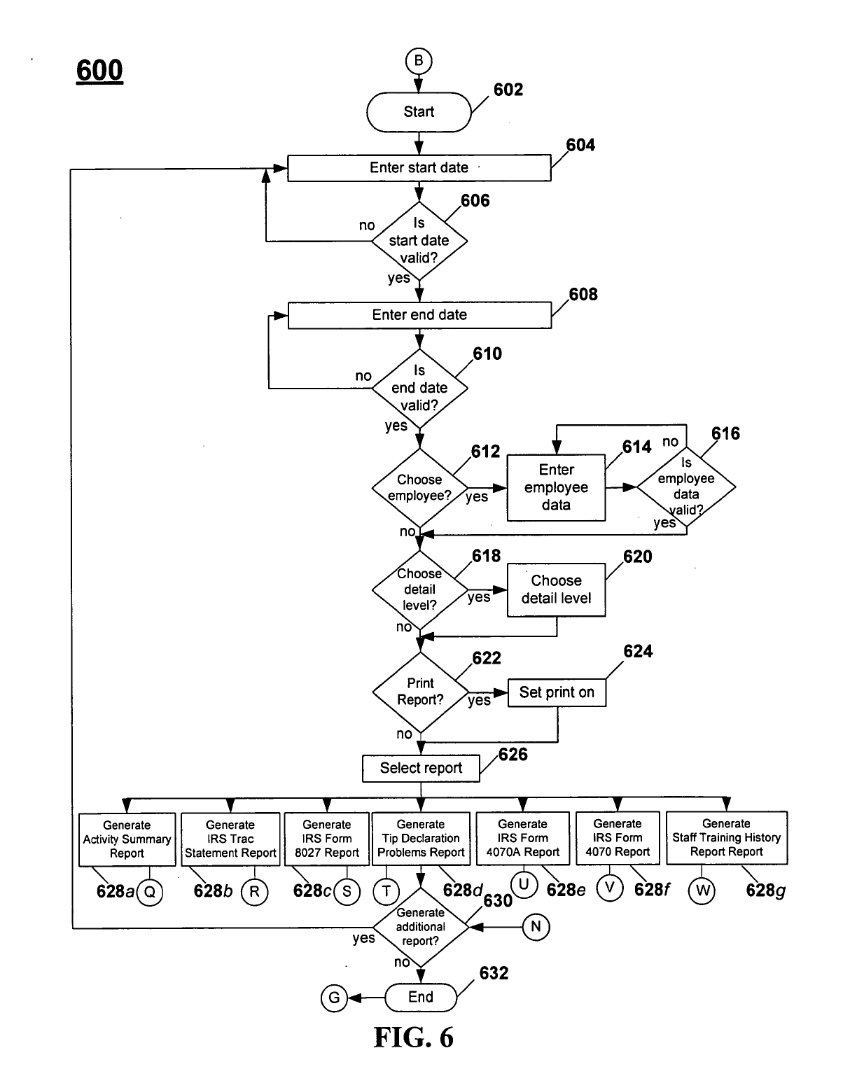

Turning next to FIG. 6, illustrated is a flow diagram of an exemplary embodiment for a process for generating reports via the exemplary GrataSoft embodiment of the present invention. Process 600 begins at 602, typically after being launched from a master process such as process 400 as described above with respect to FIG. 4. For example, process 600 may be launched by selecting reports function 430b (FIG. 4). Once reports function 430b has been initiated, process 600 proceeds to 604.

At 604, the user is prompted to enter a start date. Each generated report will include data for a specific time period during which such data occurred (e.g., the amount of tipouts that occurred during the time period, the amount of tips and/or gratuities that were received during the time period, etc.). The start date is the first day of the time period for the intended report. Process 600 then proceeds to 606 at which the start date is validated. For example, a start date may be valid whenever it occurs on or before the current date. Or, the start date may be valid if it occurs after the date that the system is first installed and on or before the current date. Such validity may also check for proper format (e.g., MM/DD/YYYY). Any method of validating the start date may be substituted without departing from the scope of the present invention. If, at 606, the start date is invalid, process 600 returns to 604 at which the user may re-enter the start date. However, if, at 606, the start date is valid, process 600 proceeds to 608.

At 608, the user is prompted to enter an end date. The end date is the last day of the time period for the intended report. Process 600 then proceeds to 610 at which the end date is validated. For example, an end date may be valid if it occurs on or before the current date and after the start date. Such validity may also check for proper format (e.g., MM/DD/YYYY). Any method of validating the end date may be substituted without departing from the scope of the present invention. If, at 610, the end date is invalid, process 600 returns to 608 at which the user may re-enter the end date. In other embodiments, process 600 may return to 604 to allow the user to re-enter both the start and end dates. However, if at 610, the end date is valid, process 600 proceeds to 612.

At 612, the user is prompted to choose all employees or a specific employee (e.g., a service provider). If, at 612, the user elects to generate a report for a specific employee, process 600 proceeds to 614. At 614, the user is prompted to enter employee data (e.g., employee ID, employee name, etc.). After the user enters the employee data, process 600 proceeds to 616, at which the employee data is verified. If the employee data is not valid, process 600 returns to 614 at which the user may re-enter the employee data. However, if the employee data is valid, process 600 proceeds to 618. Alternatively, if at 612, the users elected to print a report for all service providers, process 600 proceeds directly to 618.

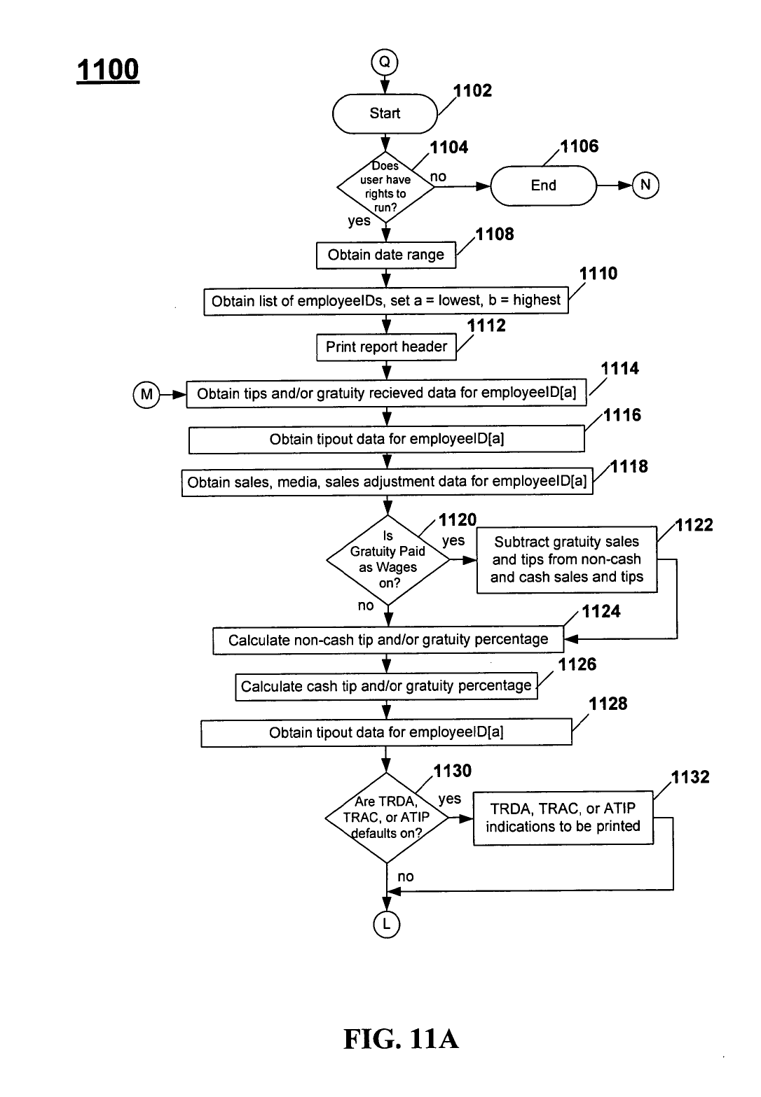

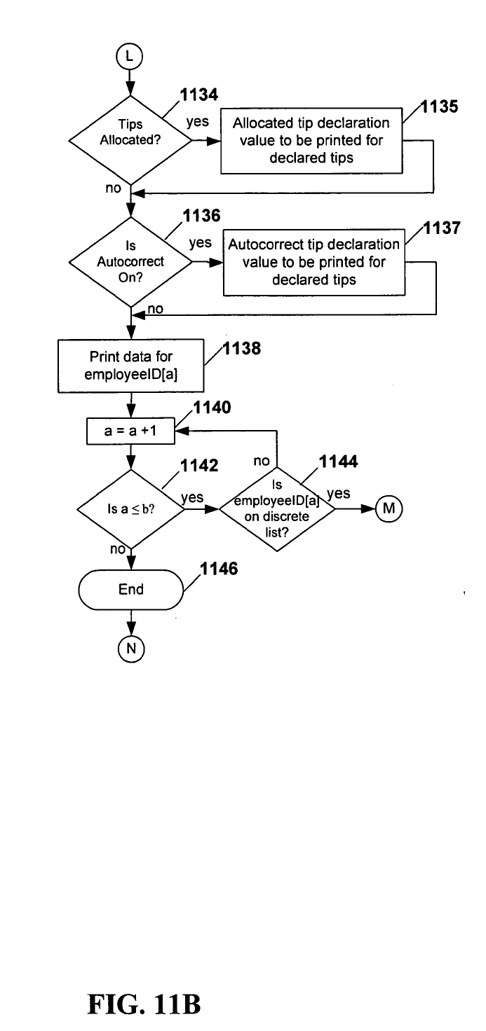

At 618, the user is prompted by the system to choose the detail level of the report. The detail level of the report may include, but is not limited, detailed information regarding employees, date, shift, meal period, sales categories, sale item, and the like. If, at 618, the user does not wish to receive a detailed report, the user selects “no detail”, and process 600 proceeds to 622. Selection of the “no detail” option will result in generation of a report having a standard level of detail. For example, if a user generates an Activity Summary Report such as that depicted in FIG. 11 and selects no detail, the generated report will sum the values (e.g., non-cash sales with tips, non-cash tips, cash sales, cash tips, gratuities, gross sales, etc.) for each contributor and recipient who worked during the selected data range. Such standard level of detail may be pre-programmed as a part of the GrataSoft system or may be defined by a user during the setup process. Alternatively, if, at 618, the user wishes to select a detail level, process 600 proceeds to 620 at which the user selects the desired detail level prior to process 600 proceeding to 622. For example, such detail level may be customized by the user via multiple prompts to the user, or it may be selected from a predefined list of detail levels.

At 622, the user is prompted to decide whether a hard copy of the report is required. If yes, process 600 proceeds to 624 at which the print feature is turned on. If this option is selected, the generated report will be sent to a printer or the like such as those described in greater detail with respect to FIG. 3. If, at 622, the user does not require a hard copy, process 600 proceeds directly to 626.

At 626, the user is prompted to select a report type. In the exemplary GrataSoft embodiment, such reports include, but are not limited to, activity summary report 628a, IRS TRAC statement report 628b, IRS Form 8027 report 628c, tip declaration problem report 628d, IRS form 4070A report 628e, IRS form 4070 report 628f, and staff training history report 628g. However, reports may be added, deleted, substituted, or modified without departing from the scope of the present invention. Once the user selects a report, process 600 proceeds to the report function 628a-628g associated with creation of the desired report. Details regarding exemplary methods of performing the report functions necessary to create the desired report are further detailed below with respect to processes 1100, 1300, 1500, 1700, 1900, 2100, and 2300, respectively, as illustrated in FIGS. 11A and 11B, 13A and 13B, 15A and 15B, 17, 19, 21, and 23, respectively. All such reports are generated using data entered by the user as well as information pre-programmed in the exemplary GrataSoft embodiment of the present invention (e.g., required calculations, report formats, etc.) as further detailed below. Also, such report functions include steps for printing and/or displaying the report to the user based upon the option selected by such user at 622.

Once the report function 628 has generated the desired report, process 600 proceeds to 630, at which the user may elect to generate another report. If yes, process 600 returns to 604. If no, process 600 proceeds to 632 at which process 600 is terminated. Since, in this exemplary embodiment, process 600 is invoked by process 400, process 600 returns control to process 400 at 426, at which the user may select another function from the main menu of the GrataSoft system.

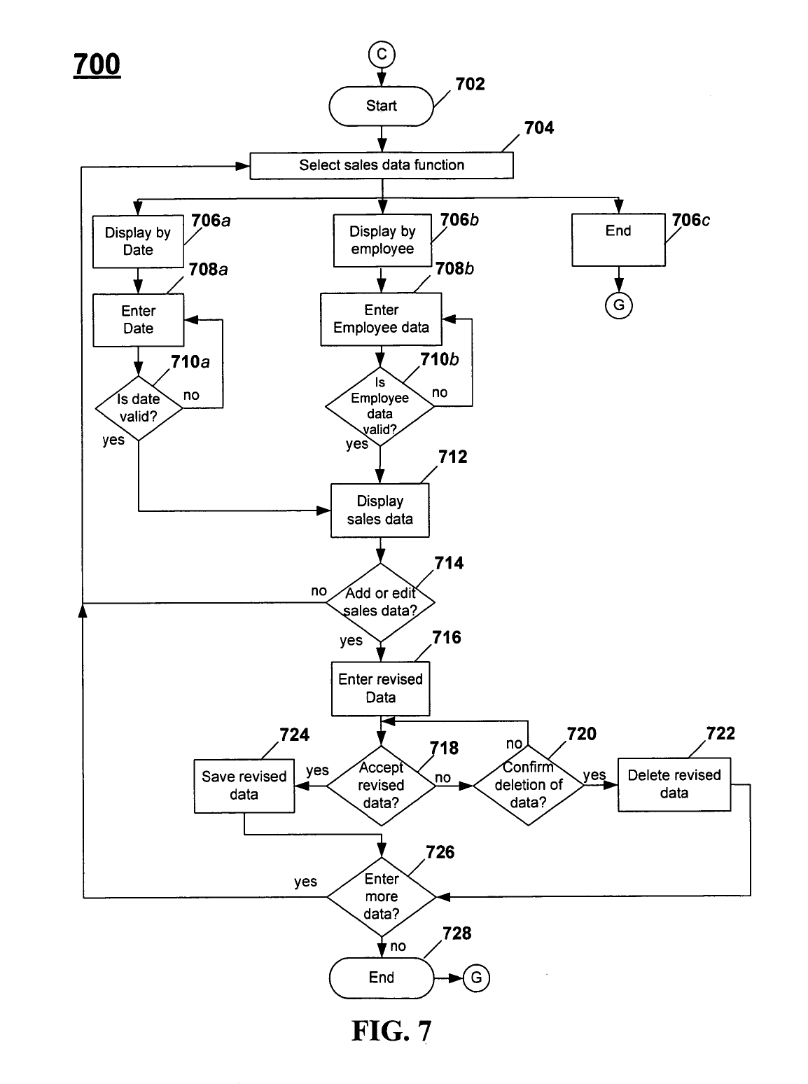

Referring now to FIG. 7, illustrated is a flow diagram of an exemplary embodiment for a process for entering sales data via the systems and methods of the present invention such as the exemplary GrataSoft system. In this embodiment of the present invention, the sales data may be manually entered. However, in embodiments that are associated with an IS such as the Aloha POS system, the sales, media, and sales adjustment data may be obtained directly from the IS such that the user is not required to enter the data manually. Such loading of the sales information is discussed in greater detail above with respect to FIG. 4. Process 700 begins at 702, typically after being launched from a master process such as process 400 as described above with respect to FIG. 4. For example, process 700 may be launched by selecting sales entry function 430c (FIG. 4). Once sales entry function 430c has been initiated, process 700 proceeds to 704.

At 704, the user selects a sales data function, for example, via a user interface such as such as those described in greater detail with respect to FIG. 3. In this exemplary embodiment of the present invention, the main functions include display by date function 706a, display by employee function 706b, and end function 706c. However, other sales data functions may be added, deleted, modified, or substituted without departing from the scope of the present invention. Once the user selects a function, process 700 proceeds to the selected function. For example, if the display by employee function is chosen, process 700 proceeds to 706b.

If at 704, the user has selected change date function 706a, process 700 proceeds to 706a at which a process to display sales by date begins. Process 700 then proceeds to 708a, at which the user is prompted to enter a date. After the user enters a date, process 700 verifies the date at 710a. For example, a valid date may include any date prior to and including the current date. If the date is invalid, process 700 returns to 708a at which the user may re-enter a date. However, if the date is valid, process 700 proceeds to 712.

If at 704, the user has selected display by employee function 706b, process 700 proceeds to 706b at which a process to display sales by employee begins. Process 700 then proceeds to 708b, at which the user is prompted to enter employee data. Other embodiments of the present invention envision an option in which all employees may be selected at 706a or 708b without departing from the scope of the present invention. After the user enters the employee data, process 700 verifies the employee data at 710b. For example, the employee data may be valid if it matches any employee data in the GrataSoft system database as entered during the process of entering a new employee (e.g., during process 800 of FIG. 8). If the employee data is invalid, process 700 returns to 708b at which the employee data may be re-entered. However, if the date is valid, process 700 proceeds to 712.

If at 704, the user has selected End Function 706c, process 700 proceeds to 706c at which process 700 is terminated. Since process 700 is invoked by process 400, process 700 returns control to process 400 at 426. This allows the user to select another function from the main GrataSoft menu.

At 712, the sales data is displayed to the user for her review. The sales data may include, but is not limited to, total cash sales, total non-cash sales, total sales for which gratuities have been applied, and sales adjustments. The latter sales adjustment data may include any voids or compensations (“comps”). Voids involve voiding an entered transaction before the voided item (e.g., an entrée, a drink, or the like) is created, and they may occur in situations such as cancellation of an order by a customer, the business establishment is unable to provide an ordered item, a service provider enters an erroneous order, and the like. Comps involve compensating a party for an entered transaction after the comped item is created. In either event, the service provider is often not tipped or provided gratuities for this amount and it is consequently excluded from his or her total sales.

At 712, if no sales data has been previously entered, zeroes will be displayed.

Other embodiments of the present invention envision an option in which a user may also print the sales data. After the sales data has been displayed or printed for the user, process 700 proceeds to 714. At 714, the user may elect to add or edit sales data. If, at 714, the user does not wish to add or edit the existing sales data, process 700 returns to 704. Alternatively, if at 714, the user would like to add or edit sales data, process 700 proceeds to 716. At 716, the user is prompted to enter the revised sales data along with the associated date of sale and employee responsible for making the sale. Process 700 then proceeds to 718.

At 718, the user may confirm whether she would like to accept the revised data. If yes, process 700 proceeds to 724, at which the data is saved prior to proceeding to 726. In some embodiments of the present invention, such saving involves saving the sales data to a database such as Microsoft® Access® using methods known in the art. The sales data is saved in a manner in which it is associated with peripheral information such as the date of sale, employee handling the sale, etc. However, alternate methods of saving sales data may be substituted (e.g., via registers, memory locations, etc.) without departing from the scope hereof. Alternatively, if the user does not wish to save the revised data, process 700 proceeds to 720, at which the user is prompted to confirm deletion of the data. If the user does not confirm, process 700 returns to 718. If the user does confirm, process 700 proceeds to 722, at which the data is deleted prior to proceeding to 726.

At 726, the user is prompted to enter additional sales data or to end entry of such data. If, at 720, the user would like to enter additional sales data, process 700 returns to 704. Or, if the user does not wish to enter additional sales data, process 700 proceeds to 728, at which process 700 is terminated. Since, in the exemplary embodiment, process 700 is invoked by process 400, process 700 returns control to process 400 at 426, at which a user may select another function from the main GrataSoft menu.

Referring next to FIG. 8, illustrated is a flow diagram of an exemplary embodiment of a process for entering employee data via the systems and methods of the present invention such as the exemplary GrataSoft system. In this embodiment of the present invention, the employee data may be manually entered. However, in embodiments that are associated with an IS such as the Aloha POS system, the employee data may be obtained directly from the IS such that the user is not required to enter the data manually. For example, if the user decides to add or edit data associated with an employee, the user simply enters the employee identification information (e.g., name, ID, etc.) and selects update. If the employee's data is present in the IS, such data will automatically be added or updated in the exemplary GrataSoft system. Or, in some embodiments of the present invention, such updated data will be presented to the GrataSoft system user and the user has the option to save the updated data (i.e., update the GrataSoft system with the data retrieved from the IS) or discard it (i.e., reject the data retrieved from the IS and retain the GrataSoft system employee record(s) as is). Such loading of the employee information is discussed in greater detail above with respect to FIG. 4. Process 800 begins at 802, typically after being launched from a master process such as process 400 as described above with respect to FIG. 4. For example, process 800 may be launched by selecting employees function 430d (FIG. 4). Once employees function 430d has been initiated, process 800 proceeds to 804.

At 804, the user selects an employee entry function, for example, via a user interface such as such as those described in greater detail with respect to FIG. 3. In this exemplary embodiment of the present invention, the employee entry functions include add new employee function 806a, edit current employee function 806b, and end function 806c. Once the user selects a function, process 800 proceeds to the selected function. For example, if the edit current employee function is chosen, process 800 proceeds to 806b.

If at 804, the user has selected the add employee function, process 800 proceeds to 806a at which a process to enter information for a new employee begins. Process 800 then proceeds to 808a, at which the user is prompted to assign an employee ID to the new employee. In some embodiments of the present invention, such employee ID may be a social security number, however, other employee IDs may be substituted without departing from the scope hereof. After the user enters an employee ID, process 800 verifies the employee ID at 810a. A valid employee ID would be any ID that complies with a predetermined format (e.g., xxx-xx-xxxx), if any, and any ID that is not currently assigned to another employee. The validation step may additionally require that the employee ID includes a certain quantity or order of numbers, characters, letters, or combinations thereof. Or, in alternate embodiments of the present invention, the process may automatically assign an employee ID to the new employee. In such embodiments, the system may display the employee ID to the user prior to proceeding to 812a.

If, at 810a the employee ID is invalid, process 800 returns to 808a at which the user may restart the process for assigning an employee ID to the new employee. However, if the employee ID is valid, process 800 proceeds to 812a, at which the user is prompted to input the employee information. Such information may be limited to the employee's name and social security number or may include additional information such as address, telephone number, emergency contact information, wage information, and the like. After the user has entered the employee's information, process 800 proceeds to 814.

If, at 804, the user has selected the current employee function, process 800 proceeds to 806b, at which a process to edit information for a current employee begins. Process 800 then proceeds to 808b, at which the user is prompted to enter the current employee's employee ID. After the user enters the employee ID, process 800 verifies the employee ID at 810b. For example, a valid employee ID may be any ID that has already been assigned to, or is otherwise associated with, an employee. If, at 810b the entered employee ID is invalid, process 800 returns to 808b at which a new employee ID may be entered. However, if the employee ID is valid, process 800 proceeds to 812b at which the data associated with the entered employee ID is displayed and the user is prompted to edit the employee information. Once the revised employee information is entered, process 800 proceeds to 814 at which the current employee information is displayed to the user. Process 800 then proceeds to 816.

At 816, the user is prompted to accept the changes to the employee information. If at 816, the user chooses to accept the employee data, process 800 proceeds to 822 at which the data is saved. In some embodiments of the present invention, such saving involves saving the sales data to a database such as Microsoft® Access® using methods known in the art. However, alternate methods of saving sales data may be substituted (e.g., via registers, memory locations, etc.) without departing from the scope hereof. Process 800 then proceeds to 826.

However, if at 816, the user decides not to save the new and/or revised employee data, process 800 proceeds to 818. At 818, the system prompts the user to delete the data. If the user does not wish to delete the employee information, process 800 returns to 814 at which the user may again review the employee information. If, at 816, the user confirms deletion of the new and/or revised employee information, process 800 proceeds to 820 at which the new or revised employee information is in fact deleted. In one aspect of the present invention, although a portion of the data associated with individual employees may be deleted, actual employees may not be deleted from the systems and methods of the present invention as such deletion may affect the accuracy of generated reports. However, is such embodiments, employees who are no longer employed by the business establishment may be marked as inactive to facilitate use of the system. Process 800 then proceeds to 826.

At 826, process 800 prompts the user to add or edit additional employees. If the user selects this option, process 800 returns to 804. If not, process 800 proceeds to 828 at which process 800 terminates. Since, in this exemplary embodiment, process 800 is invoked by process 400, process 800 returns control to process 400 at which a user may select another function from the main menu of the GrataSoft system. Similarly, if at 804, the user chooses the end function, process 800 proceeds to 806c at which process 800 returns control to process 400 at 426.

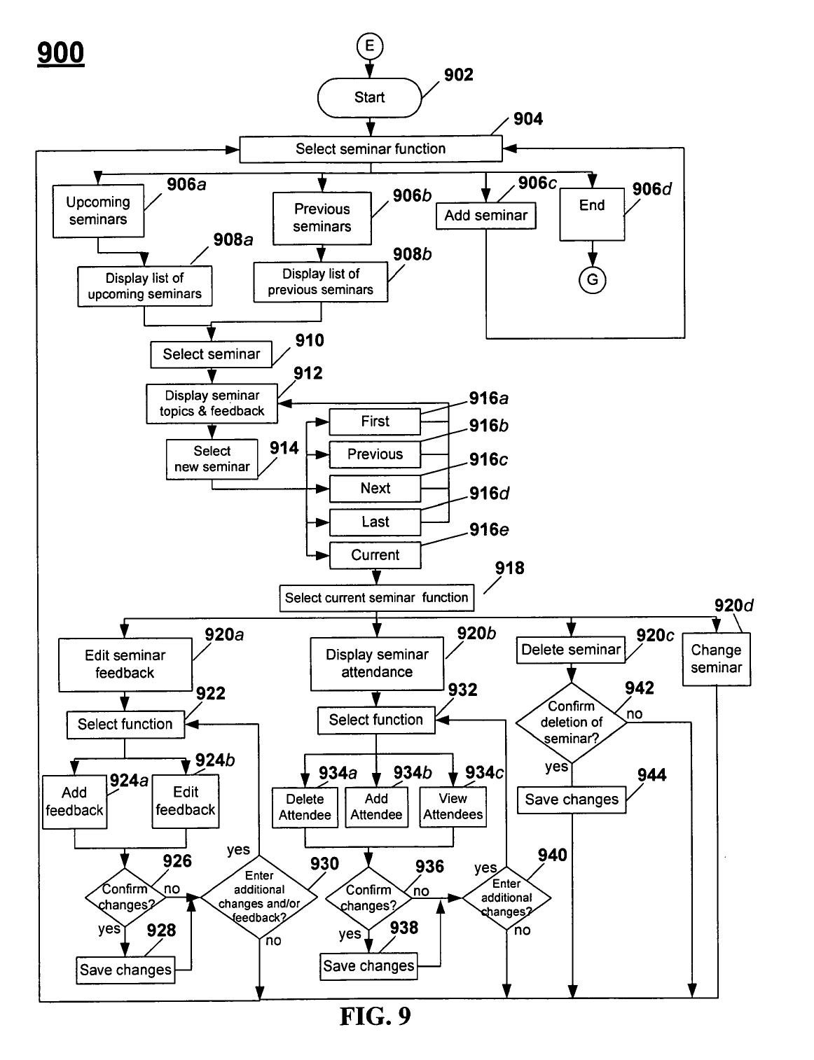

Turning now to FIG. 9, illustrated is a flow diagram of an exemplary embodiment of a process for tracking training including seminar topics, feedback, and attendance via the systems and methods of the present invention such as the exemplary GrataSoft system. The IRS requires such tracking for those business establishments entering an IRS program such as the TRAC program. Specifically, TRAC program participants must train all new employees upon hire and to train all existing employees quarterly on the legal requirements of reporting all cash and non-cash tips and/or gratuities to their employer. Therefore, the systems and methods of the present invention facilitate increased participation in voluntary programs offered by taxing authorities such as the IRS by simplifying compliance with the requirements thereof.

In some embodiments of the present invention, the user is automatically presented with training information such as upcoming training deadlines upon accessing the system for any reason. For example, an initial user logon screen may include such information. This ensures that system users are continuously reminded of the impending training deadlines, thereby increasing the likelihood that taxing authority-imposed deadlines will not be missed.

Process 900 begins at 902, typically after being launched from a master process such as process 400 as described above with respect to FIG. 4. For example, process 900 may be initiated by selecting training function 430e (FIG. 4). Once training function 430e has been initiated, process 900 proceeds to 904.

At 904, the user selects a training function via a user interface such as those described in greater detail with respect to FIG. 3. In the exemplary GrataSoft embodiment of the present invention, the main functions include upcoming seminar function 906a, previous seminar function 906b, add seminar function 906c, and end function 906d. Once the user selects a function, process 900 proceeds to the selected function. For example, if the previous seminar function 906b is chosen, process 900 proceeds to 906b.

If at 904, the user has selected the upcoming seminar function, process 900 proceeds to 904a at which a process to view and/or edit upcoming seminar information begins. Process 900 then proceeds to 908a, at which a list of upcoming seminars is displayed to the user. Process 900 then proceeds to 910. Similarly, if, at 904, the user has selected the previous seminar function 906b, process 900 proceeds to 908b, at which a list of previous seminars is displayed to the user prior to proceeding to 910.

At 910, the user selects a seminar from the list of upcoming or previous seminars, based upon her earlier selection of function 906a or 906b. Once the user has selected a seminar, process 900 proceeds to 912. At 912, the seminar topics and feedback are displayed to the user. Also, if the seminar has already occurred, the seminar attendees are also displayed to the user at 912. Process 900 the proceeds to 914 at which the user selects a new seminar. The options include first seminar 916a, previous seminar 916b, next seminar 916c, last seminar 916d, and current seminar 916e. Functions 916a-916d allow a user to navigate through a plurality of seminars. If a user selects 916a, process 900 returns to 912 and displays the topics and feedback for the first seminar. Similarly, if a user selects 916b, 916c, or 916d, process 900 returns to 912 and displays the topics and feedback for the previous, next, or last seminar, respectively. Since functions 916a-916d return the user to 912, the user may continue to toggle through the seminars until she finds the desired seminar. Once the user locates the desired seminar, she may choose current seminar 916e to make changes to the desired seminar.

After the user selects 916e, process 900 proceeds to 918 at which the user must select a current seminar function. These functions include edit seminar feedback function 920a, display seminar attendance function 920b, delete seminar function 920c, and change seminar function 920d. If, at 918, a user selects the edit feedback function, process 900 proceeds to 920a, at which a process to edit feedback begins. Process 900 then proceeds to 922, at which a user selects add feedback function 924a or edit feedback function 924b. For example, a user would typically select add feedback function 924a to enter new feedback information and would choose edit feedback function 924b when she would like to modify existing feedback. Once a user adds or edits feedback for the designated seminar at 924a or 924b, respectively, process 900 proceeds to 926.

At 926, the user is prompted to confirm the newly added or modified feedback. If the user does not wish to confirm the changes, process 900 proceeds directly to 930. If, at 924, the user confirms the changes, process 900 proceeds to 928, at which the newly added or modified feedback are saved prior to proceeding to 930. In some embodiments of the present invention, such saving involves saving the sales data to a database such as Microsoft® Access® using methods known in the art. However, alternate methods of saving sales data may be substituted (e.g., via registers, memory locations, etc.) without departing from the scope hereof. At 930, the user is prompted to enter additional changes. If, at 930, the user elects to enter additional changes and/or feedback, process 900 returns to 922. However, if at 930, the user does not wish to enter additional changes and/or feedback, process 900 returns to 904.

If, at 918, a user selects the display seminar attendance function, process 900 proceeds to 920b, at which a process to display or edit seminar attendance begins by displaying the attendees of the selected seminar. Process 900 then proceeds to 932, at which a user selects from delete attendee function 934a, add attendee function 934b, or view attendees function 934c. A user selects 934a if she would like to delete a seminar attendee. For example, this may be required if an employee is incorrectly added to a seminar attendance list or if a change in scheduling caused the attendee to miss the seminar. Or, alternatively, a user may select 934b to add an attendee to the selected seminar. Or, if the user wished to simply view the seminar attendees, she may select 934c. Once the user selects the desired function and performs the associated tasks, process 900 proceeds to 936 at which the user is prompted to confirm the input changes, if any.

If the user does not wish to confirm the changes, process 900 proceeds to 940. However, if at 936, the user confirms the changes, process 900 proceeds to 938 at which the changes are saved prior to proceeding to 940. At 940, the user is prompted to enter additional attendee changes. If, at 940, the user does wish to enter additional changes, process 900 returns to 932. However, if at 940, the user would like to enter additional changes, process 900 returns to 904.

If, at 918, a user selects the delete seminar function, process 900 proceeds to 920c, at which a process to delete the selected seminar begins. Process 900 then proceeds to 942, at which the user is prompted to confirm deletion of the seminar. If, at 942, the deletion is confirmed, process 900 proceeds to 944, at which the seminar is deleted and the changes are saved. For example, a user may wish to delete a seminar if another seminar has been created to replace it. If, at 942, a user decides not to delete a seminar, process 900 proceeds to 904.

Finally, if, at 918, a user selects the change seminar function, process 900 proceeds to 920d, at which a process to change the selected seminar begins. Process 900 then returns to 904, allowing the user to select a different seminar. A user may select this option to view or edit a different seminar, add a seminar, or terminate process 900. Adding a seminar is performed by selecting add seminar function 906c. Upon selecting this function, a user may add a new seminar and information related thereto such as date, time, topic, etc. After entry of the relevant information, the new seminar is added to the list of seminars and process 900 returns to 904. Or, if a user wishes to terminate process 900, the user chooses the end function at 904 and process 900 proceeds to 906d at which process 900 is terminated and execution of the GrataSoft embodiment of the present invention returns control to process 400 at 426.

Referring now to FIG. 10A, illustrated is a flow diagram of an exemplary embodiment of a process for setting up TRDA program criteria via the exemplary GrataSoft embodiment of the present invention. Such a process may be invoked by selecting program setup function 430f (FIG. 4). In some aspects of the present invention, the systems and methods of the present invention may be equipped with processes for configuring parameters for all available taxing authority programs. In such embodiments, upon selecting program setup function 430f (FIG. 4), a user may be prompted to select the particular taxing authority program that the establishment has entered or intends to enter. Present day, these options may include the TRAC program, EMTRAC program, TRDA program, and the ATIP program. However, taxing authority programs may be added or deleted as necessary as new programs are released or existing programs are terminated by the respective taxing authority. Once a particular program is selected, a process for configuring the parameters associated with such program (e.g., process 1000a as depicted in FIGS. 10A and 10B, process 1000b as depicted in FIG. 10C) is automatically executed.

With respect to process 1000a for configuring the parameters for a TRDA program, as discussed above, whenever a business establishment enters a TRDA commitment with the IRS, the business establishment is responsible for reporting those employees whose effective hourly rate is less than the IRS-determined minimums for the business establishment and/or those employees who declared tips and/or gratuities as a percentage of gross sales are less than the IRS-determined minimum percentage. The minimum IRS percentage and/or minimum IRS rate may be fixed for all employees, all meal periods, and all tasks or they may vary for different employees, meal periods, and/or tasks.

After the minimum IRS percentages and/or minimum IRS rates have been determined, which typically occurs at the onset of the TRDA agreement and following each annual renewal thereof, this information may be entered into the exemplary GrataSoft embodiment of the present invention. Such entry allows tip declaration problem reports such as tip declaration problem report 1800 to be automatically generated. Generation of such reports facilitates a business establishment's compliance with the IRS' TRDA agreement by automatically notifying the business establishment if a reporting must be made to the IRS, thereby increasing the ease of participating in the TRDA program, and, therefore, the likelihood that a business establishment will enter this voluntary agreement. The systems and methods of the present invention also reduce the administrative time required to comply with voluntary programs such as the TRDA program, which is likely to reduce the cost of such administration.

Process 1000a begins at 1002, typically after being launched from a master process such as process 400 as described above with respect to FIG. 4. For example, process 1000a may be launched by selecting program setup function 430f (FIG. 4). Once program setup function 430f has been initiated, process 1000a proceeds to 1004.

At 1004, the user selects a TRDA setup function from a user interface such as user interface 310. In this exemplary embodiment of the present invention, the main functions include edit default method function 1006a, edit existing method function 1006b, create new method function 1006c, and end function 1006d. Once the user selects a function, process 1000a proceeds to the selected function.

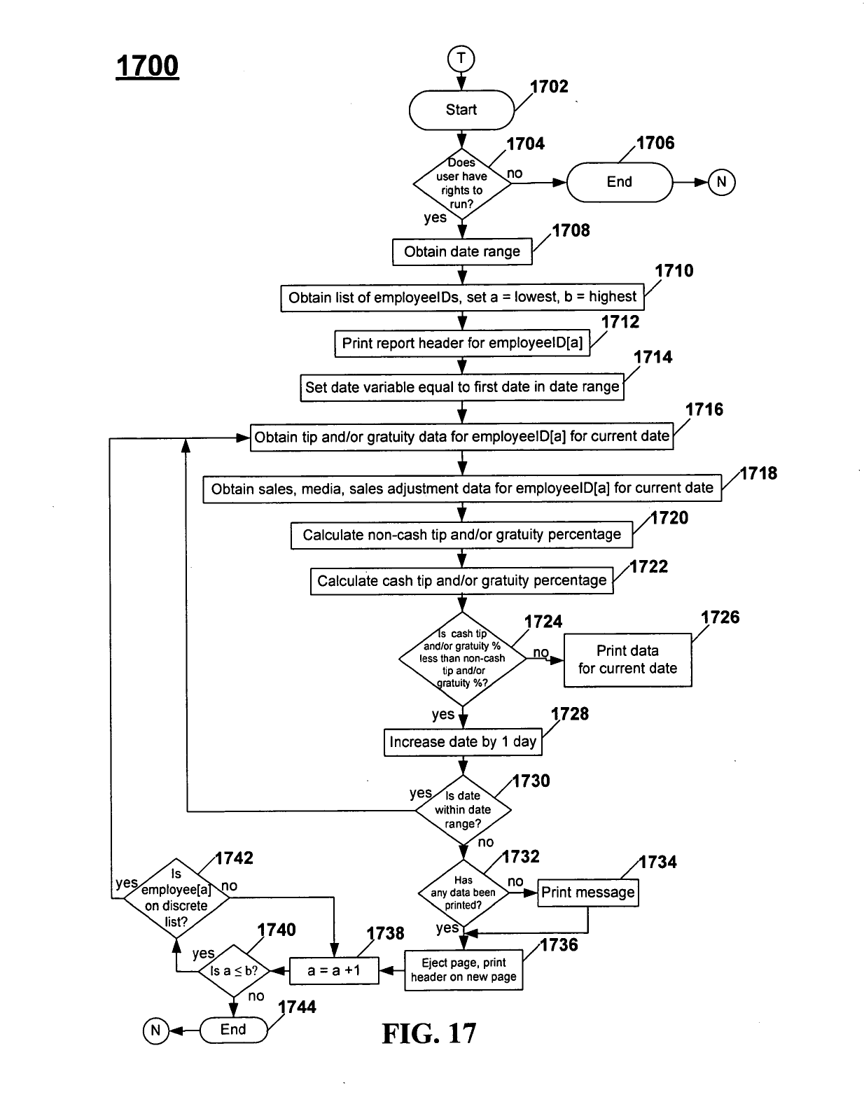

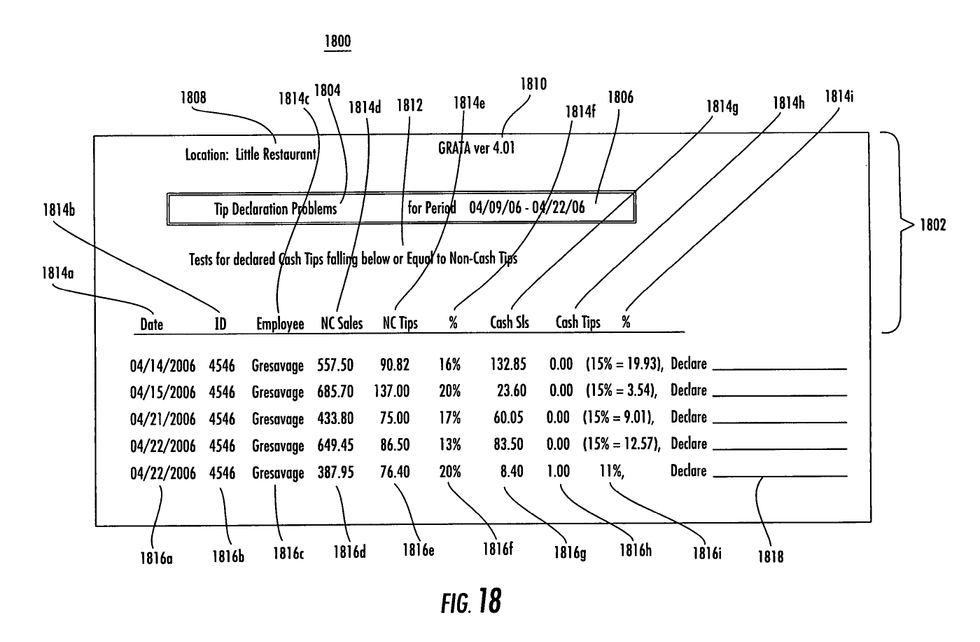

If at 1004, the user has selected the edit default method function, process 1000a proceeds to 1006a at which a process to edit the default minimum IRS percentage and/or default minimum IRS rate begins. Process 1000a then proceeds to 1008, at which the user is prompted to enter a default minimum IRS percentage and default minimum IRS rate. If these default values are not dependent upon an employee's task, meal period, or position, the default minimum IRS percentage or default minimum IRS rate is used to generate tip declaration problem reports such as tip declaration problem report 1800, as described in greater detail below with respect to FIGS. 17 and 18. After the user enters a default minimum IRS percentage and default minimum IRS rate, process 1000a proceeds to 1010. At 1010, the user is prompted to save any changes to the default values. If the user decides to save the data, process 1000a proceeds to 1012 prior to returning to 1004. At 1012, the default TRDA percentage and employee rate are saved to the default % and default rate variables, respectively. If the user does not wish to save her changes, process 1000a returns to 1004.

If, at 1004, the user has selected the edit existing method function, process 1000a proceeds to 1006b, at which a process to edit the TRDA criteria of an existing method begins. A user would choose this function if she wants to modify the TRDA criteria of an existing method of calculating TRDA. For example, the IRS requires a business establishment participating in the TRDA program to provide information pertaining to, or an update of, its minimum IRS percentages and/or rates on an annual basis for evaluation by the IRS. When the new TRDA is reevaluated, the TRDA criteria may be changed. Assuming the method of determining whether employee declarations are sufficient has not changed, edit existing method function 1006b allows the criteria for the existing method to be easily updated.

Alternatively, a user may select the create new method function at 1004 to create a new method of determining whether employee declarations are sufficient. For example, a user may need to create a new method if the IRS determines that the minimum IRS percentages and/or rates must be dependent upon criteria such as employee task, meal period, and/or employee. If the create new method function is selected, process 1000a proceeds to 1006c, at which a process to create a new method begins. Whether 1006b or 1006c is selected, process 1000a proceeds thereafter to 1014.

At 1014, the user is prompted to enter a method name. After the user enters a new or current method name, process 1000a proceeds to 1016. At 1016, the system queries the validity of the method name. For example, method names may be limited to alphanumeric characters only, may be limited in length, may be limited to a predetermined format (e.g., Method xx), etc. If the name meets the predetermined criteria and is therefore valid, process 1000a proceeds to 1018. However, if the name is invalid, process 1000a returns to 1014, at which the user may again enter a method name. However, embodiments of the present invention are envisioned in which the method names are predetermined and are unable to be edited by a user.

At 1018, the entered method is retrieved from the stored methods. If the user is creating a new method, the retrieved method is a generic method including default method information such as minimum IRS percentages and rates for each meal period, employee, and employee task. Process 1000a then proceeds to 1020, at which the user is prompted to select either edit/create method function 1022a or view method function 1022b. If a user selects 1022b, the criteria for the selected method are displayed to the user via a user interface such as user interface 310. When the user has completed this viewing, the user inputs an end view signal (e.g., the user may be prompted to hit “escape” or the like to exit viewing mode) and process 1000a returns to 1004. This viewing function allows a user to view the criteria for the selected method to determine whether it is sufficient as is or whether it requires a change.

If, however, the user chooses 1022a at 1020, a process to edit or create a method begins. Process 1000a then proceeds to 1028, at which the user begins the process of editing or creating taskIDs. A taskID is a number that corresponds to a specific task that an employee performs during a shift. Multiple taskIDs will be required if the minimum IRS percentages and/or rates are dependent upon the task performed by the employee. For example, in the exemplary restaurant embodiment, tasks may include food preparation, serving clients, cleanup, and the like. If the minimum IRS percentages and/or rates are not dependent upon the task performed by the employee, a single taskID will be entered. Process 1000a then proceeds to 1030.

At 1030, a variable i is set to a value of 1 and process 1000a proceeds to 1032. At 1032, the user is prompted to enter a minimum IRS percentage and rate for taskID[i]. If the minimum IRS percentage and/or rate for the specific taskID[i] varies with other criteria such as meal period and/or employee, such minimum values may be further defined as process 1000a proceeds. However, if the minimum values associated with taskID[i] do not vary with meal period and/or employee, then the minimum values entered at 1032 shall be the TRDA criteria used for generation of all tip declaration problem reports. After the user enters a minimum IRS percentage and rate for taskID[i], process 1000a proceeds to 1034 at which such minimum values are stored in association with the taskID[i]. Such values may be stored in a database or the like, however, other storage methods may be substituted without departing from the scope of the present invention. Process 1000a then proceeds to 1036.

At 1036, the user is prompted to enter (if it does not already exist) or scroll to the next taskID. If the user does not wish to enter or scroll to the next taskID, process 1000a proceeds to 1040. If the user does wish to enter or scroll to the next taskID, process 1000a proceeds to 1038, at which the value of i is incremented by 1. Process 1000a then returns to 1032 and repeats the process for taskID[2]. The user may continue to loop through steps 1032 to 1038 until she has scrolled through, or entered minimum IRS percentages and/or rates, for all available taskIDs. Once all taskIDs have been entered and/or edited, process 1000a proceeds to 1040. At 1040, the variable x is set to the quantity of taskIDs used in the current method such that the total quantity of taskIDs may be retained for use during the remainder of the process. Also at 1040, the variable y is set to the quantity of mpIDs used in the current method such that the total quantity of mpIDs may be retained for use during the remainder of the process

Process 1000a then proceeds to 1042, at which the user begins the process of editing or creating meal periods IDs (“mpIDs”). Each mpID corresponds to a specific meal period during which an employee works. If the minimum IRS percentages and/or rates are not dependent upon the meal period during which the tips and/or gratuities are collected, a single mpID will be entered. Process 1000a then proceeds to 1044.

At 1044, the variable i is set to the value of the variable x (i.e., the maximum quantity of taskIDs), and process 1000a proceeds to 1048. At 1048, the value of the variable i is queried. If i is less than or equal to 0, process 1000a proceeds to 1046, at which the value of the variable j and the value of the variable i are set to equal the value of variable y and variable x, respectively.

However, if at 1048, the value of i is greater than zero, process 1000a proceeds to 1050, at which an integer type variable j is set to equal the value of the variable y (i.e., the maximum quantity of mpIDs). Process 1000a then proceeds to 1052. At 1052, the user is prompted to enter a minimum IRS percentage and minimum IRS rate for the current taskID[i] and mpID[j]. After the user enters this minimum data, process 1000a proceeds to 1054 at which the minimum IRS percentage and minimum IRS rate are stored in association with the current taskID[i] and current meal period mpID[j]. Process 1000a then proceeds to 1058, at which the value of the variable j is queried. If the variable j is greater 0, process 1000a proceeds to 1060, at which the value of j is decremented by 1. Process 1000a then returns to 1052. The user may continue to loop through steps 1052, 1054, 1058, and 1060 until all meal period mpIDs corresponding to the current taskID[i] have been entered and/or edited. However, if at 1058, the variable j is less than or equal to 0, process 1000a proceeds to 1056 at which the variable i is decremented by 1 and the variable j is set to equal the value of variable y. Process 1000a then returns to 1048. If the variable i is still greater than 0, process 1000a repeats steps 1052 through 1060 until all mpIDs[j] have been entered for the current taskID[i]. Once minimum IRS percentages and rates have been assigned to all mpIDs for all taskIDs, the variable i will be equal to 0, and process 1000a proceeds to 1046. At 1046, the variable j is set to equal the value of the variable y and the variable i is set to equal the value of the variable x. Process 1000a then proceeds to 1062 of FIG. 10B.

Referring now to FIG. 10B, depicted is an extension of process 1000a as depicted in FIG. 10A. FIG. 10B begins at 1062, at which the user is prompted to decide whether specific minimum IRS percentages and rates must be entered for individual employees. If the minimum IRS values are the same for all employees, the user enters no and process 1000a proceeds to 1094. Alternatively, if different employees have different minimum IRS percentages and/or rates, the user answers yes and process 1000a proceeds to 1064.

At 1064, the value of j is queried. If j is less than or equal to 0, process 1000a proceeds to 1076, at which the variable j is set to the value of the variable y and the variable i is decremented by 1. Alternatively, if at 1064, the value of j is greater than zero, process 1000a proceeds to 1066, at which the user is prompted to enter an employeeID. Process 1000a then proceeds to 1068 at which the user is prompted to enter a minimum IRS percentage and rate for the current employeeID, taskID[i], and mpID[j]. After the user enters these minimum values, process 1000a proceeds to 1070, at which the minimum IRS percentage and rate are stored in association with the current employeeID, taskID[i], and mpID[j]. Process 1000a then proceeds to 1072, at which the user is prompted to determine whether a minimum IRS percentage and rate must be entered for another employee in conjunction with the current taskID[i] and mpID[j]. If yes, process 1000a returns to 1066, at which the user may continue to loop through steps 1066 to 1072 until she has entered all minimum IRS percentages and rates for all employeeIDs in conjunction with the current taskID[i] and mpID[j].

Once all minimum IRS percentages and rates have been entered for the selected taskID[j] and mpID[i], the user selects no at 1072 and process 1000a proceeds to 1074. At 1074, the variable j is decremented by 1. Process 1000a then returns to 1064. If j is still greater than 0, process 1000a repeats steps 1066 through 1074 until minimum IRS percentages and rates have been entered for all employees and all mpIDs[i] that corresponds to the current taskID[i]. Once all minimum IRS percentages and rates have been entered for the current taskID[i], as determined by j being equal to 0, process 1000a proceeds to 1076. At 1076, the variable j is set to equal the value of the variable y and the variable i is decremented by 1. Process 1000a then proceeds to 1078.

At 1078, the value of the variable i is queried. If the value of the variable i is less than or equal to 0, process 1000a proceeds to 1092, at which the variable j is set to equal the value of the variable y and the variable i is set to equal the value of the variable x. At 1092, the maximum values of variables i and j are preserved for future use by process 1000a.

However, if at 1078, the value of the variable i is greater than zero, process 1000a proceeds to 1080 at which the user is prompted to enter an employeeID and process 1000a proceeds to 1082. At 1082, the user is prompted to enter minimum IRS percentages and rates for the current employeeID, taskID[i], and mpID[j]. Process 1000a then proceeds to 1084 at which the minimum IRS percentages and rates are stored in association with the current employeeID, taskID[i], and mpID[j]. Process 1000a then proceeds to 1086 at which the user is prompted to determine whether additional minimum data must be entered for a new employeeID. If yes, process 1000a returns to 1080, at which the user may continue to loop through steps 1080 to 1086 until she has entered the minimum data for all employees in conjunction with the current taskID[i] and mpID[j].

Once all minimum IRS percentages and rates have been entered for the selected taskID[j] and mpID[i], the user selects no at 1086 and process 1000a proceeds to 1088. At 1088, the variable j is decremented by 1. Process 1000a then proceeds to 1090. If j is greater than 0, process 1000a repeats steps 1080 through 1090 until minimum IRS percentages and rates have been entered for all employeeIDs for the current mpID[i] and taskID[i]. Once all minimum IRS percentages and rates have been entered, as determined by j being equal to 0, process 1000a proceeds to 1076. At 1076, the variable j is set to equal the value of variable y and the variable i is decremented by 1. Process 1000a then proceeds to 1078. At 1078, the value of the variable i is queried. If the value of the variable i is less than or equal to 0, process 1000a proceeds to 1092, at which the variable j is set to equal the value of the variable y and the variable i is set to equal the value of the variable x. At 1092, the maximum values of variables i and j are preserved for future use by process 1000a.

Process 1000a then proceeds to 1094, at which the user is prompted to save the method. If yes, process 1000a proceeds to 1098 at which the method is saved. If no, the method is deleted at 1096. At 1099, the user is prompted to add or edit another method. If the user wishes to do so, process 1000a returns to 1004 (FIG. 10A). Otherwise, process 1000a returns to 1006d at which process 1000a is terminated and execution of the GrataSoft embodiment of the present invention returns control to process 400 at 426. This allows the user to select another function from the main GrataSoft menu.

Process 1000a allows a user to select a variety of methods for determining whether an employee's declared tips meet the IRS' requirements as determined by the TRDA agreement. The simplest method of making such a determination involves the use of the same minimum IRS percentage or rate for all employees regardless of the task performed or the meal period during which the tips and/or gratuities are collected. The most complex method of making this determination requires use of a different minimum IRS percentage or rate for each employee, wherein such percentage or rate varies on an individual employee basis upon the task performed and the meal period during which the tips and/or gratuities are collected. Other methods include, but are not limited to, determining whether an employee's declared tips meet the IRS' requirements as determined by the TRDA agreement based upon (i) meal period only, (ii) task only, (iii) employee only, (iv) employee and meal period, (v) employee and task, and (vi) task and meal period. However, alternate TRDA criteria may be added, deleted, or substituted for those described herein without departing from the scope of the present invention or as such criteria is required and/or allowed by the IRS' TRDA guidelines.

Turning next to FIG. 10C, illustrated is a flow diagram of an exemplary embodiment of a process for configuring ATIP program criteria via the exemplary GrataSoft embodiment of the present invention. Such a process may be invoked by selecting program setup function 430f (FIG. 4) and selecting an ATIP program.

Process 1000b begins at 1001, typically after being launched from a master process such as process 400 as described above with respect to FIG. 4. For example, process 1000b may be launched by selecting program setup function 430f (FIG. 4). Once program setup function 430f has been initiated, process 1000b proceeds to 1003.

At 1003, the user selects an ATIP setup function from a user interface such as user interface 310. In this exemplary embodiment of the present invention, the main functions include edit ATIP primary percentage function 1005a, edit existing method function 1005b, create new method function 1005c, and end function 1005d. Once the user selects a function, process 1000b proceeds to the selected function.

If at 1003, the user has selected the edit ATIP primary percentage function, process 1000b proceeds to 1005a at which a process to edit the ATIP primary percentage begins. Process 1000b then proceeds to 1007, at which the user is prompted to enter a default ATIP primary percentage. An ATIP primary percentage is the percentage of gross sales which may be attributed to all directly and/or indirectly tipped employees as declared tips. Once the value of total tips to be attributed to all business establishment employees has been determined, this value may be further allocated to individual employees based upon criteria such as hours worked, employee's gross sales, task performed and meal period worked. After the user enters an ATIP primary percentage, process 1000b proceeds to 1009. At 1009, the user is prompted to save any changes to the ATIP primary percentage value. If the user decides to save the data, process 1000b proceeds to 1011 prior to returning to 1003. At 1011, the ATIP primary percentage value is saved to the ATIPprimary_% variable. If the user does not wish to save her changes, process 1000b returns to 1003.

If, at 1003, the user has selected the edit existing method function, process 1000b proceeds to 1005b, at which a process to edit the ATIP criteria of an existing method begins. This ATIP criteria includes the criteria for attributing the total value of all calculated tips to individual employees based upon criteria such as task performed and meal period worked. A user would choose this function if she wishes to modify the ATIP criteria of an existing method of attributing tips. For example, the IRS requires a business establishment participating in the ATIP program to attribute tips to all employees using a reasonable attribution method. Such methods may be periodically reviewed and/or updated by the business establishment. The edit existing method function 1005b allows a user to easily update an existing method without re-entering all of the data related thereto.

Alternatively, a user may select the create new method function at 1003 to create a new method of attributing tips. If the create new method function is selected, process 1000b proceeds to 1005c, at which a process to create a new method begins. Whether 1005b or 1005c is selected, process 1000b proceeds thereafter to 1013.

At 1013, the user is prompted to enter a method name. After the user enters a new or current method name, process 1000b proceeds to 1015. At 1015, the system queries the validity of the method name. For example, method names may be limited to alphanumeric characters only, may be limited in length, may be limited to a predetermined format (e.g., Method xx), etc. If the name meets the predetermined criteria and is therefore valid, process 1000b proceeds to 1017. However, if the name is invalid, process 1000b returns to 1013, at which the user may again enter a method name. However, embodiments of the present invention are envisioned in which the method names are predetermined and are unable to be edited by a user.

At 1017, the entered method is retrieved from the stored methods. If the user is creating a new method, the retrieved method is a generic method including default ATIP method parameters. Process 1000b then proceeds to 1019, at which the user is prompted to select either edit/create method function 1021a or view method function 1021b. If a user selects 1021b, the criteria for the selected method are displayed to the user via a user interface such as user interface 310. When the user has completed this viewing, the user inputs an end view signal (e.g., the user may be prompted to hit “escape” or the like to exit viewing mode) and process 1000b returns to 1003. This viewing function allows a user to view the criteria for the selected method to determine whether it is sufficient as is or whether it requires a change.

If, however, the user chooses 1021a at 1019, a process to edit or create a method begins. Process 1000b then proceeds to 1023, at which the variable x is set to equal the total quantity of tasksIDS setup by a user via a function such as tasks function 430g (FIG. 4) and the variable y is set to equal the total quantity of mpIDs setup by a user via a function such as meal periods function 430i (FIG. 4). Tasks may include both directly tipped and/or indirectly tipped tasks. For example, an employee who directly takes an order from a patron is typically tipped directly by such patron. However, an employee who busses, or clears, a table for a patron is typically tipped indirectly (i.e., the employee taking the order provides the busser with a tipout, which may be a percentage of the tip received by the employee taking the order from the patron). Process 1000b then proceeds to 1025.

At 1025, the variable i is set to the value of the variable x (i.e., the total quantity of taskIDs), and process 1000b proceeds to 1027. At 1027, the value of the variable i is queried. If i is less than or equal to 0, process 1000b proceeds to 1041 (FIG. 10C). However, if at 1027, the value of i is greater than zero, process 1000b proceeds to 1029, at which an integer type variable j is set to equal the value of the variable y (i.e., the total quantity of mpIDs). Process 1000b then proceeds to 1031. At 1031, the user is prompted to enter an ATIP secondary percentage for the current taskID[i] and mpID[j]. The ATIP secondary percentage is the percentage of total tips to be attributed to all employees who performed a task having taskID[i] during all meal periods having mpID[j].

After the user enters the ATIP secondary percentage for the current mpID[j] and taskID[i], process 1000b proceeds to 1033 at which the ATIP secondary percentage is stored in association with the current taskID[i] and current meal period mpID[j]. Process 1000b then proceeds to 1037, at which the value of the variable j is queried. If the variable j is greater than 0, process 1000b proceeds to 1039, at which the value of j is decremented by 1. Process 1000b then returns to 1031. The user may continue to loop through steps 1031, 1033, 1037, and 1039 until all ATIP secondary percentages for all meal period mpIDs corresponding to the current taskID[i] have been entered and/or edited. However, if at 1037, the variable j is less than or equal to 0, process 1000b proceeds to 1035 at which the variable i is decremented by 1 and the variable j is set to equal the value of variable y. Process 1000b then returns to 1027. If the variable i is still greater than 0, process 1000b repeats steps 1031 through 1039 until all mpIDs[j] have been entered for the current taskID[i]. Once ATIP secondary percentages have been assigned to all mpIDs for all taskIDs, the variable i will be equal to 0, and process 1000b proceeds to 1041.

At 1041, at which the user is prompted to save the method. If yes, process 1000b proceeds to 1045 at which the method is saved. Process 1000b then proceeds to 1047, at which the ATIP secondary percentages for each combination of taskID and mpID are summed. Process 1000b then proceeds to 1049, at which the sum of ATIP secondary percentages is queried to determine whether it equals one hundred percent. If no, a problem exists with the entered method and process 1000b returns the user to 1019. At 1019, the user may opt to edit or view the previously entered method. This option allows the user to edit or view the entered data such that the mistake therein may be identified and/or corrected. When such mistakes are corrected, the sum of ATIP secondary percentages, as calculated at 1047, will equal one hundred percent.

If at 1049, the ATIP secondary percentages do equal one hundred percent, or if the user opted to delete the method at 1043, process 1000b proceeds to 1051. At 1051, the user is prompted to add or edit another method. If the user wishes to do so, process 1000b returns to 1003 (FIG. 10C). Otherwise, process 1000b returns to 1004d at which process 1000b is terminated and execution of the GrataSoft embodiment of the present invention returns control to process 400 at 426. This allows the user to select another function from the main GrataSoft menu.

Process 1000b allows a user to enter one method of attributing tips to all employees. However, other processes for defining other reasonable attribution methods may be substituted for process 1000b without departing from the scope of the present invention.

Referring now to FIG. 11, illustrated is a flow diagram of an exemplary embodiment of a process for creating an activity summary report such as exemplary activity summary report 1200 depicted in FIG. 12. As illustrated in FIG. 12, the activity summary report may include, but is not limited to, the following data fields: header 1202, title field 1204, date range field 1206, date and time printed field 1208, GrataSoft software version field 1210, column headers 1212, gratuity enabled/disabled field 1214, data fields 1218, employeeID fields 1220, and employee name fields 1222. However, other fields including but not limited to name and/or location of the establishment, employee hours, employee hourly rates, TRDA information, and ATIP information may be substituted without departing from the scope of the present invention.

The detail level of this report is chosen by the user during the report printing process. For example, in the exemplary GrataSoft embodiment, the detail level of the report is selected at 618 and/or 620 of process 600. In the depicted embodiment of the activity summary report shown in FIG. 12, the detail level has been selected to include non-cash and cash sales, non-cash and cash tips and gratuities, gross sales, gross tips, gross gratuities, tipout amounts, and non-cash and cash tips and gratuities as a percentage of non-cash and cash sales, respectively. The information is provided for all employees who worked during the selected date range as defined in date range field 1206.

However, in some aspects of the present invention, the detail level may also be affected by the status of system defaults such as TRDA, ATIP, Allocation Enabled, Autocorrect, Gratuity Paid as Wages, and Tips Paid as wages. For example, if Gratuities Paid as Wages is set to “off”, gratuities are included with tips (i.e., they are not broken out as a separate category). Therefore, column headers 1212 such as Grat Sls, Grat, +Grat, and −Grat are omitted from the report as well as the data associated therewith. Similarly, if the TRDA system default is set to “on”, TRDA indicators are added to the report to indicate which employees are participating in the TRDA agreement and whether any tips have been added to the employee's declared tips to ensure that the TRDA requirements are met. Any tip adjustments (i.e., the amount that the employee's declared tips have been increased to avoid under-reporting of same) may be declared in an independent column to facilitate reporting of such tip adjustments separate from declared tips to the taxing authority, payroll company, etc. Or, if the ATIP system default is set to “on”, ATIP indicators are added to the report to indicate which employees are participating in the ATIP program.

Process 1100 begins at 1102, typically after being launched from a master process such as process 600 as described above with respect to FIG. 6. For example, process 1100 may be launched by selecting generate activity summary report function 628a at 626 of process 600. When process 600 reaches 628a, process 1100 is initiated and process 1100 proceeds to 1104.

At 1104, process 1100 queries the user rights. Such process is similar to that described above for 428 of process 400. If the user does not have the required rights, process 1100 proceeds to 1106, at which process 1100 terminates. In this embodiment of the present invention, process 1100 returns to 630 of process 600, at which the user is given the option to generate another report.

However, if at 1104, the user has the rights to generate an activity summary report, process 1100 proceeds to 1108. At 1108, process 1100 obtains the date range for the report that is to be generated. In the exemplary GrataSoft embodiment of the present invention, the user has entered this date range at steps 604 through 610 of function 600 (FIG. 6). Once the date range is obtained, process 1100 proceeds to 1110.

At 1110, process 1100 obtains a discrete list of all employees having transactions occurring during the selected date range. Additionally, the integer variables a and b are set equal to the lowest and highest employeeID, respectively, from the set of employee IDs that correspond to the discrete list of employees. In this embodiment of process 1100, “all employees” were selected at 614 of process 600. However, if the user selected a single employee at 614, a would be set to equal the value of the employee's ID and b would be set to equal the value of the employee's ID incremented by 1 such that, as process 1100 proceeds, only one iteration of employee IDs would result.

Process 1100 then proceeds to 1112, at which header 1202 is printed. In some aspects of the present invention, the header format may vary depending upon the status of the system defaults. In this embodiment of the present invention, set print on is selected at 624 of process 600. In embodiments in which set print on is not selected, the report would be generated as described with respect to process 1100, but would only be displayed to the user via a monitor such as such as those described in greater detail with respect to FIG. 3. That is, the activity summary report will only be printed if the set print on feature is selected at 624 of process 600 (FIG. 6). In this embodiment, header 1202 includes title field 1204, date range field 1206, date and time printed field 1208, GrataSoft software version field 1210, column headers 1212, and gratuity enabled/disabled field 1214. However, other fields and/or information may be substituted for header 1202 without departing from the scope of the present invention. The data for these fields are obtained from storage locations of an associated processing unit such as processing unit 302 such as registers, database locations, and the like. Also, although process 1100 prints data as it is obtained from storage, alternate embodiments are envisioned in which all information is obtained prior to printing any portion of the report without departing from the scope of the present invention.

After header 1202 has been printed, process 1100 proceeds to 1114 at which process 1100 obtains the tip and/or gratuity data received for the employee associated with employeeID[a] and the selected date range. This data is obtained from storage locations of an associated processing unit such as processing unit 302 such as registers, database locations, and the like. In embodiments in which the GrataSoft system is not interfaced to an IS, the tip and/or gratuity data has been previously entered and stored in such locations via execution of a process such as process 500 by the user. Such entries may include attributed tips in lieu of, or in addition to, actual declared tips if the business establishment and service providers are enrolled in the ATIP program. Also, in embodiments of the present invention that are associated with an IS, the non-cash tip and/or gratuity data may be obtained directly from the IS system such that the user is not required to enter such data. In some embodiments of the present invention, the data received from the IS may be independently stored as a data file of the exemplary GrataSoft system. However, depending upon the interfaced system, if any, cash tip and/or gratuity data may still be entered manually via a process such as process 500. Process 1100 then proceeds to 1116.

At 1116, process 1100 obtains the tipout data for the selected date range and for the employee associated with employeeID[a]. The tipout data includes tips and/or gratuities that were received by the employee having employeeID[a] from other employees, as well as the tipouts provided by the employee having employeeID[a] to other employees. This data is obtained from storage locations of an associated processing unit such as such as those described in greater detail with respect to FIG. 3 such as registers, database locations, and the like. The tip and/or gratuity data has been previously entered and stored in such locations via execution of a process such as process 500 by the user (e.g., at step 546). Process 1100 then proceeds to 1118.

At 1118, process 1100 obtains the sales data, media data (i.e., data regarding how each sale is paid (e.g., credit card, cash, etc.)), and sales adjustment data for the employee associated with employeeID[a] during the desired date range. The sales and sales adjustment data (e.g., voids and comps) are discussed above in greater detail with respect to FIG. 7. This data is obtained from storage locations of an associated processing unit such as such as those described in greater detail with respect to FIG. 3 such as registers, database locations, and the like. The sales media, media data, and sales adjustment data have been previously entered and stored in such locations via execution of a process such as process 700 by the user. Process 1100 then proceeds to 1120.

At 1120, process 1100 queries the system defaults to determine whether the Gratuities Paid as Wages system default is set to “on”, and, therefore, gratuities are to be categorized separately. Such system defaults are entered via a system default function such as system default function 430k (FIG. 4). It may be useful to categorize gratuity sales and gratuities separate from non-cash and cash sales and tips because the IRS requires that an employer pay gratuities with the employee's hourly wage in the form of a paycheck or the like (rather than paying such gratuities in cash at the end of the employee's shift). If the Gratuities Paid as Wages system default is set to “on”, process 1100 proceeds to 1122, at which the gratuity sales and gratuities are subtracted from the non-cash/cash sales and tips, respectively. Process 1100 then proceeds to 1124. Or, if gratuities are not to be paid separately, process 1100 proceeds directly from 1120 to 1124. Or, in some embodiments of the present invention, tips may also be paid as wages in addition to gratuities.

At 1124, the non-cash tip and/or gratuity percentage for the employee associated with employeeID[a] is calculated. This percentage is determined by dividing the gross non-cash tips by the gross non-cash sales, wherein the gross non-cash sales have been adjusted to account for any sales adjustments. Similarly, at 1126, the cash tip and/or gratuity percentage for the employee associated with employeeID[a] is calculated. This percentage is determined by dividing the gross cash tips by the gross cash sales, wherein the gross non-cash sales have been adjusted to account for any sales adjustments. Also, in some embodiments of the present invention, the gross cash sales includes non-cash sales for which a tip was paid in cash. This inclusion ensures that the cash tip and/or gratuity percentage is accurate. Otherwise, if such sales were included in the non-cash sales, the non-cash tip and/or gratuity percentage would be lower than the actual percentage and the cash tip and/or gratuity percentage would be higher than the actual percentage. It should be noted that if Gratuity Paid as Wages is set to “on” as determined at 1120, gratuities will be excluded from the calculations performed at 1124 and 1126. Otherwise, if this system default is set to “off”, gratuities will be included as a part of non-cash and cash sales and tips. Process 1100 then proceeds to 1128.

At 1128, process 1100 obtains the tipout data for the employee associated with employeeID[a] during the desired date range. Tipouts are discussed above in greater detail with respect to FIGS. 5A and 5B. This data is obtained from storage locations of an associated processing unit such as such as those described in greater detail with respect to FIG. 3 such as registers, database locations, and the like. The tipout data has been previously entered and stored in such locations via execution of a process such as process 500 (FIGS. 5A and 5B) by the user. Process 1100 then proceeds to 1130.

At 1130, the TRDA, TRAC, and ATIP default settings are queried to determine their status. If all statuses are set to “off”, process 1100 proceeds to 1134. Or, if one of the statuses is set to “on”, process 1100 proceeds to 1132, at which process 1100 is indexed to print TRDA, TRAC, or ATIP indications such as TRDA indications 1224 (FIG. 12) at 1138. Such indications notify the reader of the report that specific service providers are enrolled in the TRDA agreement, that the business establishment is enrolled in a TRDA agreement or TRAC commitment, and/or that the specific service providers and business establishment are enrolled in the ATIP program. Process 1100 then proceeds to 1134, which is depicted in FIG. 11B.

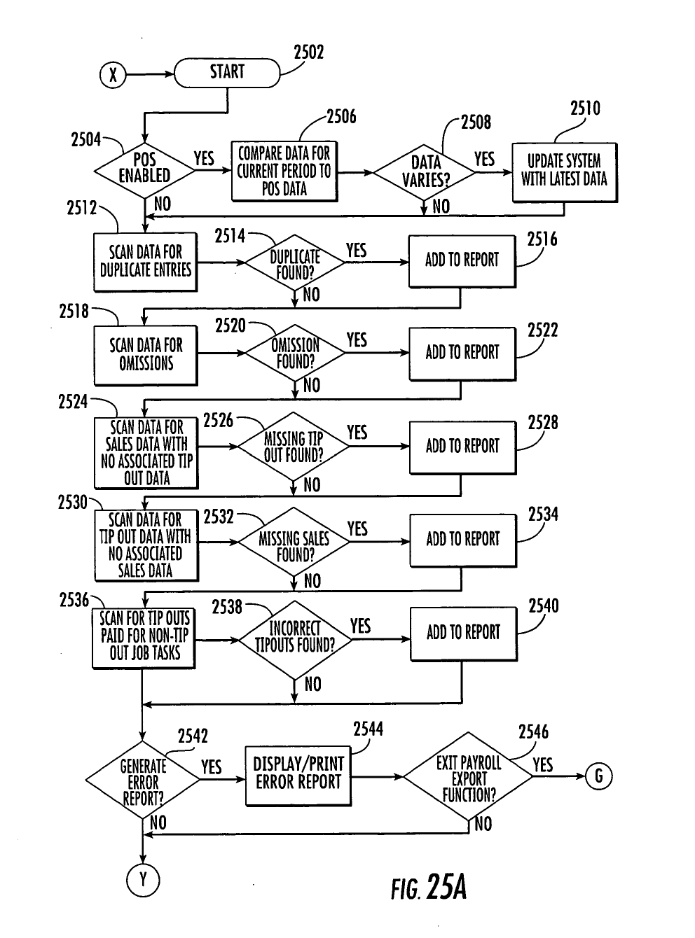

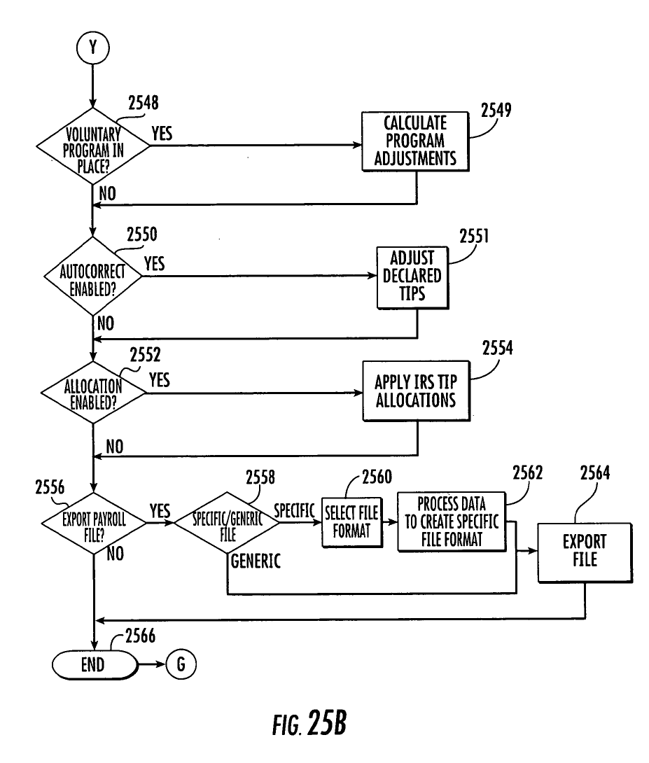

Turning next to FIG. 11B, illustrated is an extension of the flow diagram of an exemplary embodiment of a process for creating an activity summary report depicted in FIG. 11A. At 1134, process 1100 determines whether any tips have been allocated. If yes, process 1100 proceeds to 1135, at which the allocated tip declaration value (i.e., the total tips declared including any allocated tips added to the actual tips declared by the service provider) is retrieved for printing in the declared tips data fields at 1138. Tips may be allocated, for example, at 2554 of process 2500 as discussed in greater detail below with respect to FIGS. 25A and 25B. After completion of 1135, or if the Allocation Enabled status is set to “off”, as determined, for example, at 2552 of process 2500, process 1100 proceeds directly to 1136.

At 1136, the Autocorrect feature is queried. If this feature is set to “on”, the adjusted tip declaration value (i.e., the total tips declared including any automatic increases to the actual tips declared by the service provider to ensure the service provider meets the requirements of any voluntary programs (e.g., TRDA) in which the employee and/or employer are participating) is retrieved for printing in the declared tips data fields at 1138. Tips may be adjusted, for example, at 2551 of process 2500 as discussed in greater detail below with respect to FIGS. 25A and 25B. After completion of 1137, or if the Autocorrect status is set to “off”, as determined, for example, at 2550 of process 2500, process 1100 proceeds directly to 1138, at which the actual tips declared by the service provider will be printed in the respective service provider's declared tips data field. Process 1100 then proceeds to 1138.

At 1138, all of the data required for the employeeID field 1220, employee name field 1222, and data fields 1218 associated with the employee having employeeID[a] has been obtained or calculated. At 1126, this data is printed in employeeID field 1220, employee name field 1222, and data fields 1218 in an order that corresponds to the data contained in column headers 1212. Also, if the TRDA, TRAC, or ATIP system defaults are set to “on”, TRDA, TRAC, or ATIP indications, respectively, such as TRDA indications 1224 are printed. Furthermore, if the Autocorrect status is set to “on”, tip adjustments 1226 (i.e., the amount that the employee's declared tips have been increased to avoid under-reporting of same) are printed. Process 1100 then proceeds to 1140.

It should be noted that whenever tips are attributed to an employee, such attribution does not separate cash tips from non-cash tips. Consequently, no data will be printed in the non-cash tips, the cash tips, and the—Tip columns. Rather, the total attributed tips will be printed in the Gross Tips and Declared Tips columns. Additionally, an ATIP indication similar to TRDA indication 1224 may be printed to notify the user that the respective employee is enrolled in the ATIP program.

At 1140, the value of the variable a is incremented by 1 and process 1100 proceeds to 1142. At 1142, process 1100 queries the value of the variable a. If this value is less than or equal to b, process 1100 proceeds to 1144. At 1144, process 1100 queries the discrete list of employees generated at 1110. If at 1144, the employee associated with employeeID[a] is included in the discrete list, process 1100 returns to 1114. However, if the employee associated with employeeID[a] is not on the discrete list, process 1100 returns to 1140 and steps 1142 and 1144 are repeated until the details for all employees included in the discrete list have been printed.

If at 1142, a is greater than b, process 1100 proceeds to 1146 at which it terminates. Since process 1100 was launched by process 600, process 1100 returns to 630 of process 600, at which the user is given the option to generate another report.

The activity summary reports generated by process 1100 aid the business establishment in compliance with voluntary programs such as the TRAC and EMTRAC commitments and the TRDA agreement. For example, TRAC requires generation of written statements on a periodic basis, wherein the period is no less than monthly and the statements include tips and/or gratuities attributable to all employees and each employee's tip and/or gratuity information. The TRAC commitment further requires the business establishment to maintain records of the gross receipts subject to tipping and the non-cash receipts including the non-cash tips for at least four (4) years after the 15^{th} day of April following the calendar year to which the records pertain. The business establishment must also make the following records available upon request of the IRS: quarterly totals for statistical samplings of gross receipts subject to tipping, non-cash receipts including non-cash tips, total non-cash tips, and total tips reported. Similarly, the EMTRAC commitment requires the business establishment to maintain the following records for at least four (4) years after the 15^{th} day of April following the calendar year to which the records relate: (i) gross receipts subject to tipping, (ii) non-cash receipts showing non-cash tips and/or gratuities, and (iii) upon the request of the IRS, to make the quarterly totals available for statistical sampling of gross receipts subject to tipping, non-cash receipts including non-cash tips, total non-cash tips, and total tips and/or gratuities reported by the employees. Additionally, business establishments participating in the TRDA agreement are required to annually submit either a revised minimum IRS percentage or a revised minimum IRS rate (depending upon which minimum standard was originally selected by the employer) to the IRS, based upon the information received from its employees for the previous year. Generation of reports such as the activity summary report on a periodic basis enables the business establishment to easily and inexpensively meet these written statement, record keeping, and submission requirements with minimal administration time.

For employers participating in the TRDA agreement, the activity summary report may include differing data from that depicted in activity summary report 1200 of FIG. 12. For example, depending upon whether the IRS has required the employees of the business establishment to meet a minimum IRS percentage or minimum IRS rate requirement, such reports may include total tip and gratuity percentages (i.e., the total value of all received tips and gratuities, whether cash or non-cash, divided by gross sales, wherein gross sales includes both cash and non-cash sales) as a percentage of gross sales to facilitate easy comparison of each employee's total tip and gratuity percentage with the minimum IRS percentage. Or, if the IRS has set a minimum IRS rate requirement, such reports may calculate each employee's effective hourly rate to facilitate easy comparison of same with the minimum IRS rates. In scenarios in which such minimum IRS percentages and rates are dependent upon the particular employee and the associated task and/or meal period, the reporting of each employee's total tip and gratuity percentage or effective hourly rate may be detailed in the same manner as the IRS minimum requirements (e.g., per task performed, per meal period worked, etc.).

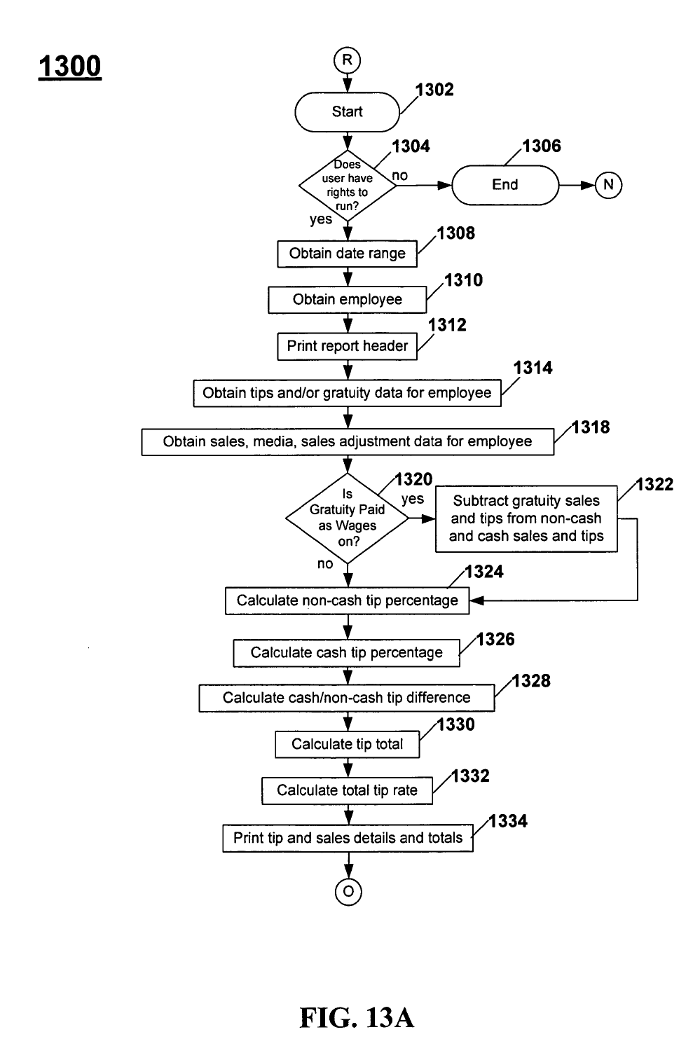

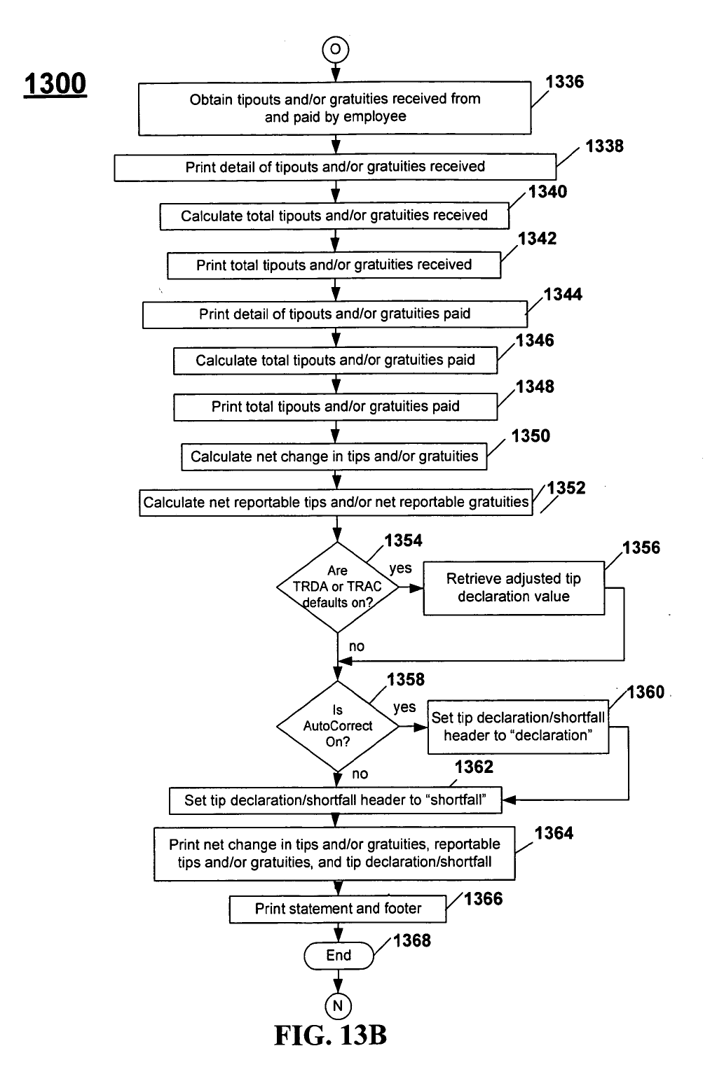

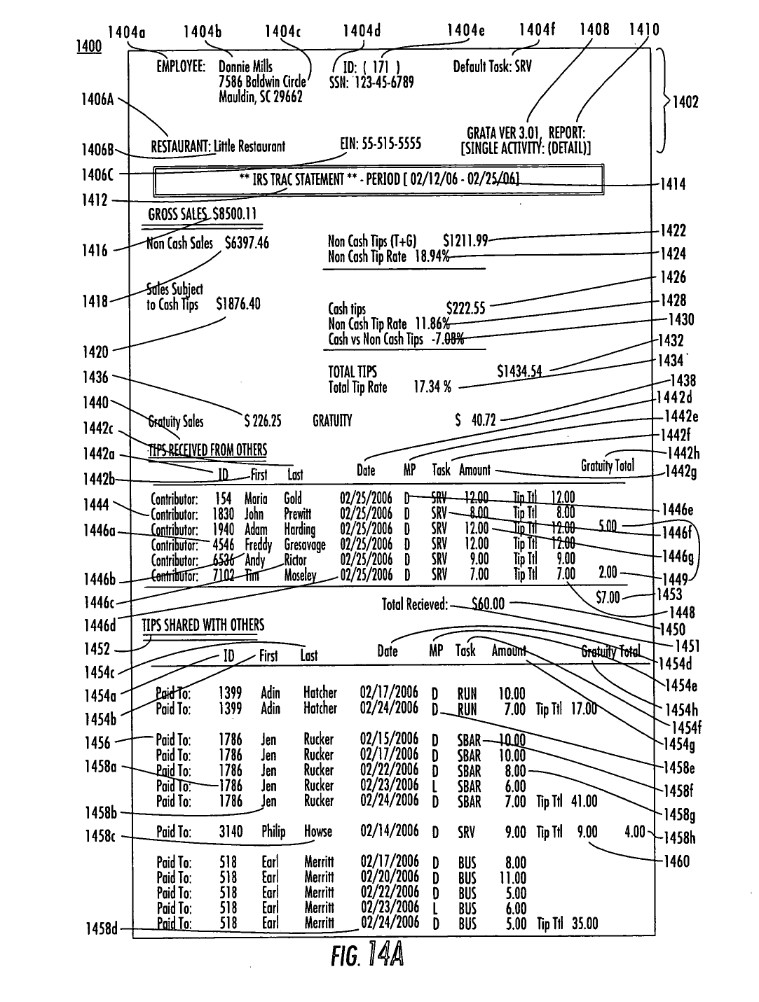

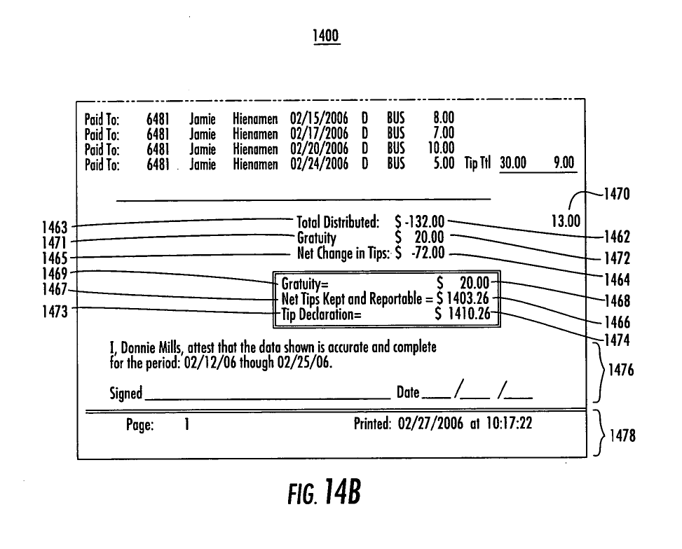

Referring now to FIG. 13A, illustrated is a flow diagram of an exemplary embodiment of a process for creating an IRS TRAC statement report such as IRS TRAC statement 1400 as depicted in FIGS. 14A and 14B. FIG. 14B depicts a continuation of the IRS TRAC statement report 1400 depicted in FIG. 14A, as indicated by the dotted line. Process 1300 begins at 1302, typically after being launched from a master process such as process 600 as described above with respect to FIG. 6. For example, process 1300 may be launched by selecting IRS TRAC statement report 628b at 624 of process 600. When process 600 reaches 628b, process 1300 is initiated and process 1300 proceeds to 1304.

At 1304, process 1300 queries the user rights. Such process is similar to that described above for 428 of process 400. If the user does not have the required rights, process 1300 proceeds to 1306, at which process 1300 terminates. In this embodiment of the present invention, process 1300 returns to 630 of process 600, at which the user is given the option to generate another report.

However, if at 1304, the user has the rights to generate a TRAC statement, process 1300 proceeds to 1308. At 1308, process 1300 obtains the date range for the report that is to be generated. In the exemplary GrataSoft embodiment of the present invention, the user has entered this date range at steps 604 through 610 of function 600 (FIG. 6). Once the date range is obtained, process 1300 proceeds to 1310.

At 1310, process 1300 obtains the employee for which the TRAC statement will be generated. In this exemplary GrataSoft embodiment of process 1300, the specific employee for whom the TRAC statement will be generated is selected during the print report process. For example, such employee may be selected at step 614 of process 600 (FIG. 6).

Process 1300 then proceeds to 1312, at which header 1402 is printed. In this embodiment of the present invention, set print on is selected at 624 of process 600 (FIG. 6). In embodiments in which set print on is not selected, the report would be generated as described with respect to process 1300, but would only be displayed to the user via a monitor such as such as those described in greater detail with respect to FIG. 3. That is, the TRAC statement will only be printed if the set print on feature is selected at 624 of process 600 (FIG. 6). In this embodiment, header 1402 includes employee data fields 1404, restaurant data field 1406, GrataSoft software version field 1408, report setting field 1410, report title field 1412, and date range field 1414. In this exemplary embodiment, employee data fields 1404 may include employee identifier field 1404a, employee name field 1404b, employee address field 1404c, employee social security number field 1404d, employee ID field 1404e, and employee default task field 1404f. This exemplary embodiment also includes restaurant data fields 1406 such as employer identifier field 1406a, restaurant name field 1406b, and employer identification number (“EIN”) field 1406c. However, other fields and/or information may be substituted for header 1402, employee data fields 1404, and restaurant data fields 1406 without departing from the scope of the present invention. For example, these fields may be modified as necessary to meet the requirements or specifications of the IRS. The data for these fields are obtained from storage locations of an associated processing unit such as processing unit 302 such as registers, database locations, and the like. Also, although process 1300 prints data as it is obtained from storage, alternate embodiments are envisioned in which all information is obtained prior to printing any portion of the report without departing from the scope of the present invention.

After the header has been printed, process 1300 proceeds to 1314 at which process 1300 obtains the tip and/or gratuity data associated with the selected date range and the employee for which the TRAC statement will be generated. This data is obtained from storage locations of an associated processing unit such as processing unit 302 such as registers, database locations, and the like. In embodiments in which the GrataSoft system is not interfaced to an IS, the tip and/or gratuity data has been previously entered and stored in such locations via execution of a process such as process 500 (FIGS. 5A and 5B) by the user. However, in embodiments of the present invention that are associated with an IS, the non-cash tip and/or gratuity data may be obtained directly from the IS such that the user is not required to enter such data. However, depending upon the capabilities of the IS, cash tip and/or gratuity data may still be entered manually via a process such as process 500 (FIGS. 5A and 5B). Process 1300 then proceeds to 1318.

At 1318, process 1300 obtains the sales data, media data, and sales adjustment data associated with the selected date range and the employee for which the TRAC statement will be generated. The sales and sales adjustment data (e.g., voids and comps) are discussed above in greater detail with respect to FIG. 7. This data is obtained from storage locations of an associated processing unit such as such as those described in greater detail with respect to FIG. 3 such as registers, database locations, and the like. The sales media, media data, and sales adjustment data has been previously entered and stored in such locations via execution of a process such as process 700 (FIG. 7) by the user. Process 1300 then proceeds to 1320.

At 1320, process 1300 queries the system defaults to determine whether the Gratuities Paid as Wages system default is set to “on”, and, therefore, gratuities are to be categorized separately. Such system defaults are entered via a system default function such as system default function 430k (FIG. 4). It may be useful to categorize gratuity sales and gratuities separate from non-cash and cash sales and tips because the IRS requires that an employer pay gratuities with the employee's hourly wage in the form of a paycheck or the like (rather than paying such gratuities in cash at the end of the employee's shift). This feature also allows gratuities that are tipped out to recipients to be paid to the recipient as part of the recipient's wages. If the Gratuities Paid as Wages system default is set to “on”, process 1300 proceeds to 1322, at which the gratuity sales and gratuities are subtracted from the non-cash/cash sales and tips, respectively. Process 1300 then proceeds to 1324. Or, if gratuities are not to be paid separately, process 1300 proceeds directly from 1320 to 1324.

At 1324, the non-cash tip percentage associated with the selected date range and the employee for which the TRAC statement will be generated is calculated. This percentage is determined by dividing the gross non-cash tips by the gross non-cash sales, wherein the gross non-cash sales have been adjusted to account for any sales adjustments. Similarly, at 1326, the cash tip percentage associated with the selected date range and the employee for which the TRAC statement will be generated is calculated. This percentage is determined by dividing the gross cash tips by the gross cash sales, wherein the gross non-cash sales have been adjusted to account for any sales adjustments. Also, in some embodiments of the present invention, the gross cash sales includes non-cash sales for which the tips were paid in cash. This inclusion ensures that the cash tip percentage is accurate. Otherwise, if such sales were included in the non-cash sales, the non-cash tip percentage would be lower than the actual percentage and the cash tip percentage would be higher than the actual percentage, which would result in erroneous reporting to the IRS. Process 1300 then proceeds to 1328.

At 1328, the difference between the cash and non-cash tip percentages is calculated. This is simply the non-cash percentage calculated at 1324 minus the cash tip percentage calculated at 1326. Process 1300 then proceeds to 1330.

At 1330, the total tip value is calculated for the selected employee during the selected time period. In embodiments of the TRAC statement in which the gratuities are paid separately from the tips such as TRAC statement 1400 (FIG. 14), the total tip value is simply the sum of the cash tips and the non-cash tips. However, if the gratuities are not paid separately, as determined by the user-defined system defaults, the gratuities are also added to the total tip value. Process 1300 then proceeds to 1332. At 1332, the total tip rate is calculated by dividing the gross sales (i.e., the total cash sales plus the total non-cash sales) by the total tip value calculated at 1330. Process 1300 then proceeds to 1334.

At 1334, all of the data required for gross sales field 1416, non-cash sales field 1418, cash sales field 1420, non-cash tips field 1422, non-cash tip percentage field 1424, cash tips field 1426, cash tip percentage field 1428, cash vs. non-cash tip percentage field 1430, total tips field 1432, total tip percentage field 1434, gross gratuity sales field 1436, and total gratuities 1438 is printed. Process 1300 then proceeds to 1336 of FIG. 13B.

Turning now to FIG. 13B, illustrated is an extension of the flow diagram of the exemplary embodiment of a process for creating an exemplary IRS TRAC statement depicted in FIG. 13A. FIG. 13B begins at 1336, at which process 1300 obtains the tipouts made to and from the selected employee during the selected date range. This tipout data includes tips and/or gratuities that were received by the selected employee from other employees, as well as the tipouts provided by the selected employee to other employees. This data is obtained from storage locations of an associated processing unit such as such as those described in greater detail with respect to FIG. 3 such as registers, database locations, and the like. The tipout data has been previously entered and stored in such locations via execution of a process such as process 500 (FIGS. 5A and 5B) by the user (e.g., at step 546). Peripheral information about such tipout data such as date, meal period, the employeeID of the person providing the tipout, the employeeID of the person receiving the tipout, the task associated with the tipout, and the amount of the tipout have also been previously entered in a process such as process 500 at steps such as steps 510a-514, 510b-518, 510c-522, 546, 546, and 546, respectively. Process 1300 then proceeds to 1338.

At 1338, the detail of the tipouts received from other employees is printed. In some embodiments of the present invention, the TRAC statement such as TRAC statement 1400 as depicted in FIGS. 14A and 14B includes the following fields: section title field 1440, column headers 1442a-1442g, row label fields 1444, row data fields 1446a-1446g, and tipout total fields 1448. Column headers 1442 include employee ID header 1442a, first name header 1442b, last name header 1442c, date header 1442d, meal period header 1442e, task header 1442f, and amount header 1442g. Row data fields 1446 include contributor employee ID data field 1446a, contributor first name data field 1446b, contributor last name data field 1446c, date of contribution data field 1446d, meal period data field 1446e, task data field 1446f, contribution amount data field 1446g, and total tipout field 1448. In some aspects of the present invention, section title field 1440, column headers 1442, and row label fields 1444 are populated with predetermined static information created to describe the corresponding data fields. However, the data for contributor employee ID data field 1446a, date of contribution data field 1446d, meal period data field 1446e, task data field 1446f, and contribution amount data field 1446g are retrieved during step 1336. The data for contributor first name data field 1446b and contributor last name data field 1446c is retrieved from a database of employee information or the like as created by the user via a function such as employees function 430d (FIG. 4). The data for total tipout field 1448 is equal to the sum of the data for all contribution amount data fields 1446g associated with a specific contributor.

In addition, if the system default Gratuity Paid as Wages is set to “on”, as determined by process 1300 at 1320, process 1300 will also print gratuities received from others independent from tipouts received from others rather than combining both received tipouts and received gratuities into a single “received tipout” classification. For example, as depicted in FIGS. 14A and 14B, if Gratuity Paid as Wages is set to “on”, process 1300 also prints gratuity header 1442h and received gratuity amount data fields 1449. The data for received gratuity amount data fields 1449 is retrieved during step 1336. However, if Gratuity Paid as Wages is set to “off”, such gratuity headers and data fields are omitted from the TRAC statement and tipouts and gratuities received from others are combined and reported as tipouts received from others. Process 1300 then proceeds to 1340.

At 1340, if the system default Gratuity Paid as Wages is set to “on”, the total tipouts and total gratuities received by the selected employee during the selected date range are calculated. These values are the sums of the data contained in total tipout fields 1448 and received gratuity amount data fields 1449, respectively. Or, alternatively, if the system default Gratuity Paid as Wages is set to “off”, gratuities received from others are included with the tipouts received from others and are reported as combined sums in total tipout fields 1448. Process 1300 then proceeds to 1342, at which the calculated total tipouts received and total gratuities received data is printed in total tipouts received field 1450 and total gratuities received field 1453, respectively, next to a predefined row label field 1451. Process 1300 then proceeds to 1344.

At 1344, the detail of the tipouts and gratuities paid to other employees is printed. In some embodiments of the present invention, the TRAC statement such as TRAC statement 1400 as depicted in FIGS. 14A and 14B includes the following fields: section title field 1452, column headers 1454a-1454g, row label fields 1456, row data fields 1458a-1458g, and tipout total fields 1460. Column headers 1454 include employee ID header 1454a, first name header 1454b, last name header 1454c, date header 1454d, meal period header 1454e, task header 1454f, amount header 1454g. Row data fields 1458 include contributor employee ID data field 1458a, contributor first name data field 1454b, contributor last name data field 1454c, date of contribution data field 1454d, meal period data field 1454e, task data field 1454f, contribution amount data field 1454g, and total tipout field 1460. In some embodiments of the present invention, section title field 1452, column headers 1454, and row label fields 1456 are populated with predetermined static information created to describe the corresponding data fields. However, the data for contributor employee ID data field 1458a, date of contribution data field 1458d, meal period data field 1458e, task data field 1458f, and contribution amount data field 1458 are retrieved during step 1336. The data for contributor first name data field 1458b and contributor last name data field 1458c is retrieved from a database of employee information or the like as created by the user via a function such as employees function 430d (FIG. 4). The data for total tipout field 1460 is equal to the sum of the data for all contribution amount data fields 1458g associated with a specific recipient.

In addition, if the system default Gratuity Paid as Wages is set to “on”, as determined by process 1300 at 1320, process 1300 will also print gratuities paid to others independent from tipouts paid to others rather than combining both paid tipouts and paid gratuities into a single “paid tipout” classification. For example, as depicted in FIGS. 14A and 14B, if Gratuity Paid as Wages is set to “on”, process 1300 also prints gratuity header 1454h and received gratuity amount data fields 1458h. The data for paid gratuity amount data fields 1458h is retrieved during step 1336. However, if Gratuity Paid as Wages is set to “off”, such gratuity headers and data fields are omitted from the TRAC statement and tipouts and gratuities paid to others are combined and reported as tipouts paid to others. Process 1300 then proceeds to 1346.

At 1346, the total tipouts and total gratuities paid by the selected employee during the selected date range are calculated. These values are the sums of the data contained in total tipout fields 1460 and received gratuity amount data fields 1458h, respectively. Or, alternatively, if the system default Gratuity Paid as Wages is set to “off”, gratuities paid to others are included with the tipouts paid to others and are reported as combined sums in total tipout fields 1460. Process 1300 then proceeds to 1348, at which the calculated total tipouts paid and total gratuities paid data is printed in total tipouts paid field 1462 and total gratuities paid field 1470, respectively, next to a predefined row label field 1463. Process 1300 then proceeds to 1350.

At 1350, the net change in tips is calculated. This value is the sum of the total tipouts received from other employees, as calculated at 1340, and the total tipouts paid to other employees, as calculated at 1346. Also, if the system default Gratuities Paid as Wages is set to “on”, the net change in gratuities is calculated at 1350. This value is the sum of the total gratuities received from other employees, as calculated at 1340, and the total tipouts paid to other employees, as calculated at 1346. Process 1300 then proceeds to 1352, at which the net reportable tips and/or net reportable gratuities are calculated. The former value is the total tip value calculated at 1330 less the net change in tips calculated at 1350. The latter value is the total gratuities as determined at 1322 less the net change in gratuities calculated at 1350. Process 1300 then proceeds to 1354.

At 1354, the TRDA and TRAC default settings are queried to determine their status. If both statuses are set to “off”, process 1300 proceeds to 1358. Or, if one of the statuses is set to “on”, process 1300 proceeds to 1356, at which the adjusted tip declaration value is retrieved (i.e., the total tips declared including any automatic increases to the actual tips declared by the service provider). Such value is calculated, for example, at 2551 of process 2500 as discussed in greater detail below with respect to FIGS. 25A and 25B. Process 2500 then proceeds to 1358.

At 1358, the AutoCorrect default setting is queried to determine its status. If this status is “on”, process 1300 proceeds to 1360, at which the tip declaration/shortfall header such as tip declaration/shortfall header 1473 is set to declaration. This notifies the reader of the TRAC statement that the declared tips have automatically been increased as necessary to meet predefined minimum levels (e.g., minimum IRS rate, minimum IRS percentage, TRAC minimum rate as set by user, etc.). Conversely, if the AutoCorrect status is set to “off”, process 1300 proceeds to 1362, at which the tip declaration/shortfall header such as tip declaration/shortfall header 1473 is set to shortfall. This notifies the reader of the TRAC statement that there is a shortfall between the value of the declared tips versus predefined minimum levels (e.g., minimum IRS rate, minimum IRS percentage, TRAC minimum rate as set by user, etc.), which have not been automatically increased by the system. In some embodiments of the present invention, each employee has a dedicated AutoCorrect status since such automatic correction requires written approval from the respective employee. The dedicated AutoCorrect status therefore allows the exemplary GrataSoft system to automatically correct declarations for those employees who have provided written approval without automatically correcting declarations for those employees who have not provided such approval. Process 1300 then proceeds to 1364.

At 1364, if Gratuity Paid as Wages is set to “on”, the net change in tips, the net change in gratuities, the net reportable tips, and the net reportable gratuities are printed in net change in tips data field 1464, net change in gratuities data field 1472, net reportable tips data field 1466, and net reportable gratuities data field 1468, respectively. Such data fields are adjacent row label fields 1465, 1471, 1467, and 1469, respectively, which label the data presented in the adjacent data fields 1464, 1472, 1466, and 1468, respectively. If, at 1364, Gratuity Paid as Wages is set to “off”, the net change in tips and the net reportable tips are printed in net change in tips data field 1464 and net reportable tips data field 1466, respectively, and gratuities are simply combined with and reported as tips. Additionally, the value of any tip declaration shortfall is printed in shorfall data field 1474 adjacent tip declaration/shortfall header 1473 as printed at step 1362. Process 1300 then proceeds to 1366.

At 1366, a statement and footer are printed in statement and footer fields 1476 and 1478, respectively, as depicted in FIG. 14B. The business establishment preparing the TRAC statement may require the selected employee for whom the statement has been printed to sign the statement in acknowledgement and agreement to the information contained therein to avoid any future disputes regarding such information. Thereafter, a copy of the TRAC statement may be provided to the employee to conform with the TRAC commitment's periodic written statement requirements as discussed in greater detail above. Furthermore, the TRAC statement may be saved by the business establishment to comply with the TRAC commitment's recordkeeping procedures. After 1366, process 1300 proceeds to 1368. At 1368, process 1300 terminates and control is returned to 630 of process 600, at which the user may opt to generate another report.

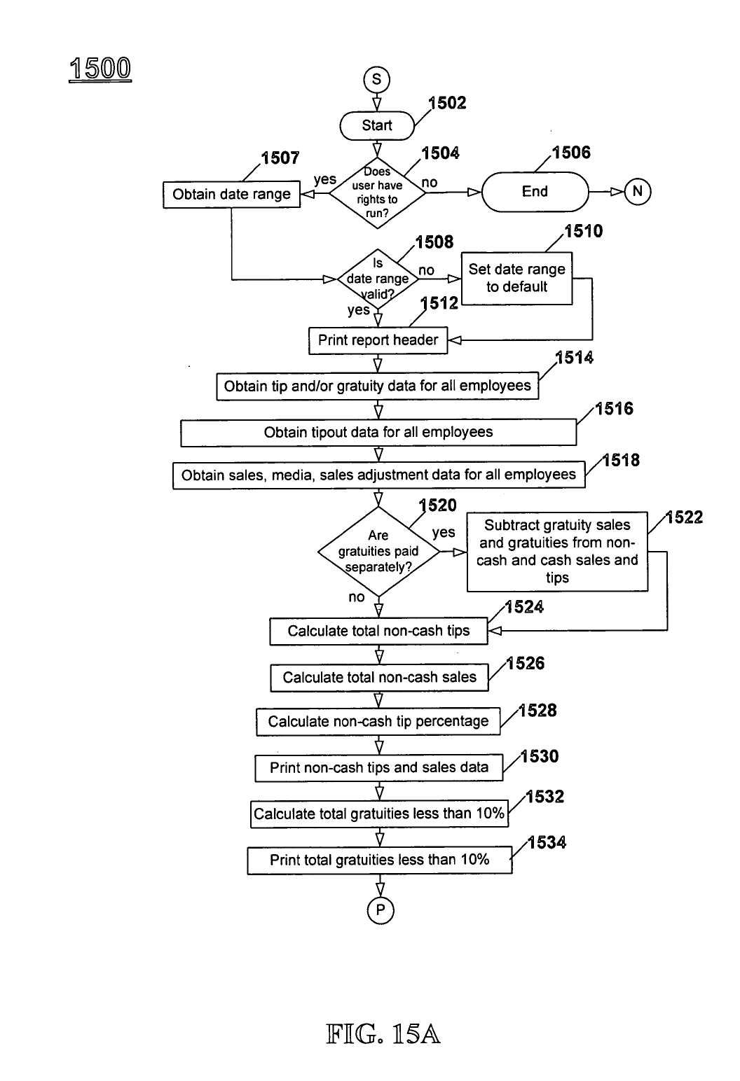

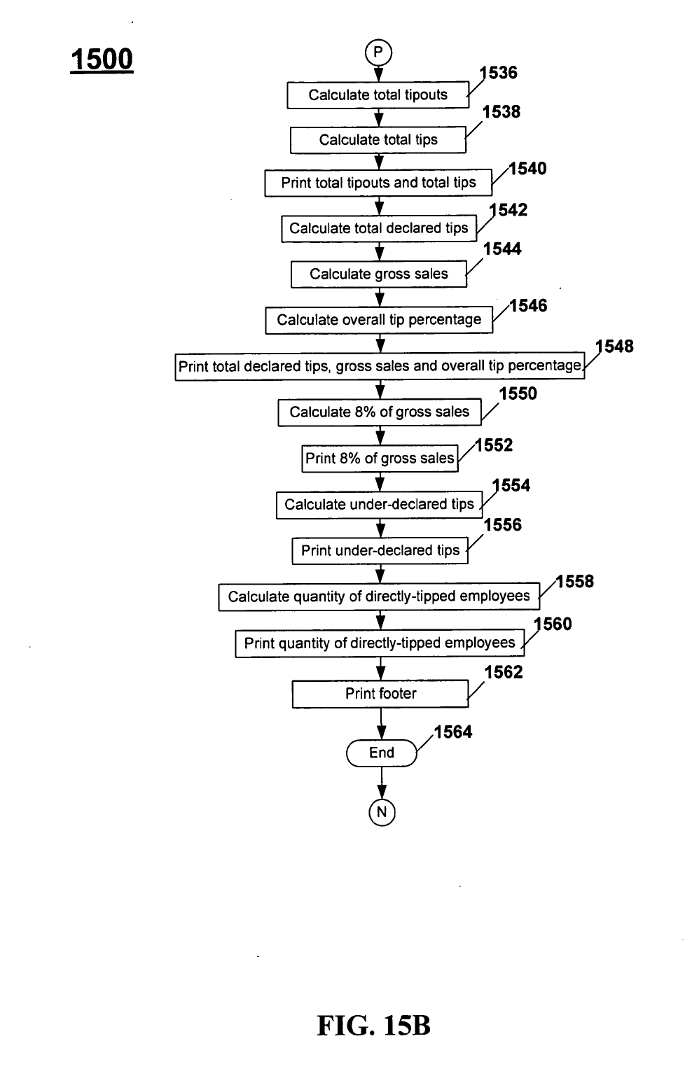

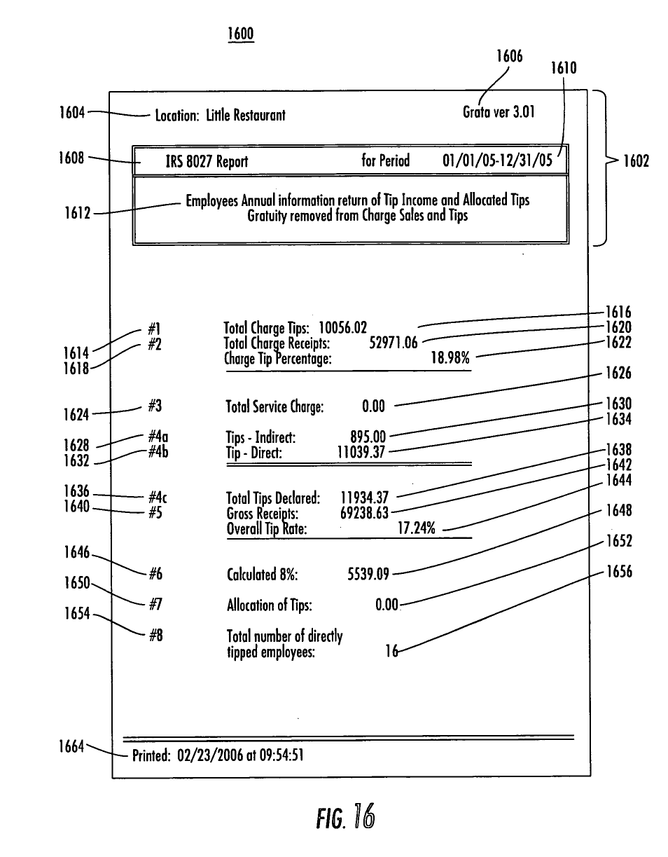

Turning now to FIG. 15A, illustrated is a flow diagram of an exemplary embodiment of a process for creating an IRS 8027 report. An example of such a report is provided in FIG. 16. In this exemplary GrataSoft embodiment of the present invention, the generated form simply generates the information required to fill out IRS form 8027. However, other embodiments of the present invention are envisioned in which the required information is printed directly onto an official IRS form 8027 without departing from the scope of the present invention. Large food and/or beverage establishments, as defined above, are required to file IRS form 8027 annually regardless of whether or not they are participating in the TRAC commitment. ATIP program participants are also required to submit Form 8027 on an annual basis.

Process 1500 begins at 1502, typically after being launched from a master process such as process 600 as described above with respect to FIG. 6. For example, process 1500 may be launched by selecting IRS 8027 report function 628c of process 600. When process 600 reaches 628, process 1500 is initiated and process 1500 proceeds to 1504.

At 1504, process 1500 queries the user rights. Such process is similar to that described above for 428 of process 400. If the user does not have the required rights, process 1500 proceeds to 1506, at which process 1500 terminates. In this embodiment of the present invention, process 1500 returns to 630 of process 600, at which the user is given the option to generate another report.

However, if at 1504, the user has the rights to generate an IRS 8027 report, process 1500 proceeds to 1507. At 1507, process 1500 obtains the date range for the report that is to be generated. In the exemplary GrataSoft embodiment of the present invention, the user has entered this date range at steps 604 through 610 of function 600 (FIG. 6). Once the date range is obtained, process 1500 proceeds to 1508.

At 1508, the date range is checked for validity. Since IRS form 8027 is an annual report, an acceptable date range will typically start on the first day of a calendar or tax year and will typically end on the last day of a calendar or tax year. Or, a partial year may be valid if it is the first or last year for which the business establishment is participating in the TRAC commitment, or if a user must align declared tips with payroll reporting that did not fall within the same calendar year. If the date range obtained at 1507 is valid, process 1500 proceeds to 1512. Otherwise, process 1500 proceeds to 1510.

At 1510, the date range is set to the default date range. In some embodiments of the present invention, the default date range is January 1st to December 31st of the previous year. If another date range is desired, the user may return to a process for generating a report such as process 600 (FIG. 6) and enter the desired date range at steps such as steps 604 through 610. Alternatively, process 1500 may exclude the validate date range step. In such embodiments, the user may generate IRS 8027 reports such as IRS 8027 report 1600 (FIG. 16) throughout the year to evaluate the employees' declared tip information. Process 1510 then proceeds to 1512.

At 1512, a header such as header 1602 (FIG. 16) is printed. In this exemplary embodiment of the present invention, set print on may be selected at 624 of process 600 (FIG. 6). In embodiments in which set print on is not selected, the report would be generated as described with respect to process 1500, but would only be displayed to the user via a monitor such as such as those described in greater detail with respect to FIG. 3. That is, the IRS 8027 report will only be printed if the set print on feature is selected at 624 of process 600 (FIG. 6). In the IRS 8027 report embodiment depicted in FIG. 16, header 1602 includes location field 1604, GrataSoft software version field 1606, form type field 1608, date range field 1610, and title field 1612. However, other fields and/or information may be substituted for header 1602 without departing from the scope of the present invention. The data for these fields are obtained from storage locations of an associated processing unit such as processing unit 302 such as registers, database locations, and the like. Also, although process 1500 prints data as it is obtained from storage, alternate embodiments are envisioned in which all information is obtained prior to printing any portion of the report without departing from the scope of the present invention.

After the header has been printed, process 1500 proceeds to 1514 at which it obtains the tip and/or gratuity data associated with the selected date range for all employees. This data is obtained from storage locations of an associated processing unit such as processing unit 302 such as registers, database locations, and the like. In embodiments in which the GrataSoft system is not interfaced to an IS, the tip and/or gratuity data has been previously entered and stored in such locations via execution of a process such as process 500 (FIGS. 5A and 5B) by the user. However, in embodiments of the present invention that are associated with an IS, the non-cash tip and/or gratuity data may be obtained directly from the IS such that the user is not required to enter such data. However, depending upon the capabilities of the IS, cash tip and/or gratuity data may still be entered manually via a process such as process 500 (FIGS. 5A and 5B). Process 1500 then proceeds to 1516.

At 1516, process 1500 obtains the tipouts made by all employees during the selected date range. This tipout data includes tips and/or gratuities that were received by all employees from other employees. This data is obtained from storage locations of an associated processing unit such as such as those described in greater detail with respect to FIG. 3 such as registers, database locations, and the like. The tipout data has been previously entered and stored in such locations via execution of a process such as process 500 (FIGS. 5A and 5B) by the user (e.g., at step 546). Peripheral information about such tipout data such as date, meal period, the employeeID of the person providing the tipout, the employeeID of the person receiving the tipout, the task associated with the tipout, and the amount of the tipout have also been previously entered in a process such as process 500 at steps such as steps 510a-514, 510b-518, 510c-522, 546, 546, and 546, respectively. Process 1500 then proceeds to 1518.

At 1518, process 1500 obtains the sales data, media data, and sales adjustment data associated with the selected date range for all employees. The sales and sales adjustment data (e.g., voids and comps) are discussed above in greater detail with respect to FIG. 7. This data is obtained from storage locations of an associated processing unit such as such as those described in greater detail with respect to FIG. 3 such as registers, database locations, and the like. The sales media, media data, and sales adjustment data has been previously entered and stored in such locations via execution of a process such as process 700 (FIG. 7) by the user. Process 1500 then proceeds to 1520.

At 1520, process 1500 queries the system defaults to determine whether gratuities are to be categorized separately. Such system defaults are entered via a system default function such as system default function 430k (FIG. 4). It may be useful to categorize gratuity sales and gratuities separate from non-cash and cash sales and tips because the IRS requires that an employer pay gratuities with the employee's hourly wage in the form of a paycheck or the like (rather than paying such gratuities in cash at the end of the employee's shift). If gratuities are to be categorized separately, process 1500 proceeds to 1522, at which the gratuity sales and gratuities are subtracted from the non-cash/cash sales and tips, respectively, as discussed in greater detail above with respect to FIG. 13. Process 1500 then proceeds to 1524. Or, if gratuities are not to be paid separately, process 1500 proceeds directly from 1520 to 1524.

At 1524, the non-cash tips for all employees having non-cash tips during the selected date range are summed to calculate total non-cash tips. Next, at 1526, the non-cash sales for all employees having non-cash sales during the selected date range are summed to calculate total non-cash sales (or receipts). This value of total non-cash sales includes the value of total non-cash tips. The summed value is then adjusted by the value of all sales adjustments. Process 1500 then proceeds to 1528, at which the total non-cash tip percentage is calculated. This value is obtained by dividing the non-cash tips by the non-cash sales. Process 1500 then proceeds to 1530.

At 1530, the non-cash tips, sales, and percentage data is printed. This data is printed in non-cash tips field 1616, non-cash sales field 1620, and non-cash percentage field 1622, respectively. Non-cash tips field 1616 and non-cash sales field 1620 are coupled with first line identifier 1614 and second line identifier 1618, respectively. First line identifier 1614 and second line identifier 1618 correspond to line 1 and 2, respectively, of IRS form 8027. Such identifiers allow the user to easily transfer information from an IRS 8027 report such as IRS 8027 report 1600 to IRS form 8027. Process 1500 then proceeds to 1532.

At 1532, the gratuities assessed at a percentage that is less than ten percent for all employees receiving such gratuities during the selected date range are summed to calculate total gratuities less than ten percent. In many instances, this value will be zero since a majority of business establishments assess gratuities at rates exceeding ten percent. Process 1500 then proceeds to 1534, at which total gratuities less than 10% are printed. This data is printed in non-cash tips field 1616, non-cash sales field 1620, and non-cash percentage field 1622, respectively. Non-cash tips field 1616 and non-cash sales field 1620 are coupled with first line identifier 1614 and second line identifier 1618, respectively. First line identifier 1614 and second line identifier 1618 correspond to line 1 and 2, respectively, of IRS form 8027. Such identifiers allow the user to easily transfer information from an IRS 8027 report such as IRS 8027 report 1600 to IRS form 8027. Process 1500 then proceeds to 1534.

At 1534, the value of all gratuities charged at a rate less than ten percent are printed. In the exemplary report depicted in FIG. 16, this value is printed in total service charge field 1626, which is coupled with third line identifier 1624. This identifier associates total service charge field 1626 with the data required by line 3 of IRS form 8027. Such identifiers allow the user to easily transfer information from an IRS 8027 report such as IRS 8027 report 1600 to IRS form 8027. Process 1500 then proceeds to 1536.

Referring now to FIG. 15B, illustrated is an extension of the flow diagram of the exemplary embodiment of a process for creating an IRS 8027 report depicted in FIG. 15A. FIG. 15B begins at 1536, at which all tipouts received by all employees during the selected date range are summed to calculate the total value of all tipouts. Process 1500 then proceeds to 1538.

At 1538, all cash and non-cash tips received by all employees during the selected date range are summed to calculate the total value of all cash and non-cash tips. Process 1500 then proceeds to 1540, at which the total tipouts and total tips are printed in total tipout field 1630 and total tips field 1634, respectively. Tipout field 1630 and total tips field 1634 are coupled with fourth line identifier 1628 and fifth line identifier 1632 to associate the data contained in such fields with the data required by lines 4a and 4b of IRS form 8027. It should be noted that business establishments participating in a program such as ATIP in which tips are attributed rather than declared may not have the information available to them to enter any data in total tipouts field 1630, as employees participating in the ATIP program are not required to declare actual tips or tipouts. Similarly, for ATIP participants, the data entered in total tips field 1634 and total declared tip field 1638 may be the total attributed tip data plus the value of all tips declared by employees that are not participating in the ATIP program plus the value of any tips declared by participating ATIP employees in excess of such employees' attributed tips. Process 1500 then proceeds to 1542.

At 1542, total tipouts, as calculated at 1536, is summed with total tips, as calculated at 1538, to calculate the total declared tips. Process 1500 then proceeds to 1544, at which total non-cash sales are summed with total cash sales to calculate gross sales. Thereafter, at 1546, the overall tip percentage is calculated by dividing the total declared tips by the gross sales.

The total declared tips, gross sales, and overall tip percentage are then printed at 1548 in total declared tip field 1638, gross sales field 1642, and overall tip percentage field 1644, respectively. Total declared tip field 1638 and gross sales field 1642 are coupled with sixth line identifier 1636 and seventh line identifier 1640 to associate the data contained in such fields with the data required by lines 4c and 5 of IRS form 8027. Process 1500 then proceeds to 1550.

At 1550, the gross sales, as calculated at 1544, is multiplied by eight percent or as otherwise specified by the taxing authority to which the return will be submitted. Process 1500 then proceeds to 1552, at which this value is printed in eight percent field 1648. This field is coupled with eighth line identifier 1646 to associate the data contained in this field with the data required by line 6 of IRS form 8027. Process 1500 then proceeds to 1554.

At 1554, the total declared tips, as calculated at 1542, is subtracted from the value representing eight percent of gross sales, as calculated at 1550, to determine the value of all under-declared tips, if any. If a negative value is produced, the value of under-declared tips will be set to zero. If a positive value is produced, the IRS will automatically require allocation of tips such that the total declared tips equals eight percent of gross sales. Process 1500 then proceeds to 1556, at which this value is printed in under-declared tips field 1652. This field is coupled with ninth line identifier 1650 to associate the data contained in this field with the data required by line 7 of IRS form 8027. Process 1500 then proceeds to 1558. When implementing the systems and methods of the present invention, line 7 will typically equal zero as any employees reporting less than eight percent of his or her gross sales as declared tips may be flagged to increase such declared tips to exceed the minimum percentage required by IRS form 8027, as well as to meet any IRS minimum percentages or rates imposed by a TRDA agreement. That is, tip declaration problems may be identified and corrected using the systems and methods of the present invention prior to an annual submission of IRS form 8027. Or, alternatively, if system defaults such as Allocation Enabled and/or Autocorrect are set to “on”, tip declaration problems will be automatically corrected upon entry of such declared tips into the systems and methods of the present invention.

At 1558, all employees receiving non-cash and/or cash tips are summed to calculate the total quantity of directly-tipped employees. That is, based upon today's IRS guidelines, employees who receive gratuities only are not included in this summation. However, the systems and methods of the present invention may be customized as necessary to meet the requirements of changing IRS, or other taxing authority, guidelines. Process 1500 then proceeds to 1560, at which this value is printed in directly-tipped employee field 1656. This field is coupled with tenth line identifier 1654 to associate the data contained in this field with the data required by line 8 of IRS form 8027. Process 1500 then proceeds to 1562.

At 1562, footer 1664 is printed. In the exemplary embodiment of IRS 8027 report 1600, footer 1664 includes the date and time that the report is printed. However, other information may be substituted without departing from the scope of the present invention. Process 1500 then terminates at 1564 and returns control to 630 of process 600 (FIG. 6), at which the user may opt to generate another report.

Referring now to FIG. 17, illustrated is a flow diagram of an exemplary embodiment of a process for creating a tip declaration problem report for business establishments participating in the TRAC commitment. An exemplary tip declaration problem report 1800 is provided in FIG. 18. Tip declaration problem report 1800 facilitates an employer's notification of an employee when the employee has not declared enough cash tips. For employees working for employers participating in the TRAC commitment, employees should declare a sufficient quantity of cash tips to minimize the difference between the non-cash tip and/or gratuity percentage and the cash tip and/or gratuity percentage to avoid an IRS audit. In some embodiments of the present invention, such as that depicted in FIG. 18, upon receipt of tip declaration problem report 1800, the employee may review the report to analyze the difference between the non-cash tip and/or gratuity percentage and the cash tip and/or gratuity percentage. If the difference is too great (i.e., the employee feels that he or she is increasing his or her chances for an IRS audit), the employee may declare additional tips by writing such tips into tip declaration fields and submitting same to the employer for modification of the employee's declared tips.

Slightly modified tip declaration problem reports similar to tip declaration problem report 1800 also help the business establishment to comply with the IRS' TRDA agreement. This agreement requires business establishments party thereto to notify the IRS if an employee's declared tips and/or gratuities is below the minimum IRS percentage or rate defined in the TRDA agreement. However, in lieu of detailing the non-cash and cash tip percentages, such modified reports will detail either the overall tip percentage versus the minimum IRS percentage or the employee's effective hourly rate versus the minimum IRS rate. Additionally, such reports may specifically detail the amount of the shortfall (i.e., the difference between the minimum tip declaration expected by the IRS and the actual tips declared by the employee. This will allow the employee to request an increase in tip declarations equal to the amount of the shortfall. Such information will allow the employee to monitor his or her compliance with the TRDA agreement in an effort to avoid an IRS audit.

In another slightly modified tip declaration problem report, information is included if any employee's effective hourly rate is less than state or federal minimum wage requirements, which would result in a violation of state and federal minimum wage laws. Notification of the employer of such shortcomings allow the employer to take corrective action such that it remains in compliance with state and federal laws.

Process 1700 begins at 1702, typically after being launched from a master process such as process 600 as described above with respect to FIG. 6. For example, process 1700 may be launched by selecting tip declaration problem report function 628d of process 600. When process 600 reaches 628, process 1700 is initiated and it proceeds to 1704.

At 1704, process 1700 queries the user rights. Such process is similar to that described above for 428 of process 400. If the user does not have the required rights, process 1700 proceeds to 1706, at which process 1700 terminates. In this embodiment of the present invention, process 1700 returns to 630 of process 600, at which the user is given the option to generate another report.

However, if at 1704, the user has the rights to generate a tip declaration problem report, process 1700 proceeds to 1708. At 1708, process 1700 obtains the date range for the report that is to be generated. In the exemplary GrataSoft embodiment of the present invention, the user has entered this date range at steps 604 through 610 of function 600 (FIG. 6). Once the date range is obtained, process 1700 proceeds to 1710.

At 1710, process 1700 obtains a discrete list of all employees having transactions occurring during the selected date range. Additionally, the integer variables a and b are set equal to the lowest and highest employeeID, respectively, from the set of employee IDs that correspond to the discrete list of employees. In this embodiment of process 1700, “all employees” were selected at 614 of process 600. However, if the user selected a single employee at 614, a would be set to equal the value of the employee's ID and b would be set to equal the value of the employee's ID incremented by 1 such that, as process 1700 proceeds, only one iteration of employeeIDs would result.

Process 1700 then proceeds to 1712, at which header 1802 is printed. In this embodiment of the present invention, set print on is selected at 624 of process 600. In embodiments in which set print on is not selected, the report would be generated as described with respect to process 1700, but would only be displayed to the user via a monitor such as those described in greater detail with respect to FIG. 3. That is, the tip declaration problem report will only be printed if the set print on feature is selected at 624 of process 600 (FIG. 6). In this embodiment, header 1802, as depicted in FIG. 18, includes title field 1804, date range field 1806, location field 1808, GrataSoft software version field 1810, message field 1812, and column headers 1814. However, other fields and/or information may be substituted for header 1802 without departing from the scope of the present invention. The data for these fields are obtained from storage locations of an associated processing unit such as processing unit 302 such as registers, database locations, and the like. Also, although process 1700 prints data as it is obtained from storage, alternate embodiments are envisioned in which all information is obtained prior to printing any portion of the report without departing from the scope of the present invention.

After header 1802 has been printed, process 1700 proceeds to 1714, at which the date variable is set to equal the first date in the selected date range. Process 1700 then proceeds to 1716. At 1716, the tip and/or gratuity data associated with the current date, as determined by the date variable, is obtained for the employee having employeeID[a]. This data is obtained from storage locations of an associated processing unit such as processing unit 302 such as registers, database locations, and the like. In embodiments in which the GrataSoft system is not interfaced to an IS, the tip and/or gratuity data has been previously entered and stored in such locations via execution of a process such as process 500 (FIGS. 5A and 5B) by the user. However, in embodiments of the present invention that are associated with an IS, the non-cash tip and/or gratuity data may be obtained directly from the IS such that the user is not required to enter such data. However, depending upon the capabilities of the IS, cash tip and/or gratuity data may still be entered manually via a process such as process 500 (FIGS. 5A and 5B). Process 1700 then proceeds to 1718.

At 1718, process 1700 obtains the sales data, media data, and sales adjustment data associated with the current date for all employees. The sales and sales adjustment data (e.g., voids and comps) are discussed above in greater detail with respect to FIG. 7. This data is obtained from storage locations of an associated processing unit such as those described in greater detail with respect to FIG. 3 such as registers, database locations, and the like. The sales media, media data, and sales adjustment data has been previously entered and stored in such locations via execution of a process such as process 700 (FIG. 7) by the user. Process 1700 then proceeds to 1720.

At 1720, the non-cash tip and/or gratuity percentage for the employee associated with employeeID[a] is calculated. This percentage is determined by dividing the gross non-cash tips by the gross non-cash sales, wherein the gross non-cash sales have been adjusted to account for any sales adjustments. Similarly, at 1722, the cash tip and/or gratuity percentage for the employee associated with employeeID[a] is calculated. This percentage is determined by dividing the gross cash tips by the gross cash sales, wherein the gross non-cash sales have been adjusted to account for any sales adjustments. Also, in some embodiments of the present invention, the gross cash sales includes non-cash sales for which a tip and/or gratuity was paid in cash. This inclusion ensures that the cash tip and/or gratuity percentage is accurate. Otherwise, if such sales were included in the non-cash sales, the non-cash tip and/or gratuity percentage would be lower than the actual percentage and the cash tip and/or gratuity percentage would be higher than the actual percentage. Process 1700 then proceeds to 1724.

At 1724, process 1700 compares the values calculated at 1720 and 1722 to determine whether the cash tip and/or gratuity percentage is less than the non-cash tip and/or gratuity percentage. If no, process 1700 proceeds directly to 1728. If yes, process 1700 proceeds to 1726. Alternatively, the cash tip and/or gratuity percentage may be compared to a predetermined minimum rate set by the employer as a system default or the like.

At 1726, the data for the current date is printed. This data includes date, employee ID, employee name, non-cash sales, non-cash tips and/or gratuities, non-cash tip and/or gratuity percentage, cash sales, cash tips and/or gratuities, and cash tips and/or gratuity percentage/fifteen percent values, which are printed in date field 1816a, employee ID field 1816b, employee name field 1816c, non-cash sales field 1816d, non-cash tips and/or gratuities field 1816e, non-cash tip and/or gratuity percentage field 1816f, cash sales field 1816g, cash tips and/or gratuity field 1816h, and cash tip and/or gratuity percentage/fifteen percent value field 1816i, respectively. The data printed to the cash tip and/or gratuity percentage/fifteen percent value field 1816i varies depending upon the cash tip and/or gratuity percentage. If the value of this percentage is greater than zero, then the actual value will be printed. However, if the value of this percentage is zero, a value equal to fifteen percent of the cash sales will be printed to guide the employee with his or her cash tip declaration.

Declare line 1818 is also printed at 1726. This line provides an area upon which the employee receiving the tip declaration problem report may declare additional cash tips such that the employer may adjust the employee's declared tips. Process 1700 then proceeds to 1728.

At 1728, the current date is incremented by one day and process 1700 proceeds to 1730. At 1730, process 1700 verifies whether the new date is within the date range obtained at 1708. If yes, process 1700 returns to 1716. If no, process 1700 proceeds to 1732.

At 1732, process 1700 determines whether any data has been printed. If data has been printed, process 1700 proceeds directly to 1736. If data has not been printed, process 1700 proceeds to 1734 prior to 1736. At 1734, a message is printed indicating that no tip declaration problems exist for this employee.

At 1736, the current page is ejected and a new header such as header 1802 is printed on a new page. Process 1700 then proceeds to 1738. At 1738, the value of the variable a is incremented by 1 and process 1700 proceed to 1740. At 1740, process 1700 determines whether the value of the variable a is greater than the value of the variable b. If no, process 1700 proceeds to 1742, at which process 1700 determines whether the employee having employeeID[a] is on the discrete list of employees. If it is not, process 1700 returns to 1738. If the employee having employeeID[a] is on the discrete list of employees, process 1700 proceeds to 1716.

However, if at 1740, the value of the variable a is greater than the value of the variable b, process 1700 proceeds to 1744 at which process 1700 is terminated. Since process 1700 was launched by process 600, process 1700 returns control to 630 of process 600 (FIG. 6), at which the user is given the option to generate another report.

Generation of reports such as tip declaration report 1800 allows the employee to correct any tip declaration mistakes that may occur due to incorrect data entry into the GrataSoft system, an employee forgetting to clock out of the POS system, an employee incorrectly declaring tips to the business establishment, etc. Such corrections may be made prior to submission of incorrect information to the taxing authority, which may result in an employee audit.

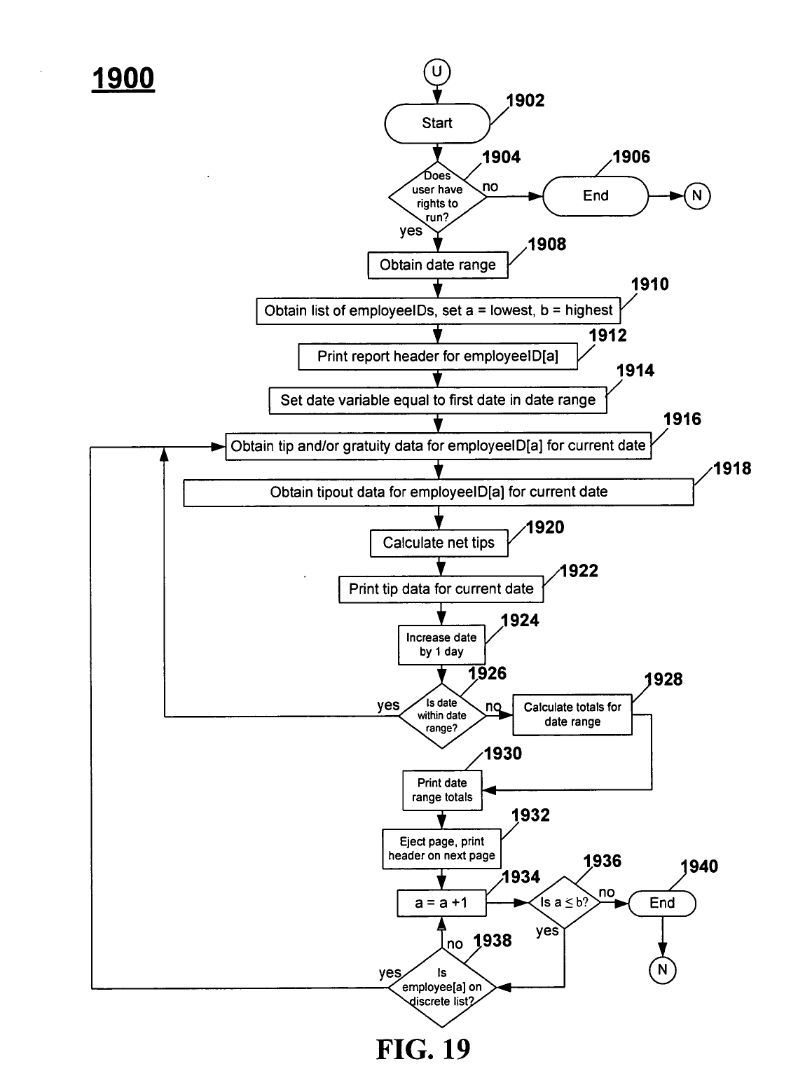

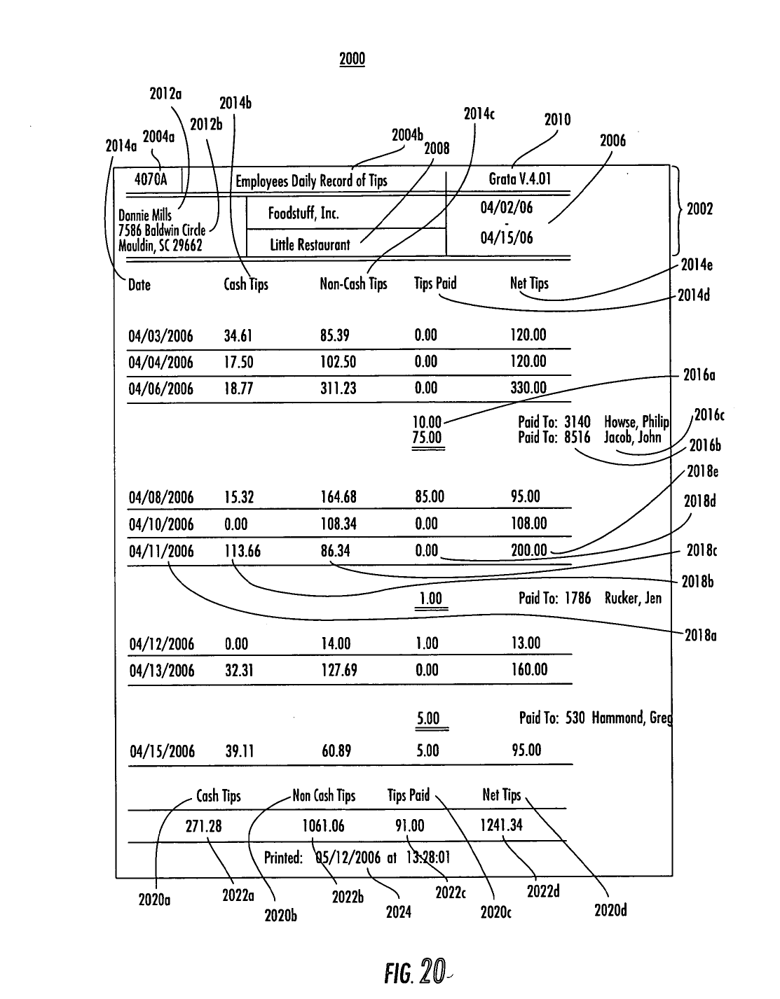

Referring next to FIG. 19, illustrated is a flow diagram of an exemplary embodiment of a process for generating IRS form 4070A. An exemplary IRS form 4070A is provided in FIG. 20. Employees are required to create and retain IRS forms 4070A such that they may be presented to the IRS if the employee is audited. Automatic creation of such forms by the business establishment for its employees increases employee satisfaction, while ensuring that the business establishment's records and the employees' records are in agreement. Also, creation of such forms by the business establishment saves each employee an estimated 66 hours per year (i.e., the time estimated by the IRS for preparation of form 4070A). Furthermore, the business establishment's retention of such forms aids in its compliance with the recordkeeping requirements of the TRAC and EMTRAC commitments and/or TRDA agreement.

Process 1900 begins at 1902, typically after being launched from a master process such as process 600 as described above with respect to FIG. 6. For example, process 1900 may be launched by selecting IRS form 4070A function 628e of process 600. When process 600 reaches 628, process 1900 is initiated and process 1900 proceeds to 1904.

At 1904, process 1900 queries the user rights. Such process is similar to that described above for 428 of process 400. If the user does not have the required rights, process 1900 proceeds to 1906, at which process 1900 terminates. In this embodiment of the present invention, process 1900 returns to 630 of process 600 (FIG. 6), at which the user is given the option to generate another report.

However, if at 1904, the user has the rights to generate a 4070A report, process 1900 proceeds to 1908. At 1908, process 1900 obtains the date range for the report that is to be generated. In the exemplary GrataSoft embodiment of the present invention, the user has entered this date range at steps 604 through 610 of function 600 (FIG. 6). Once the date range is obtained, process 1900 proceeds to 1910.

At 1910, process 1900 obtains a discrete list of all employees having transactions occurring during the selected date range. Additionally, the integer variables a and b are set equal to the lowest and highest employeeID, respectively, from the set of employee IDs that correspond to the discrete list of employees. In this embodiment of process 1900, “all employees” were selected at 614 of process 600 (FIG. 6). However, if the user selected a single employee at 614, the value of the variable a would be set to equal the value of the employee's ID and the value of the variable b would be set to equal the value of the employee's ID incremented by 1 such that, as process 1900 proceeds, only one iteration of employeeIDs would result.

Process 1900 then proceeds to 1912, at which header 2002 is printed. In this embodiment of the present invention, set print on is selected at 624 of process 600. In embodiments in which set print on is not selected, the report would be generated as described with respect to process 1900, but would only be displayed to the user via a monitor such as those described in greater detail with respect to FIG. 3. That is, the 4070A report will only be printed if the set print on feature is selected at 624 of process 600 (FIG. 6). In this embodiment, header 2002, as depicted in FIG. 20, includes title field 2004, date range field 2006, location field 2008, GrataSoft software version field 2010, employee information fields 2012, and column headers 2014. Employee information fields 2012 include fields such as employee name field 2012a and employee address field 2012b. Column headers 2014 include fields such as date field 2014a, cash tips field 2014b, non-cash tips field 2014c, tipouts field 2014d, and net tips field 2014e. However, other fields and/or information may be substituted for header 2002 without departing from the scope of the present invention. The data for these fields are obtained from storage locations of an associated processing unit such as processing unit 302 such as registers, database locations, and the like. Also, although process 1900 prints data as it is obtained from storage, alternate embodiments are envisioned in which all information is obtained prior to printing any portion of the report without departing from the scope of the present invention.

After the header has been printed, process 1900 proceeds to 1914, at which the date variable is set to equal the first date in the selected date range. Process 1900 then proceeds to 1916. At 1916, the tip and/or gratuity data associated with the current date, as determined by the date variable, is obtained for the employee having employeeID[a]. This data is obtained from storage locations of an associated processing unit such as processing unit 302 such as registers, database locations, and the like. In embodiments in which the GrataSoft system is not interfaced to an IS, the tip and/or gratuity data has been previously entered and stored in such locations via execution of a process such as process 500 (FIGS. 5A and 5B) by the user. However, in embodiments of the present invention that are associated with an IS, the non-cash tip and/or gratuity data may be obtained directly from the IS such that the user is not required to enter such data. However, depending upon the capabilities of the IS, cash tip and/or gratuity data may still be entered manually via a process such as process 500 (FIGS. 5A and 5B). Process 1900 then proceeds to 1918.

At 1918, process 1900 obtains the tipouts made by the employee having employeeID[a] for the current date. This tipout data includes tips and/or gratuities that were paid by such employee to other employees. This data is obtained from storage locations of an associated processing unit such as such as those described in greater detail with respect to FIG. 3 such as registers, database locations, and the like. The tipout data has been previously entered and stored in such locations via execution of a process such as process 500 (FIGS. 5A and 5B) by the user (e.g., at step 546). Peripheral information about such tipout data such as date, meal period, the employeeID of the person providing the tipout, the employeeID of the person receiving the tipout, the task associated with the tipout, and the amount of the tipout have also been previously entered in a process such as process 500 at steps such as steps 510a-514, 510b-518, 510c-522, 546, 546, and 546, respectively. Process 1900 then proceeds to 1920.

At 1920, the net tips for the employee associated with employeeID[a] for the current date is calculated. This value is calculated by adding the cash tips and/or gratuities to the non-cash tips and/or gratuities and subtracting any tipouts from this sum. Process 1900 then proceeds to 1922, at which the tip data for the current employee and current date is printed. The tip data includes date, cash tips, non-cash tips, tipouts, net tips, and tipout details, which are printed in date fields 2018a, cash tip fields 2018b, non-cash tip fields 2018c, tipout fields 2018d, net tips fields 2018e, and tipout detail fields 2016. Tipout detail fields 2016 include individual tipout fields 2016a, individual tipout recipient employeeID fields 2016b, and individual tipout recipient name 2016c. Process 1900 then proceeds to 1924.

At 1924, the current date is incremented by one day and process 1900 proceeds to 1926. At 1926, process 1900 verifies whether the new date is within the date range obtained at 1908. If yes, process 1900 returns to 1916. If no, process 1900 proceeds to 1928. At 1928, process 1900 calculates total cash tips, total non-cash tips, total tipouts, and total net tips by summing each of the individual cash tips, non-cash tips, tipouts, and net tips, respectively. Process 1900 then proceeds to 1930, at which such totals are printed in total cash tips field 2022a, total non-cash tips field 2022b, total tipouts field 2022c, and total net tips field 2022d. Each of these fields is also coupled to total cash tips header 2020a, total non-cash tips header 2020b, total tipouts header 2020c, and total net tips header 2020d, respectively. Process 1900 then proceeds to 1932.

At 1932, the current page is ejected and a new header such as header 2002 is printed on a new page. Process 1900 then proceeds to 1934, at which the value of the variable a is incremented by 1 and process 1900 proceed to 1936. At 1936, process 1900 determines whether the value of the variable a is less than the value of the variable b. If yes, process 1900 proceeds to 1938, at which process 1900 determines whether the employee having employeeID[a] is on the discrete list of employees. If it is not, process 1900 returns to 1912. If the employee having employeeID[a] is on the discrete list of employees, process 1900 proceeds to 1916.

However, if at 1936, the value of the variable a is greater than the value of the variable b, process 1900 proceeds to 1940, at which process 1900 is terminated. Since process 1900 was launched by process 600, process 1900 returns control to 630 of process 600 (FIG. 6), at which the user is given the option to generate another report.

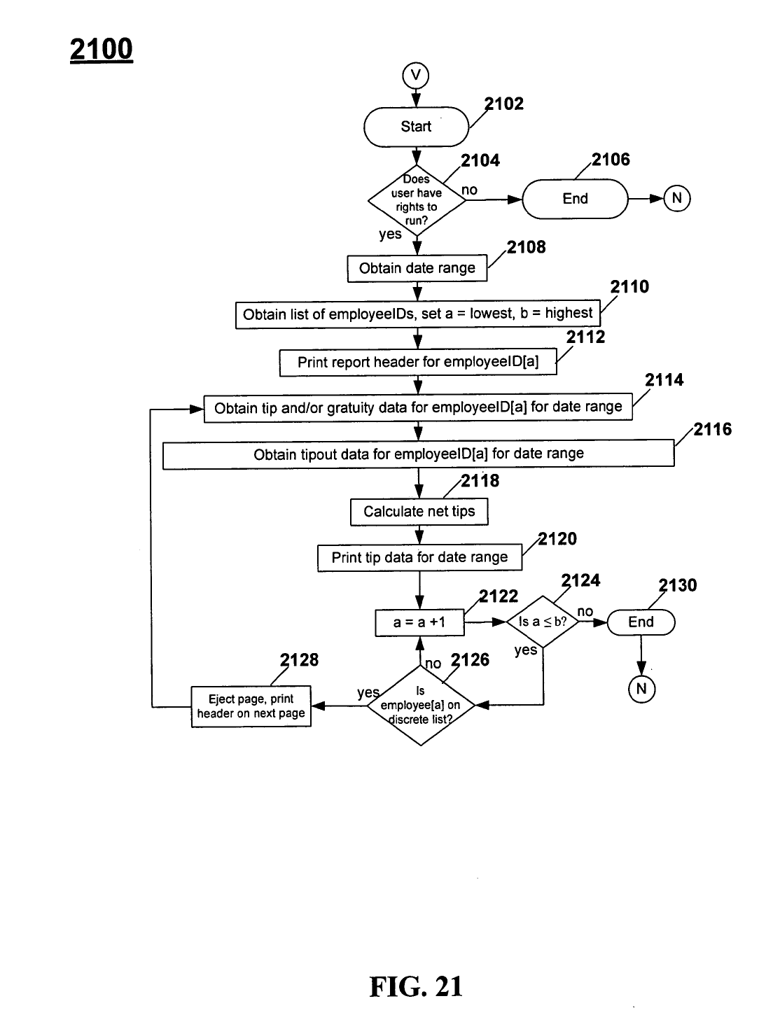

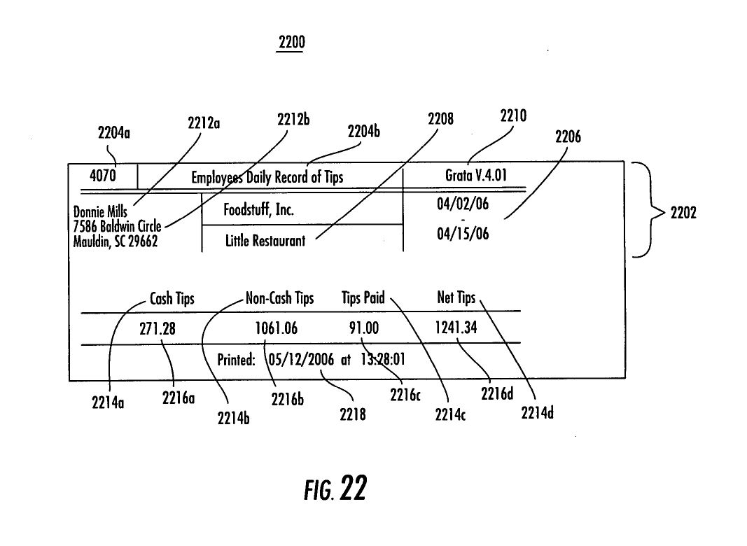

Turning now to FIG. 21, illustrated is a flow diagram of an exemplary embodiment of a process for generating IRS form 4070. An exemplary IRS form 4070 is provided in FIG. 22. Employees are required to create and retain IRS forms 4070 such that they may be presented to the IRS if the employee is audited. Automatic creation of such forms by the business establishment for its employees increases employee satisfaction, while ensuring that the business establishment's records and the employees' records are in agreement. Furthermore, the business establishment's retention of such forms aids in its compliance with the recordkeeping requirements of the TRAC and EMTRAC commitments and/or TRDA agreement.

Process 2100 begins at 2102, typically after being launched from a master process such as process 600 as described above with respect to FIG. 6. For example, process 2100 may be launched by selecting IRS form 4070 function 628f of process 600. When process 600 reaches 628f, process 2100 is initiated and process 2100 proceeds to 2104.

At 2104, process 2100 queries the user rights. Such process is similar to that described above for 428 of process 400. If the user does not have the required rights, process 2100 proceeds to 2106, at which process 2100 terminates. In this embodiment of the present invention, process 2100 returns to 630 of process 600 (FIG. 6), at which the user is given the option to generate another report.

However, if at 2104, the user has the rights to generate a 4070 report, process 2100 proceeds to 2108. At 2108, process 2100 obtains the date range for the report that is to be generated. In the exemplary GrataSoft embodiment of the present invention, the user has entered this date range at steps 604 through 610 of function 600 (FIG. 6). Once the date range is obtained, process 2100 proceeds to 2110.

At 2110, process 2100 obtains a discrete list of all employees having transactions occurring during the selected date range. Additionally, the integer variables a and b are set equal to the lowest and highest employeeID, respectively, from the set of employee IDs that correspond to the discrete list of employees. In this embodiment of process 2100, “all employees” were selected at 614 of process 600 (FIG. 6). However, if the user selected a single employee at 614, the value of the variable a would be set to equal the value of the employee's ID and the value of the variable b would be set to equal the value of the employee's ID incremented by 1 such that, as process 2100 proceeds, only one iteration of employeeIDs would result.

Process 2100 then proceeds to 2112, at which header 2202 is printed. In this embodiment of the present invention, set print on is selected at 624 of process 600. In embodiments in which set print on is not selected, the report would be generated as described with respect to process 2100, but would only be displayed to the user via a monitor such as those described in greater detail with respect to FIG. 3. That is, the 4070 report will only be printed if the set print on feature is selected at 624 of process 600 (FIG. 6). In this embodiment, header 2202, as depicted in FIG. 22, includes title field 2204, date range field 2206, location field 2208, GrataSoft software version field 2210, employee information fields 2212, and column headers 2214. Employee information fields 2212 include fields such as employee name field 2212a and employee address field 2212b. Column headers 2214 include fields such as cash tips header 2214a, non-cash tips header 2214b, tipouts header 2214c, and net tips header 2214d. However, other fields and/or information may be substituted for header 2202 without departing from the scope of the present invention. The data for these fields are obtained from storage locations of an associated processing unit such as processing unit 302 such as registers, database locations, and the like. Also, although process 2100 prints data as it is obtained from storage, alternate embodiments are envisioned in which all information is obtained prior to printing any portion of the report without departing from the scope of the present invention.

After the header has been printed, process 2100 proceeds to 2114, at which the tip and/or gratuity data associated with the current date range as obtained at 2108 for the employee having employeeID[a] is obtained. This data is obtained from storage locations of an associated processing unit such as processing unit 302 such as registers, database locations, and the like. In embodiments in which the GrataSoft system is not interfaced to an IS, the tip and/or gratuity data has been previously entered and stored in such locations via execution of a process such as process 500 (FIGS. 5A and 5B) by the user. However, in embodiments of the present invention that are associated with an IS, the non-cash tip and/or gratuity data may be obtained directly from the IS such that the user is not required to enter such data. However, depending upon the IS, cash tip and/or gratuity data may still be entered manually via a process such as process 500 (FIGS. 5A and 5B). Process 2100 then proceeds to 2116.

At 2116, process 2100 obtains the tipouts made by the employee having employeeID[a] for the selected date range. This tipout data includes tips and/or gratuities that were paid by such employee to other employees. This data is obtained from storage locations of an associated processing unit such as such as those described in greater detail with respect to FIG. 3 such as registers, database locations, and the like. The tipout data has been previously entered and stored in such locations via execution of a process such as process 500 (FIGS. 5A and 5B) by the user (e.g., at step 546). Peripheral information about such tipout data such as date, meal period, the employeeID of the person providing the tipout, the employeeID of the person receiving the tipout, the task associated with the tipout, and the amount of the tipout have also been previously entered in a process such as process 500 at steps such as steps 510a-514, 510b-518, 510c-522, 546, 546, and 546, respectively. Process 2100 then proceeds to 2118.

At 2118, the net tips for the employee associated with employeeID[a] for the selected date range is calculated. This value is calculated by adding the cash tips and/or gratuities to the non-cash tips and/or gratuities and subtracting any tipouts from this sum. Process 2100 then proceeds to 2120, at which the tip data for the current employee and the selected date range is printed. The tip data includes cash tips, non-cash tips, tipouts, and net tips, which are printed in cash tip field 2216a, non-cash tip field 2216b, tipout field 2216c, and net tips field 2216d. Process 2100 then proceeds to 2122.

At 2122, the value of the variable a is incremented by 1 and process 2100 proceed to 2124. At 2124, process 2100 determines whether the value of the variable a is less than the value of the variable b. If yes, process 2100 proceeds to 2126, at which process 2100 determines whether the employee having employeeID[a] is on the discrete list of employees. If it is not, process 2100 returns to 2122. If the employee having employeeID[a] is on the discrete list of employees, process 2100 proceeds to 2128. At 2128, the current page is ejected and a new header such as header 2202 is printed on a new page. Process 2100 then proceeds to 2114.

However, if at 2124, the value of the variable a is greater than the value of the variable b, process 2100 proceeds to 2130, at which process 2100 is terminated. Since process 2100 was launched by process 600, process 2100 returns control to 630 of process 600 (FIG. 6), at which the user is given the option to generate another report.

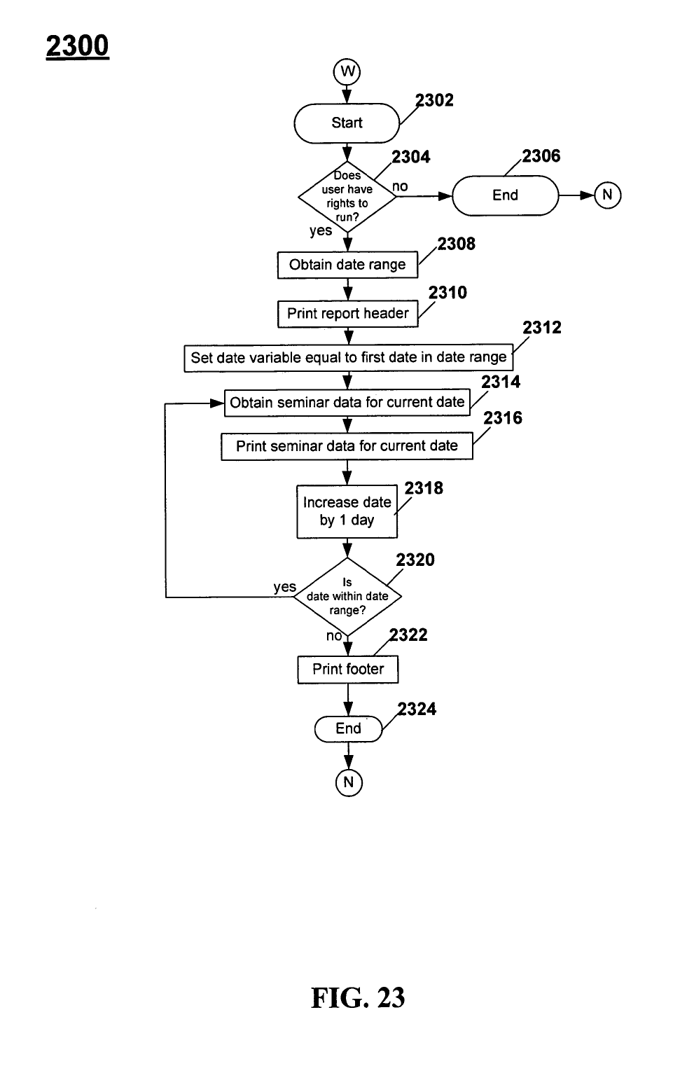

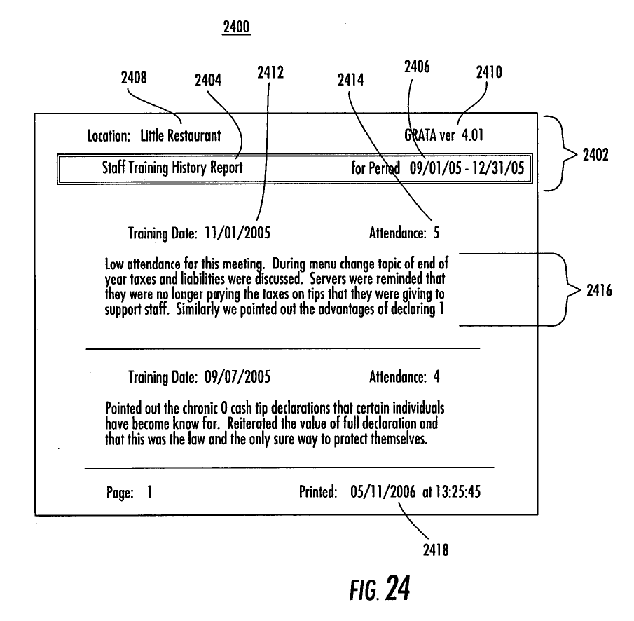

Referring now to FIG. 23, illustrated is a flow diagram of an exemplary embodiment of a process for generating a staff training history report. An exemplary staff training history report 2400 is provided in FIG. 24. Staff training history report 2400 provides employers with a method of documenting performance of training as required by the TRAC agreement. Also, it allows employers to easily determine whether they are current with the quarterly training requirements by periodically reviewing such reports.

Process 2300 begins at 2302, typically after being launched from a master process such as process 600 as described above with respect to FIG. 6. For example, process 2300 may be launched by selecting staff training history report function 628e of process 600. When process 600 reaches 628, process 2300 is initiated and it proceeds to 2304.

At 2304, process 2300 queries the user rights. Such process is similar to that described above for 428 of process 400. If the user does not have the required rights, process 2300 proceeds to 2306, at which process 2300 terminates. In this embodiment of the present invention, process 2300 returns to 630 of process 600 (FIG. 6), at which the user is given the option to generate another report.

However, if at 2304, the user has the rights to generate a staff training history report, process 2300 proceeds to 2308. At 2308, process 2300 obtains the date range for the report that is to be generated. In the exemplary GrataSoft embodiment of the present invention, the user has entered this date range at steps 604 through 610 of function 600 (FIG. 6). Once the date range is obtained, process 2300 proceeds to 2310.

At 2310, header 2402 is printed. In this embodiment of the present invention, set print on is selected at 624 of process 600. In embodiments in which set print on is not selected, the report would be generated as described with respect to process 2300, but would only be displayed to the user via a monitor such as those described in greater detail with respect to FIG. 3. That is, the staff training history report will only be printed if the set print on feature is selected at 624 of process 600 (FIG. 6). In this embodiment, header 2402, as depicted in FIG. 24, includes title field 2404, date range field 2406, location field 2408, and GrataSoft software version field 2410. However, other fields and/or information may be substituted for header 2402 without departing from the scope of the present invention. The data for these fields are obtained from storage locations of an associated processing unit such as processing unit 302 such as registers, database locations, and the like. Also, although process 2300 prints data as it is obtained from storage, alternate embodiments are envisioned in which all information is obtained prior to printing any portion of the report without departing from the scope of the present invention.

After the header has been printed, process 2300 proceeds to 2312, at which the date variable is set to equal the first date in the selected date range. Process 2300 then proceeds to 2314. At 2314, the seminar data associated with the current date, as determined by the date variable, is obtained. This data is obtained from storage locations of an associated processing unit such as processing unit 302 such as registers, database locations, and the like. In the exemplary GrataSoft embodiment, the seminar data has been previously entered and stored in such locations via execution of a process such as process 900 (FIG. 9) by the user. Process 2300 then proceeds to 2316.

At 2316, process 2300 prints the seminar data for the current date. The seminar data includes date, attendance, and notes, which are printed in date fields 2412, attendance fields 2414, and note fields 2416. However, other training and/or seminar fields may be substituted, added, or deleted without departing from the scope of the present invention. For example, the seminar information could additionally include a list of all employees who attended the seminar, a list of employees that are still required to attend the seminar, employee comments on the seminar, policy changes to be made based on the seminar information, or the like. Process 2300 then proceeds to 2318.

At 2318, the current date is incremented by one day and process 2300 proceeds to 2320. At 2320, process 2300 verifies whether the new date is within the date range obtained at 2308. If yes, process 2300 returns to 2314. If no, process 2300 proceeds to 2322, at which a footer such as footer 2418 is printed. Such footer may include information such as date and time the report is printed, however, other information may be substituted without departing from the scope of the present invention.

Process 2300 then proceeds to 2324, at which process 2300 is terminated. Since process 2300 was launched by process 600, process 1900 returns control to 630 of process 600 (FIG. 6), at which the user is given the option to generate another report.

Although a plurality of reports have been specifically detailed, it should be noted that any report based upon the data collected by the systems and methods of the present invention may be created. Such reports may be provided in any one of a variety of formats without departing from the scope hereof.

For example, the systems and methods of the present invention may be tailored to provide reports that facilitate filing of United States Army reports such as reports DA 5462-R and 5163-R. Use of the present invention by the Army may result in benefits including, but not limited to, increased efficiency due to the ability to import data from an electronic cash receipt system rather than entering it manually, carrying over data for any given period to later periods without the need to re-enter such data, allowing the Army to participate in a TRAC or EMTRAC commitment, TRDA agreement, or ATIP program at minimal cost and administration time, and facilitating inter-employee tip tracking.

Turning next to FIG. 25, illustrated is a flow diagram of an exemplary embodiment of a process for exporting payroll data from a system such as the exemplary GrataSoft system. In some embodiments of the present invention in which a time and attendance system (e.g., a Datamatics TC-1 time and attendance system) is utilized to pay employees, the GrataSoft system includes a function such as payroll export function 430l to transmit payroll data, as well as data regarding tips and/or gratuities to be paid as wages, to the time and attendance system. Such a function allows the systems and methods of the present invention to transmit tip and/or gratuities that are to be paid as wages, as discussed elsewhere herein, along with, or distinct from, transmission of each employee's hours worked. Such transmission allows the time and attendance software to seamlessly pay each employee for the hours worked as well as the tips and gratuities received that the employee and/or employer designate to be paid as wages. Furthermore, this function facilitates an employer's compliance with taxing authority regulations such as the IRS that require tips and/or gratuities to be paid as wages.

Process 2500 begins at 2502, typically after being launched from a master process such as process 400 as described above with respect to FIG. 4. For example, process 2500 may be launched by selecting export payroll function 430l (FIG. 4). Once process 2500 has been initiated, it proceeds to 2504.

At 2504, the interfaced POS system, if any, is queried to determine whether it is enabled. If yes, process 2500 proceeds to 2506, at which the data for the current period is compared to the POS data for the same period. For example, a current period may be the most recent payroll period and may include all data that has not yet been transmitted to a third-party payroll system including hours worked, tips and/or gratuities to be paid as wages, etc. Process 2500 then proceeds to 2508 at which a determination is made as to whether the data for the current period varies from the POS data. If yes, the exemplary GrataSoft system is updated with the latest data present in the POS data such that both systems include the same data. Such updating may be necessary, for example, whenever a business establishment is utilizing both a POS system as well as a system or method in accordance with the present invention since updating of the data allows business establishment personnel to make changes in one system only and then update the data between the two systems. Such capabilities avoid the need for business establishment personnel to manually update both systems and minimize the potential for mistakes that may be caused due to manual updating of the multiple systems. Process 2500 then proceeds to 2512. Or, if at 2508, the data for the current period does not vary from the POS data, no action is taken and process 2500 proceeds directly to 2512. In embodiments of the present invention in which a POS system or the like is not interfaced thereto, steps 2504 through 2510 may be omitted from the payroll export function 430l process.

At 2512, the data for the current period is scanned for duplicate entries and process 2500 proceeds to 2514, at which process 2500 determines whether a duplicate entry has been found. If yes, process 2500 proceeds to 2516, at which specific data regarding the duplicate entries is added to the payroll export report. Such entry allows the user to correct the duplicate data entry problem(s) prior to transmitting the payroll data to the time and attendance system. Process 2500 then proceeds to 2518. Or, alternatively, if at 2514 a duplicate entry has not been found, process 2500 proceeds directly to 2518.

At 2518, the data for the current period is scanned for data omissions and process 2500 proceeds to 2520, at which process 2500 determines whether a data omission has been found. If yes, process 2500 proceeds to 2522, at which specific data regarding the data omission(s) is added to the payroll export report. Such entry allows the user to correct the data omission prior to transmitting the payroll data to the time and attendance system. Data omissions may include a failure to declare cash tips and/or gratuities, failure to clock out (i.e., hours worked equals zero), etc. Process 2500 then proceeds to 2524. Or, alternatively, if at 2520 a data omission has not been found, process 2500 proceeds directly to 2524.

At 2524, the data for the current period is scanned for sales data that does not have any tipout declarations associated therewith. Process 2500 proceeds to 2526, at which process 2500 determines whether sales data without tipout data has been found. If yes, process 2500 proceeds to 2528, at which specific data regarding the sales data without tipout data is added to the payroll export report. Such entry allows the user to correct the potentially omitted tipout data prior to transmitting the payroll data to the time and attendance system. Tipout data may be omitted if a business establishment employee failed to enter such data into the system, a server failed to report such tipout data to the business establishment, etc. Process 2500 then proceeds to 2530. Or, alternatively, if at 2526 sales data without tipout data has not been found, process 2500 proceeds directly to 2530.

At 2530, the data for the current period is scanned for tipout data that does not have any sales data associated therewith. Process 2500 proceeds to 2532, at which process 2500 determines whether tipout data without sales data has been found. If yes, process 2500 proceeds to 2534, at which specific data regarding the tipout data without sales data is added to the payroll export report. Such entry allows the user to correct the potentially omitted sales data or the potentially redundant or incorrect tipout data prior to transmitting the payroll data to the time and attendance system. Tipout data with no associated sales data may indicate that the tipout data has been incorrectly entered. Process 2500 then proceeds to 2536. Or, alternatively, if at 2532 tipout data without sales data has not been found, process 2500 proceeds directly to 2536.

At 2536, the data for the current period is scanned for tipout data paid by an employee performing a task that does not typically involve tipouts. Process 2500 proceeds to 2538, at which process 2500 determines whether potentially incorrect tipout data has been found. If yes, process 2500 proceeds to 2540, at which specific data regarding potentially incorrect tipout data is added to the payroll export report. Such entry allows the user to correct the potentially incorrect tipout data prior to transmitting the payroll data to the time and attendance system. Such potentially incorrect tipout data may indicate that the tipout data has been incorrectly entered. Process 2500 then proceeds to 2542. Or, alternatively, if at 2538 potentially incorrect tipout data has not been found, process 2500 proceeds directly to 2542.

Although FIG. 25A depicts an error checking routine that checks for five potential errors (i.e., duplicate data, omitted data, sales data with no associated tipout data, tipout data with no associated sales data, and potentially incorrect tipout data), error checking routines checking for fewer or greater errors may substituted without departing from the scope of the present invention. Or such error routines may be omitted without departing from the scope of the present invention. Furthermore, such error checking routines may be a separate and distinct function available via the main menu of the respective system.

At 2542, all error checking has been completed and the user is prompted to decide whether he or she would like to generate an error report. If yes, process 2500 proceeds to 2544 at which an error report is generated and is displayed and/or printed for the user. The user may then use this report to correct any data problems prior to processing the payroll data for the current period. Process 2500 then proceeds to 2546, at which a user may decide to exit payroll export function 430l (e.g., to correct data errors). If a user decides to exit, process 2500 returns control to process 400 (FIG. 4) at 426 since, in this exemplary embodiment, process 2500 is invoked by process 400. At 426, the user may select another function from the main menu of the GrataSoft system. Or, alternatively, if at 2542 the user elects to not generate an error report, or if at 2546 the user elects not to exit payroll export function 430l, process 2500 proceeds directly to 2548.

At 2548, process 2500 queries the system defaults to determine whether a voluntary taxing program (e.g., a TRDA agreement, a TRAC commitment, an EMTRAC commitment, an ATIP program, or the like) is in place. If yes, process 2500 proceeds to 2549, at which voluntary program adjustments, if any, are calculated. That is, the declared tips and/or gratuities of each employee participating in the voluntary program are analyzed to determine whether the amount declared is sufficient to meet IRS standards and to hopefully avoid an IRS audit. If the business establishment is a party to a TRAC commitment, such analysis includes comparing non-cash tips and/or gratuities as a percentage of total sales for which non-cash tips and/or gratuities were received to cash tips and/or gratuities as a percentage of total sales for which cash tips and/or gratuities were received. If the deviation between the two is too great, the systems and methods of the present invention calculate the adjustment necessary to increase the employee's declared tips to an acceptable level. Similarly, if the business establishment and employee are parties to a TRDA agreement, step 2549 compares the employee's tips and/or gratuities as a percentage of total sales or the employee's effective hourly rate to the minimum IRS percentage or minimum IRS rate, respectively, depending upon the TRDA method incorporated. If the declared tips and/or gratuities are not sufficient to meet the minimum IRS levels, the systems and methods of the present invention automatically calculate the adjustment required to raise the employee's declared tips to an acceptable level. Such adjustment amounts, if any, are then provided to the employee such that the employee may decide whether to increase the declared tips and/or gratuities such that he or she is in compliance with the voluntary program prior to transmission of such employee's data to the payroll company. Process 2500 then proceeds to 2550. Or, alternatively, if a voluntary program is not in place as determined at 2548, process 2500 proceeds directly to 2552.

At 2550, process 2500 queries the system defaults to determine whether Autocorrect is enabled. If yes, process 2500 proceeds to 2551, at which the employee's declared tips and/or gratuities are analyzed to determine whether the amount declared is sufficient to meet IRS standards and to hopefully avoid an IRS audit. If the service establishment is a party to a TRAC commitment, such analysis includes comparing credit card tips and/or gratuities as a percentage of total sales for which credit card tips and/or gratuities were received to cash tips and/or gratuities as a percentage of total sales for which cash tips and/or gratuities were received. If the deviation between the two is too great, the systems and methods of the present invention automatically increase the employee's declared tips to an acceptable level. Similarly, if the service establishment and employee are parties to a TRDA agreement, the analysis performed at 2551 includes comparing the employee's tips and/or gratuities as a percentage of total sales or the employee's effective hourly rate to the minimum IRS percentage or minimum IRS rate, respectively, depending upon the TRDA method incorporated. If the declared tips and/or gratuities are not sufficient to meet the minimum IRS levels, the systems and methods of the present invention automatically increase the employee's declared tips to an acceptable level. If AutoCorrect is off (and step 2551 is not required), or if the system has completed 2551, process 2500 proceeds to 2552.

At 2552, process 2500 queries the system defaults to determine whether IRS allocation is enabled. If yes, process 2500 proceeds to 2554, at which IRS allocations, if any, are calculated. That is, for each tipped employee, a determination is made as to whether such employee's tip and/or gratuity declarations fall below the IRS minimums as required, for example, when filing IRS form 8027. Currently, such minimum requires total declared tips to be equal to or greater than eight percent of gross sales, however, such minimums are subject to change by the IRS. If yes, the exemplary Gratasoft system calculates an allocation amount that will cause the respective employee's tip and/or gratuity declarations to meet the IRS minimum. Such allocations are declared to the payroll company as income separate from hourly wages and declared tips and/or gratuities. In some aspects of the present invention that include the IRS' ATIP program, all employees participating in the ATIP program will be excluded from allocation of tips as per 2554 in accordance with the rules of the ATIP program. Process 2500 then proceeds to 2556. Or, alternatively, if IRS allocation is not enabled at 2552, process 2500 proceeds directly to 2556.

At 2556, a user is prompted to determine whether he or she would like to export a payroll file. If no, process 2500 proceeds directly to 2566, at which process 2500 returns control to process 400 (FIG. 4) at 426 since, in this exemplary embodiment, process 2500 is invoked by process 400. At 426, the user may select another function from the main menu of the GrataSoft system.

Alternatively, if at 2556 the user elects to export a file, process 2500 proceeds to 2558. At 2558, the user is prompted to determine whether a specific or generic payroll file shall be exported. If the user elects to export a specific file format, process 2500 proceeds to 2560, at which the user is prompted to enter the specific file format desired. Process 2500 then proceeds to 2562, at which the payroll data is processed to create a file of the type selected by the user. In one aspect of the present invention, such processing includes conversion of said payroll data from a first file format to the desired file format via means of a converter, conversion software, or the like. After creation of the specific file, process 2500 then proceeds to 2564 at which the file is exported to the time and attendance system. Or, alternatively, if at 2558, the user elects to export the generic file automatically created by the exemplary Gratasoft system, process 2500 proceeds directly to 2564, at which the file is exported to the time and attendance system. However, alternate embodiments are envisioned in which in lieu of exporting the file, the file is imported by the user into the necessary payroll software. For example, a user may activate the payroll software program, select import, and select the location of the file created during process 2500. However, other methods of transferring payroll data between the systems and methods of the present invention and an external system or software package may be substituted without departing from the scope of the present invention.

Process 2500 then proceeds to 2566, at which it ends. Process 2500 returns control to process 400 (FIG. 4) at 426 since, in this exemplary embodiment, process 2500 is invoked by process 400. At 426, the user may select another function from the main menu of the GrataSoft system.

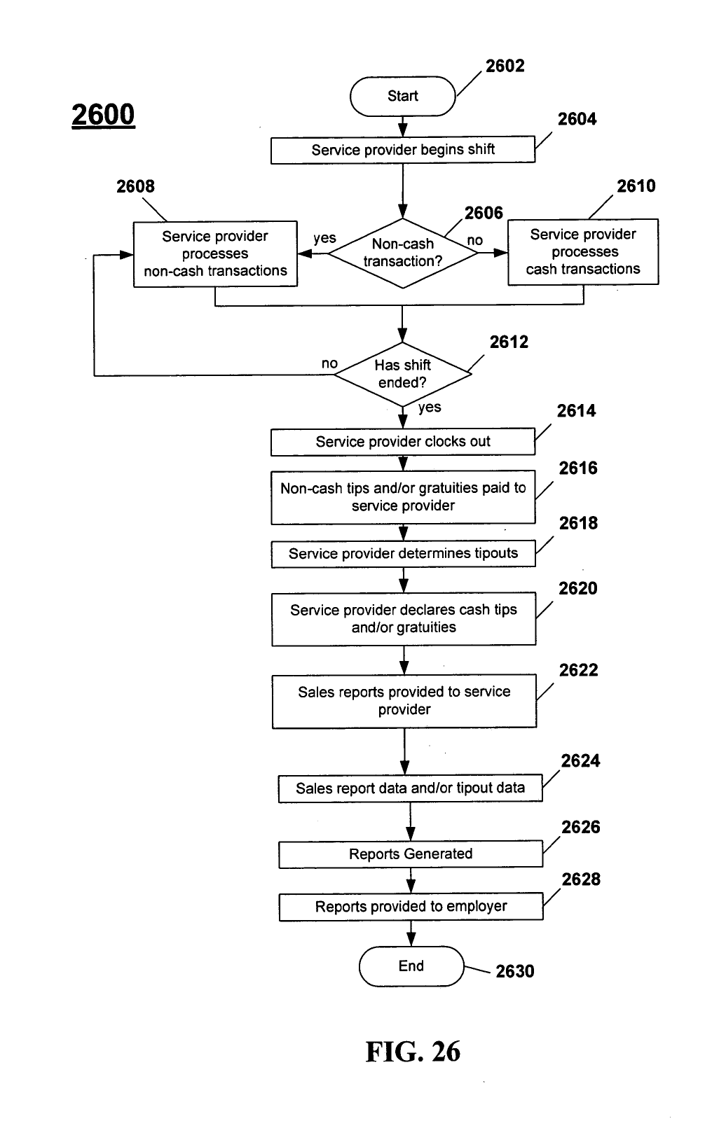

Although FIGS. 1 through 25 depict an embodiment of the present invention configured primarily for use by an employer, embodiments of the present invention are also envisioned for use by individual employees. Such embodiments may be particularly useful for employees working for business establishments that do not utilize any type of tip and/or gratuity management system as the tipped employee is always exposed to the potential of a taxing authority audit in which such employee must provide documentation of his or her tips, particularly cash tips, and tipout transactions. If the employee has not maintained proper documentation of his or her tips, the employee is at the mercy of the taxing authority. For example, when an IRS audit of a tipped employee is performed, the IRS auditor typically picks a representative period (e.g., a month) and extrapolates the employee's income from that representative period to calculate the employee's tax liability for a much greater period of time. The representative period is typically chosen to maximize the return to the IRS, which may be potentially harmful to the audited employee. Use of an individualized system in accordance with the present invention helps to protect the employee during such audits, while also increasing the likelihood that the taxing authority will move on to another employee for auditing if it discovers that the currently audited employee has kept proper records. FIG. 26 depicts a flow diagram of one such exemplary process for individually managing tips and gratuities in accordance with the present invention.

Process 2600 begins at 2602, at which the exemplary process is implemented by an employee performing work of the type for which tipping and/or providing gratuities is customary. Although such services will be described herein using an exemplary embodiment of restaurant services (i.e., serving of foods and/or beverages), the methods and systems of the present invention may be implemented with the provision of virtually any type of service in which it is customary to provide gratuities and/or tips including, but not limited to, hair salon services, spa services, valet services, tour guide services, moving services, and bellman services. Process 2600 then proceeds to 2604.

At 2604, the employee begins his or her shift. In one aspect of the present invention, the start of the shift includes “clocking in” via an employee time clock, a point-of-sale (“POS”) system, an IS, or the like. Such systems record an employee's starting and ending work hours for the purposes of calculating total hourly wages based upon the quantity of hours worked. Once the employee has “clocked in”, the employee's shift begins and the employee provides patrons with the desired services. In the exemplary restaurant embodiment of the present invention, the employee performs services such as taking meal orders, serving food and beverages, and the like. Such services also include processing of payments for goods and services, which payments are typically made via credit cards and/or cash.

Whenever an employee must process a payment, process 2600 proceeds to 2606. At 2606, a determination is made regarding whether such payment will be made via a non-cash method such as a credit card. If yes, process 2600 proceeds to 2608 at which the employee processes the non-cash transaction(s). In one aspect of the present invention, processing of non-cash transactions at 2606 occurs via a POS system as discussed in greater detail above with respect to FIG. 1. Although such POS systems are popular in current day business establishments, other methods of processing non-cash transactions may be substituted without departing from the scope of the present invention.

If, at 2606, a determination is made that the payment will be made via cash, process 2600 proceeds to 2610 at which the employee processes the cash transaction(s). Similar to 2608, in one aspect of the present invention, processing of cash transaction(s) at 2606 occurs at least partially via a POS system. In this exemplary restaurant embodiment, cash transactions may be processed via the POS system by entering the data via a cash register or cash register terminal. Such cash transactions may include meal charges, bar charges, cash and/or non-cash gratuities, and the like, however, cash tips are not typically included therein. Rather such cash tips are typically held by the employee until the end of his or her shift, at which point the employee reconciles the retained cash tips with the business establishment as discussed in greater detail below with respect to 2616 Again, although such POS systems are popular in current day business establishments, other methods of processing cash transactions may be substituted without departing from the scope of the present invention.

At 2612, process 2600 determines whether the employee's shift has ended. If no, process 2600 returns to 2606 at which the server continues to process transactions. If the employee's shift has ended, process 2600 proceeds to 2614, at which the employee clocks out. Such clocking out may be performed via a POS system or via alternative systems (e.g., a time and attendance system) and methods without departing from the scope hereof. Process 2600 then proceeds to 2616.

At 2616, non-cash tips and/or gratuities are paid to the employee. In one aspect of the present invention, such tips and/or gratuities are paid to the employee in cash. In another aspect of the present invention, such tips and/or gratuities are retained by the business establishment and are included in the employee's gross wages, as is required by the IRS. However, alternate embodiments of transferring non-cash tips and/or gratuities to the employee may be substituted without departing from the scope of the present invention. Process 2600 then proceeds to 2618.

At 2618, the employee may optionally tipout a portion of the tips and/or gratuities received during his or her shift to support staff (e.g., busboys, bar servers, etc.) as described in greater detail above with respect to 118 of FIG. 1. However, in addition to that disclosed above, for individualized embodiments of the present invention operating via a portable device such as a laptop, PDA, Smartphone, or the like, the portable device may be equipped to capture a signature and/or accept an electronic/digital signature from a supervisor, the co-worker to which a tipout is made, the co-worker from which a tipout is received, etc. as described in further detail above with respect to FIGS. 2A, 3, and 5. The capturing and saving of such signatures may be used as verification, if needed, at a later date of the tipout transactions. Or, in lieu of electronically or digitally capturing signatures, an employee utilizing the individualized embodiment of the present invention may ask supervisors and/or co-workers to sign paperwork confirming the tipout transactions. Such paperwork may be in the form of an envelope such as that depicted in FIG. 2B, a ledger, or any other document that verifies the value of the exchanged tipouts and the signatures of the relevant parties thereto. Process 2618 then proceeds to 2620.

At 2620, the employee declares all cash tips and/or gratuities received from patrons to the business establishment. In one aspect of the present invention, such declaration only includes cash tips and/or gratuities received from patrons (i.e., such declaration does not include tipouts received from other co-workers). In such embodiments, tipout information is recorded separately and each employee's total declared tips and/or gratuities are adjusted based upon the provided tipout information via the systems and methods of the present invention. In its most simplistic form, this step involves simply notifying business establishment personnel of the total cash tips and/or gratuities received for all cash sales, as well as cash tips and/or gratuities paid to the employee for non-cash sales. Typically, the business establishment does not require reporting of cash sales, non-cash sales, and the non-cash tips and gratuities associated therewith since such transactions are typically recorded in the business establishment's computerized processing system (e.g., a POS system). However, embodiments of the present invention are envisioned in which the employee is responsible for reporting cash sales, non-cash sales, and non-cash tips and gratuities to business establishments having unsophisticated processing systems. Process 2600 then proceeds to 2622. Although FIG. 26 depicts determination of tipouts and declaration of cash tips and/or gratuities as multiple steps, alternate embodiments are envisioned in which these steps are performed simultaneously such as the embodiment discussed above with respect to FIG. 2B.

At 2622, which may occur simultaneously with 2620, the employer provides the employee with a sales report for the shift. For example, in one embodiment of the present invention, the sales report may include total non-cash sales, total non-cash tips and/or gratuities, total cash sales, and total cash tips and/or gratuities. Such sales reports may optionally include tipout information for tipouts received and/or provided by the employee. The employee retains such information for input into his or her personal tip and gratuity management system.

Information such as non-cash and cash sales data, cash and/or non-cash tip and/or gratuity data, tipout data, and the like are recorded by the employee at 2624. Some such data may be received from the employer (e.g., data received in the sales report provided at 2622), whereas other such data may be generated or received directly by the employee (e.g., tipouts provided or received by the employee). In one aspect of the present invention, recording involves entering this information into a software program executed by a system such as those described in greater detail above with respect to FIG. 3. When a system such as system 300 is utilized, it may typically be kept at the employee's home due to its size. Therefore, recording of the aforementioned data may occur after an employee returns home from work. However, alternate embodiments are envisioned in which the individualized tip and gratuity management system operates via a portable device such as a laptop, PDA, Smartphone, cellular telephone, or the like. In such embodiments, data recording may be performed instantaneously in the employer's place of business or elsewhere as desired by the employee. In embodiments of the present invention in which data is recorded on a portable device, such devices may also be capable of downloading an employee's individual data directly from an IS such as the employer's tip and/or gratuity management system, a POS system, or the like via a link such as an infrared link, hardwired cable connection, wireless connection, Internet connection, or the like. Process 2600 then proceeds to 2626.

At 2626, reports may be generated based upon the data recorded by the employee. The systems and methods of the present invention are designed to automatically generate desired reports with little or no input from a user. Numerous reports may be generated in a variety of formats including, but not limited to, activity summary reports, tip declaration problem reports, and IRS reports such as TRAC statements, IRS Form 8027, and IRS Publication 1244 reports including IRS forms 4070A and 4070. In some embodiments of the present invention capable of generating IRS forms 4070A and 4070, such reports may be automatically created and stored by the employee such that the employee maintains compliance with the IRS' recordkeeping requirements. Additionally, such reports are likely to be required if the employee is ever audited. In embodiments of the present invention in which tip declaration problem reports are created, such reports allow the employee to increase his or her declared tips via notification of his or her employer in an effort to avoid an IRS audit.

Process 2600 then proceeds to 2628. At 2628, some or all reports generated at 2626 may be provided to the employer. In some aspects of the present invention, some or all of such reports (e.g., 4070 and 4070A reports) may be provided to the employer to declare cash tips and/or gratuities, thereby eliminating the need for step 2620. In some aspects of the present invention, some or all of such reports, or all or a portion of the information included therein, may be submitted to the employer electronically via methods including, but not limited to, upload or download via a Web interface, electronic mail submission, etc. Or, optionally, step 2628 may be omitted if the employee provides declared tip and/or tipout information to the employer in another format. Process 2600 then proceeds to 2630, at which it ends.

Although steps 2616 through 2628 are depicted in the flowchart of FIG. 26 in a specific order, alternate variations in these steps are envisioned within the scope of the present invention. In addition, although steps 2616 through 2628 are depicted as occurring after the conclusion of a shift, such steps may occur more or less frequently (e.g., such steps may be performed in real time via the use of a portable device such as a personal digital assistant (“PDA”)). For example, any one or more of these steps may occur, weekly, bi-weekly, monthly, bi-monthly, annually, or upon some other periodic basis without departing from the scope of the present invention.

One system and method of implementing an individualized system for managing tips and/or gratuities in accordance with the present invention is a variation of the employer system for managing tips and gratuities as depicted and discussed above with reference to FIGS. 4 through 25.

Referring first to FIG. 4, one overview of an individualized system for managing tips and/or gratuities in accordance with one embodiment of the present invention is similar to that depicted in FIG. 4 with a few variations. One, in embodiments of the individualized system that are capable of loading data such as described at steps 404 and 406, the method of loading such data must be modified such that the individual employee does not have access to irrelevant and/or sensitive information such as co-worker's social security numbers, other employees' wage, tip, and or gratuity data, other employees' personal information, etc. In contrast, the loaded data should relate solely to the individual employee's sales data, tip and/or gratuity data, tipout data, and the like. In some embodiments of the present invention, the system from which such data is downloaded may be specially configured to provide such information on an individual employee basis.

Additionally, for individualized systems, it is less likely that such systems will be co-located on the same computer as the system from which sales data is downloaded. One such reason for this is that the individualized system will typically be owned by the employee, whereas the system from which data is downloaded (e.g., a POS system or employer tip and gratuity management system) will typically be owned by the employer. Also, it is likely that a plurality of employees will download data from the same system, therefore, co-locating every employee's individualized system with the systems from which data is downloaded is not practical. However, embodiments of the present invention are envisioned in which the individualized systems may be co-located with the systems from which data such as sales data is loaded. Also, embodiments of the present invention are envisioned in which the ability to load sales data is completely omitted from the individualized system.

Individualized systems are likely to include security features such as those provided at 404 through 424 of FIG. 4. However, in one aspect of the present invention, such security features are more simplified in the individualized system as compared to the employer system since the individualized system is intended for use by a single employee only. Consequently, there is no need to assign varying levels of access and/or user rights to each user since there is likely to be one user (i.e., the employee) that has access to all of his or her data. In such embodiments, the steps of querying user rights and enabling/disabling menu items based upon user rights may be omitted and the same main menu will be displayed during each use of the system. However, some individualized systems may accommodate use by multiple users and or customization of the main menu based upon the user without departing from the scope of the present invention.

In some aspects of the present invention, the functions available in an individualized system will vary from those available in an employer system. For example, an individualized system typically will not require employees function 430d, training function 430e, user rights function 430j, and payroll export function 430l. Employees function 430d is not typically required as only one employee will use the system. Therefore, the data for the sole employee may be entered and/or modified as a part of a system default function such as system default function 430k or via a simplified form of process 800 (FIG. 8). That is, elements of process 800 such as employeeID may be eliminated since only one employee will be present in an individualized system.

In addition, since employees are not required to track training in order to comply with taxing authority requirements, functions such as training function 430e may be omitted from individualized systems. Similarly, since individualized systems are intended for use by a single user (i.e., the employee), definition of individual user rights via a function such as user rights function is typically not required. It would be assumed that the individual user would have all rights to all aspects of the individualized system. However, such functions may be included in an individualized system without departing from the scope of the present invention. Furthermore, payroll export functions such as payroll export function 430l are not typically required because individual employees do not typically transmit their own data to a payroll company. This transmission is typically performed by an employer to allow the employer to verify payroll data before a check is issued to the employee.

Many of the other functions available in the employer system may be used in the individualized system with slight alterations. Tip data entry function 430a may be implemented as depicted in FIGS. 5A and 5B with one modification. Whereas the employer system requires initialization, display, and the ability to change the employee for which tip data is being entered, the individualized system does not require such features since it is intended for use by a single employee. That is, the tip data being entered will always be applicable to the same employee.

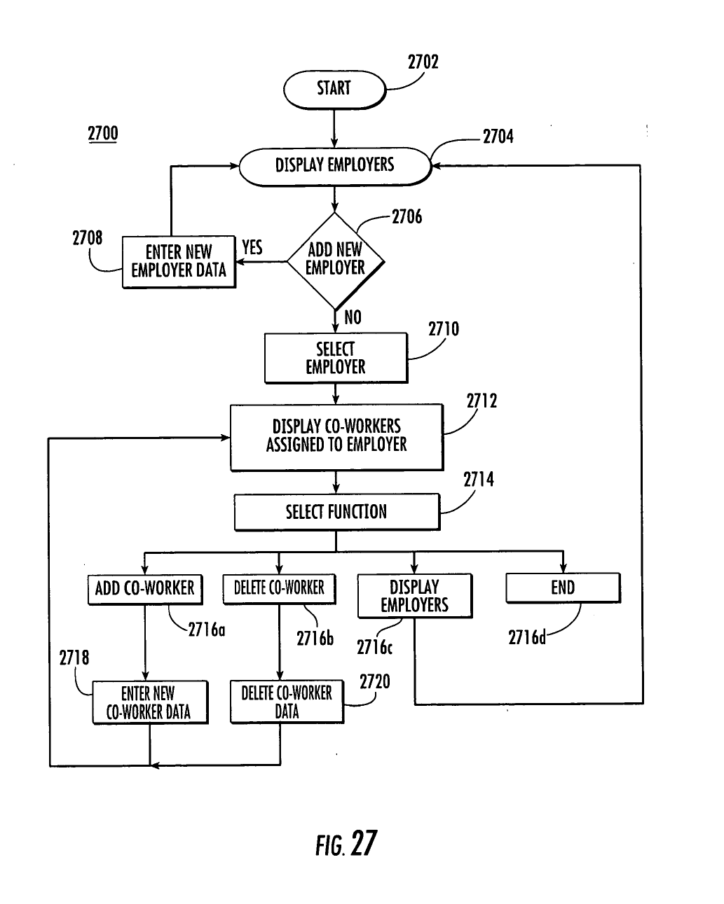

The modify tipouts portion of the tip data entry function of the individualized system will retain the ability to select the specific co-worker from which tipouts are received by the employee. The information for such co-workers may be added via an employer/coworker function such as that discussed below with respect to FIG. 27. However, the modify tipouts portion of the tip data entry function will be expanded in the individualized system to allow tipouts provided by the employee to his or her co-workers to be entered. In the employer embodiment of the present invention, such ability is not necessary since such transactions are tracked when the tipout data is entered by the employee receiving the tipout. However, since tipout data is not entered in the individualized system for all co-workers, the tipouts provided by the sole employee must be entered in addition to those received by the sole employee.

In addition, in some aspects of the present invention, the individualized system is equipped with the ability to record data associated with multiple employers. This allows an employee that holds multiple jobs or an employee that changes employment to record his or her data via a single integrated system. This may be necessary as the IRS requires an employee to retain his or her records for approximately four years, and it is likely that the employee will work for more than one employee during that time period. In such embodiments of the present invention, an employer function will be included in the main menu of the individualized system.

Referring next to FIG. 27, illustrated is a flow diagram of an exemplary embodiment of a process for defining co-worker and employer data in accordance with one embodiment of the present invention. Allowing co-worker and employer data to be defined in a single function is beneficial in a multi-employer individualized system since each of the entered co-workers should be associated with a specific one or more of the multiple employers. Process 2700 begins at 2702, typically after being launched from a master process such as an individualized system variation of process 400 as described above with respect to FIG. 4. For example, process 2700 may be launched by selecting a co-worker/employer function from the main menu of the individualized system. Once the function has been initiated, process 2700 proceeds to 2704.

At 2704, a list of all employers defined in the system are displayed to the user and process 2700 proceeds to 2706. At 2706, the user decides whether to add a new employer. If yes, process 2700 proceeds to 2708, at which the data for the new employer is entered. Process 2700 then returns to 2704, at which all employers including the newly entered employer are again displayed to the user. Alternatively, if a user decides not to add a new employer at 2706, process 2700 proceeds directly to 2710.

At 2710, a user selects an employer from the list of employees displayed at 2704, for example, via a user interface such as those discussed above with respect to FIG. 3. In this exemplary embodiment of the present invention, process 2700 then proceeds to 2712, at which all co-workers assigned to the selected employer are displayed to the user. Process 2700 then proceeds to 2714.

At 2714, the user selects a function, for example, via a user interface such as those discussed above with respect to FIG. 3. In this exemplary embodiment of the present invention, the functions include add co-worker function 2716a, delete co-worker function 2716b, display employers function 2716c, and end function 2716d. Once the user selects a function, process 2700 proceeds to the selected function. For example, if the add co-worker function is chosen, process 2700 proceeds to 2716a.

If at 2714, the user has selected the add co-worker function, process 2700 proceeds to 2716a at which a process to enter information for a new co-worker begins. Process 2700 then proceeds to 2718, at which the user is prompted to enter data associated with the new co-worker such as name, address, position, etc. The newly added co-worker is automatically assigned to the selected employer. In one embodiment of the present invention, assignment of the co-worker to an employer such as the current employer minimizes the potential for data entry errors in multi-employer embodiments of the individualized system. Such potential is minimized during entry of tip data during a process such as process 500 by requiring an employee to select the applicable employer prior to entering tip data. Thereafter, when tipouts are associated with a particular co-worker at a step such as step 546 of a process such as process 500, only those co-workers assigned to the selected employer will be available to the user (e.g., via a pick list, drop down menu, or the like) to prevent such user from accidentally assigning a co-worker to the tipout data that is employed by another employer. However, alternate, more simplified embodiments of the present invention that are not programmed with such precautions may be substituted without departing from the scope of the present invention. After the user has entered the co-worker's information, process 2700 returns to 2712, at which the co-workers assigned to the selected employer are again displayed to the user.

If, at 2714, the user has selected the delete co-worker function, process 2700 proceeds to 2720, at which the co-worker information is in fact deleted. In one aspect of the present invention, although a portion of the data associated with individual co-worker may be deleted, actual co-workers may not be deleted from the systems and methods of the present invention as such deletion may affect the accuracy of generated reports. However, in such embodiments, co-workers who are no longer employed by the employer may be marked as inactive to facilitate use of the system. Process 2700 then returns to 2712, at which the co-workers assigned to the selected employer are again displayed to the user.

At 2712, if the user selects the display employers function, process 2700 proceeds to 2704, at which all employers are again displayed to the user. Or, alternatively, if at 2712, the user selects the end function, process 2700 terminates. Since, in this exemplary embodiment, process 2700 is invoked by a master process such as an individualized system variation of process 400 as described above with respect to FIG. 4, process 2700 returns control to such master process at which point a user may select another function from the main menu of the individualized system.

Referring back to FIG. 4, in one aspect of an individualized system in accordance with the present invention, the main menu will be equipped with a reports function similar to reports function 430b as discussed in greater detail above. However, in the individualized system, there will be no need to select an employee at 612 since the system is designed for use by a single employee. Therefore, steps 612 through 616 may be omitted. Or, alternatively, for multi-employer embodiments of the individualized system, steps 612 through 616 may be substituted with one or more steps in which the employee chooses the employer for which he or she would like to run a report.

Additionally, the reports available to the user via a reports function such as reports function 430b may vary. For example, for the reasons discussed above, an individual employee is not likely to track his or her employee training. Therefore, staff training history reports or reports similar thereto would not be required. Also, whereas other employer reports may be useful to the employee, such reports may require modifications. For example, steps related to whether a user has the rights to run a report may be omitted since only one user will use the individualized system and, therefore, presumably that user has rights to the entire software package. In addition, for reports capable of reporting data for multiple employees, such reports shall be modified to print data for the sole employee only. For example, when printing a report such as an activity summary report, an 8027 report, etc., only one employee's data shall be listed.

A sales entry function such as sales entry function 430c may also be available in an individualized embodiment of the present invention with some minor revisions. For example, in the individualized system, there will be no need to have the option to display sales data by employee at 706b (FIG. 7) since the system is designed for use by a single employee. Therefore, steps 706b through 710b (FIG. 7) may be omitted. Or, alternatively, for multi-employer embodiments of the individualized system, such steps may be substituted with one or more steps in which the employee chooses the employer for which he or she would like to run a report.

Similarly, an individualized system may also include a program setup function such as program setup function 430f with some minor revisions. For example, program methods and/or variables will not need to be entered for each employee since the individualized system is designed for use by a single employee. Therefore, these steps may be omitted. Or, alternatively, for multi-employer embodiments of the individualized system, such steps may be substituted with one or more steps in which the employee chooses the employer for which he or she would like to setup the TRDA method and/or variables.

The remaining functions available through the exemplary embodiment of the GrataSoft system as discussed in greater detail above with respect to FIG. 4 such as tasks function 430g, IS tasks function 430h, meal period function 430i, system default function 430k, and end function 430m may also be available through an individualized system. Such functions allow the individual user to setup features of the system such as tasks, IS tasks (if applicable), meal periods, and system defaults or to quit from the main menu, respectively, as described in greater detail above with respect to FIG. 4. Again, such functions may be modified as necessary to eliminate use for multiple employees (other than co-workers as discussed above with respect to FIG. 27) and/or to add capabilities for multiple employers.

Although the individualized system of the present invention has been discussed above as a variation of an employer embodiment of the present invention, the present invention is not so limited. Additional functions may be added, deleted, and/or modified without departing from the scope hereof.

Although the processes discussed above detail sequential methods of performing such processes, other embodiments of such processes may be substituted without departing from the scope of the present invention. For example, object oriented event-triggered languages such as Dbase Plus may be used to create processes that rely on user input (e.g., clicking an onscreen button, data entry, and the like) to determine the flow of the process. In such embodiments, the user determines which portions, if any, of each process will be executed. For example, in process 700 as depicted in FIG. 7, step 712 may display the sales data in the form of a grid of employee sales for a specific date. In an object-oriented embodiment, after the grid is displayed, process 700 essentially stops until the user selects an option (e.g., exit, add or edit a specific employee's sales data, etc.). If the user selects exit, for example, process 700 immediately proceeds to 728 without the need to execute steps 714 through 726. Or, alternatively, if a user selects a specific employee's sales data, process 700 may proceed as depicted. In such a scenario, the grid of employee sales data may be re-presented to the user at 726 and the user decides whether to enter or edit additional data by simply clicking another employee's sales data. Object-oriented programming is just one example of an alternate embodiment for creating the processes described above. Other embodiments may also be substituted without departing from the scope of the present invention.

Although the present invention has been discussed herein as an independent system capable of interfacing to third-party systems such as POS systems, time and attendance systems, etc., the systems and methods of the present invention may also be implemented as an integral component of such systems, or the functions and features of such systems may be added to the systems and methods of the present invention, without departing from the scope hereof.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-26. (canceled)

27. A method for managing tipouts comprising the steps of:
receiving at least one tipout provided to at least one first employee from at least one second employee;
verifying at least a portion of said at least one tipout; and
providing said at least one tipout to said at least one first employee.

28. A method according to claim 27, wherein said at least a portion of said at least one tipout is received via at least one envelope.

29. A method according to claim 27, wherein said verifying said at least a portion of said at least one tipout is performed by at least one of the group consisting of said at least one first employee, said least one second employee, at least one third employee, and combinations thereof.

30. A method according to claim 29, wherein said third employee is a manager, a supervisor, a head server, a bartender, a floor manager, and combinations thereof.

31. A method according to claim 27, wherein said verifying includes at least one of the group consisting of signing said at least one envelope, submitting an electronic signature, submitting a digital signature, signing via an electronic device that electronically captures said signature, and combinations thereof.

32. A method according to claim 28, further comprising:
receiving information selected from the group consisting of a cash tip value, a non-cash tip value, a cash gratuity value, a non-cash gratuity value, a tipout value, meal period data, task data, employee identification data, and combinations thereof from said at least one second employee via said at least one envelope;
wherein at least a portion of said information is written upon a face of said at least one envelope.

33. A method according to claim 27, wherein said at least a portion of said at least one tipout is cash.

34. A method according to claim 27, wherein said providing of said at least a portion of said at least one tipout to said at least one first employee includes paying said at least a portion of said at least one tipout to said at least one first employee as wages.

35. A method according to claim 34, wherein said paying said at least a portion of said at least one tipout to said at least one first employee as wages includes electronically exporting payroll data.

36. A method according to claim 27, wherein said method is for use by at least one of the group consisting of an employee, an employer, and combinations thereof.

37. A method according to claim 27, wherein said method manages tipouts on a per employer basis.

38-104. (canceled)
